(19) United States
(12) Patent Application Publication
(10) Pub. No.: US 2022/0369031 A1
(43) Pub. Date: Nov. 17, 2022

(54) DEEP NEURAL NETWORK DENOISER MASK GENERATION SYSTEM FOR AUDIO PROCESSING

(71) Applicant: SHURE ACQUISITION HOLDINGS, INC., Niles, IL (US)

(72) Inventors: Michael Lester, Buena Vista, CO (US); Michael Prosinski, Chicago, IL (US); Iris Lorente, Park Ridge, IL (US); Zhen Qin, Chicago, IL (US); Dan Law, Glencoe, IL (US); Justin Sconza, Chicago, IL (US); Paul Becke, Mundelein, IL (US)

(21) Appl. No.: 17/679,604

(22) Filed: Feb. 24, 2022

Related U.S. Application Data
(60) Provisional application No. 63/153,757, filed on Feb. 25, 2021.

(51) Int. Cl. H04R 3/04

(52) U.S. Cl. CPC H04R 3/04

(57) ABSTRACT

Techniques for providing an artificial intelligence denoiser related to audio processing are discussed herein. Some embodiments may include providing an audio signal sample associated with at least one microphone to a time-frequency domain transformation pipeline for a transformation period. Some embodiments may include providing the audio signal sample to a deep neural network (DNN) processing loop that is configured to determine a denoiser mask associated with a noise prediction for the audio signal sample. In a circumstance where the denoiser mask is determined prior to expiration of the transformation period, some embodiments may include applying the denoiser mask associated with the noise prediction to a frequency domain version of the audio signal sample associated with the time-frequency domain transformation pipeline to generate a denoised audio signal sample associated with the at least one microphone.

### CROSS REFERENCE TO RELATED APPLICATIONS

This application claims the benefit of U.S. Provisional Patent Application No. 63/153,757, titled “DEEP NEURAL NETWORK DENOISER MASK GENERATION SYSTEM FOR AUDIO PROCESSING,” and filed on Feb. 25, 2021, the entirety of which is hereby incorporated by reference.

### TECHNICAL FIELD

Embodiments of the present disclosure relate generally to audio processing and, more particularly, to systems configured to apply machine learning to generate and update denoiser masks for application to audio samples.

### BACKGROUND

Noise may be introduced during audio capture related to microphones used in audio systems. For example, noise is often introduced during audio capture related to telephone conversations, video chats, office conferencing scenarios, etc. Such introduced noise may impact intelligibility of speech and produce an undesirable experience for discussion participants.

### BRIEF SUMMARY

Various embodiments of the present disclosure are directed to improved apparatuses, systems, methods, and computer readable media for providing an artificial intelligence enabled denoiser related to audio processing. These characteristics as well as additional features, functions, and details of various embodiments are described below. Similarly, corresponding and additional embodiments are also described below.

### BRIEF DESCRIPTION OF THE DRAWINGS

Having thus described some embodiments in general terms, reference will now be made to the accompanying drawings, which are not necessarily drawn to scale, and wherein:

FIG. 1 illustrates an example of an audio processing system that includes a time-frequency domain transformation pipeline and a deep neural network processing loop configured in accordance with one or more embodiments disclosed herein;

FIG. 2 illustrates an example of an audio processing system that includes a time-frequency domain transformation pipeline with digital transforms and a deep neural network processing loop configured in accordance with one or more embodiments disclosed herein;

FIG. 3 illustrates an example of an audio processing system that includes a time-frequency domain transformation pipeline and a deep neural network processing loop configured to include a DNN model in accordance with one or more embodiments disclosed herein;

FIG. 4 illustrates processing operations performed by a time-frequency domain transformation pipeline and a deep neural network processing loop configured in accordance with one or more embodiments disclosed herein;

FIG. 5 illustrates an example of an audio processing system that includes a time-frequency domain transformation pipeline and a deep neural network processing loop configured with frequency warping operations in accordance with one or more embodiments disclosed herein;

FIG. 6 illustrates an example of an audio processing system that includes a time-frequency domain transformation pipeline, a deep neural network processing loop, and post-model processing operations in accordance with one or more embodiments disclosed herein;

FIG. 7 illustrates an example of an audio processing system that includes a time-frequency domain transformation pipeline, a deep neural network processing loop, and post-model processing operations configured to employ user denoiser control in accordance with one or more embodiments disclosed herein;

FIG. 8 illustrates an example of an audio processing system that includes a time-frequency domain transformation pipeline, a deep neural network processing loop, and post-model processing operations with spatial filtering in accordance with one or more embodiments disclosed herein;

FIG. 9 illustrates an audio processing system that includes a time-frequency domain transformation pipeline, a deep neural network processing loop, and a post-processing pipeline configured in accordance with one or more embodiments disclosed herein;

FIG. 10 schematically illustrates an example audio processing system that provides an artificial intelligence denoiser for audio processing in accordance with one or more embodiments disclosed herein;

FIG. 11 illustrates an exemplary deep neural network model configured in accordance with one or more embodiments disclosed herein;

FIG. 12 illustrates an exemplary deep neural network model configured in a U-Net architecture in accordance with one or more embodiments disclosed herein;

FIG. 13 illustrates an exemplary deep neural network model configured to define three levels in a U-Net architecture in accordance with one or more embodiments disclosed herein;

FIG. 14 illustrates exemplary noise return loss processing related to a noise reduction loss meter interface in accordance with one or more embodiments disclosed herein;

FIG. 15 illustrates exemplary signal flow processing related to a noise reduction loss meter interface in accordance with one or more embodiments disclosed herein;

FIG. 16 illustrates other exemplary noise return loss processing related to a noise reduction loss meter interface in accordance with one or more embodiments disclosed herein;

FIG. 17 illustrates an exemplary digital signal processing apparatus configured in accordance with one or more embodiments disclosed herein;

FIG. 18 illustrates an example audio processing system that includes a digital signal processing apparatus and a client device in accordance with one or more embodiments disclosed herein;

FIG. 19 illustrates an exemplary audio processing control user interface in accordance with one or more embodiments disclosed herein;

FIG. 20 illustrates another exemplary audio processing control user interface in accordance with one or more embodiments disclosed herein;

FIG. 21 illustrates another exemplary audio processing control user interface in accordance with one or more embodiments disclosed herein;

FIG. 22 illustrates another exemplary audio processing control user interface in accordance with one or more embodiments disclosed herein;

FIG. 23 illustrates an example audio processing system that is configured to provide an artificial intelligence denoiser related to active noise cancellation in accordance with one or more embodiments disclosed herein;

FIG. 24 illustrates an example audio processing system that is configured to provide audio processing related to active noise cancellation in accordance with one or more embodiments disclosed herein;

FIG. 25A illustrates an example wearable listening device associated with an audio processing system related to active noise cancellation in accordance with one or more embodiments disclosed herein;

FIG. 25B illustrates further details regarding the example wearable listening device in accordance with one or more embodiments disclosed herein;

FIG. 26 illustrates an example method for digital signal processing of an audio sample that is configured to include an asynchronous deep neural network processing loop in accordance with one or more embodiments disclosed herein;

FIG. 27 illustrates another example method for digital signal processing of an audio sample that is configured to include an asynchronous deep neural network processing loop and user-defined control parameters in accordance with one or more embodiments disclosed herein; and

FIG. 28 illustrates yet another example method for digital signal processing of an audio sample that is configured to include an asynchronous deep neural network processing loop and a dynamic noise reduction user interface in accordance with one or more embodiments disclosed herein.

### DETAILED DESCRIPTION

Various embodiments of the present disclosure will now be described more fully hereinafter with reference to the accompanying drawings, in which some, but not all embodiments of the present disclosure are shown. Indeed, the disclosure may be embodied in many different forms and should not be construed as limited to the embodiments set forth herein. Rather, these embodiments are provided so that this disclosure will satisfy applicable legal requirements.

Overview

Various embodiments of the present disclosure address technical problems associated with accurately, efficiently and/or reliably removing or suppressing noise associated with an audio signal sample. The disclosed techniques can be implemented by an audio processing system to provide improved denoising of an audio signal. Importantly, audio processing systems configured in accordance with various embodiments described herein are adapted to remove or suppress non-stationary noise from audio signal samples.

Various embodiments of the present disclosure involve improved audio processing systems that are configured to employ artificial intelligence (AI) or machine learning (ML) to determine denoiser masks that can be applied to an audio signal sample in a manner that satisfies exacting conversational speech latency requirements. Improved audio processing systems as discussed herein may be implemented as a microphone, a digital signal processing (DSP) apparatus, and/or as software that is configured for execution on a laptop, PC, or other device.

In some embodiments, an improved audio processing system is configured to remove non-stationary noise from speech-based audio signal samples captured via one or more microphones. For example, an improved audio processing system may be incorporated into microphone hardware for use when a microphone is in a “speech” mode. In some embodiments, an improved audio processing system is configured to remove non-stationary noise of an ambient listening environment for a listening product such as, for example, headphones, earphones, speakers, other listening devices, etc. Additionally, in some embodiments, an improved audio processing system is configured to remove non-stationary noise from non-speech audio signal samples such as music, precise audio analysis applications, public safety tools, sporting event audio (e.g., real-time basketball game audio, etc.).

According to another embodiment, an improved audio processing system can be incorporated into software that is configured for automatically processing speech from one or more microphones in a conferencing system (e.g., an audio conferencing system, a video conferencing system, etc.). In one embodiment, the improved audio processing system can be integrated within an inbound audio chain from remote participants in a conferencing system. The improved audio processing system can be configured to employ one or more machine learning models trained to predict noise (e.g., non-stationary noise) related to an audio signal. In another embodiment, the improved audio processing system can be integrated within an outbound audio chain from local participants in a conferencing system.

Improved audio processing systems discussed herein may be integrated into a virtual DSP processing system with other conference DSP processing. In many embodiments, improved audio processing systems are configured to decouple computational timing requirements of a deep neural network (DNN) model from a DSP processing chain. In such embodiments, the DNN model is chronologically correlated to the DSP processing chain, but the DSP processing operations can be implemented without being chronologically dependent on data (e.g., timely completion of output) provided by the DNN model. In some embodiments, improved audio processing systems include a DNN processing loop that is asynchronously decoupled from a time frequency domain transformation pipeline.

In other embodiments, the improved audio processing system is configured to determine and apply a denoiser mask (e.g., a time-frequency mask) to an audio signal sample processed within a DSP processing chain (e.g., a time frequency domain transformation pipeline). In such embodiments, the denoiser mask may be determined through an asynchronous processing loop that is configured to provide denoiser mask leakage to unity to facilitate degradation of denoiser properties to normal passthrough in an event of misses in the computational timing and/or certain processing errors. Said differently, in circumstances where an asynchronous processing loop fails to produce an updated denoiser mask under sufficient timing to meet requirements set by a DSP processing chain, the asynchronous processing loop is configured to fail “open” such that a previous or default denoiser mask is applied to the audio signal sample.

The improved audio processing system may also be configured to provide one or more digital transforms at a front end of the DSP processing chain and/or the DNN processing loop to reduce computational complexity and/or to facilitate application of the denoiser mask to the audio signal sample processed within the DSP processing chain. The one or more digital transforms may include a Fourier transform, a perceptual transform, or another type of digital transform with respect to the audio signal sample.

The improved audio processing system may also be configured to convert an audio signal sample into a non-uniform-bandwidth frequency domain representation (e.g., a Bark scale format) provided as input to a DNN model configured to generate the denoised mask. As such, data transmitted through a DSP pipeline and/or data sets provided to a DNN model associated with noise prediction may be reduced or minimized to ensure more rapid and efficient processing by the DNN model to meet one or more audio latency requirements for the asynchronous processing loop.

The improved audio processing system may also be configured to provide post-processing related to the DSP processing chain and/or the DNN processing loop. The post-processing related to the DSP processing chain and/or the DNN processing loop may include employment of defined noise reduction levels and/or defined time-frequency maps to modify a denoiser mask.

Improved audio processing systems may be configured to translate user denoiser control parameters related to denoising into a denoising algorithm that may be applied, for example by a DNN processing loop, to optimize denoising of an audio signal sample based on the user denoiser control parameters. For instance, in certain embodiments, the user denoiser control parameters can be user defined denoiser levels established through user engagement of a user engagement denoiser interface.

In one embodiment, an improved audio processing system may be configured to output a noise reduction loss meter interface that provides a visual representation of an amount of noise removed from an audio signal sample. The improved audio processing system may also be configured to provide bypass functionality to provide an improved audible change to the audio signal sample. The bypass functionality may be employed to remove computational load and/or audio path latency associated with the DSP processing chain and/or the DNN processing loop.

Improved audio processing systems may also be configured to provide noise audition functionality that inverts behavior of denoising of an audio signal sample to allow a user to identify one or more non-stationary noise sources in a noise environment (e.g., a room) and/or to facilitate processing with respect to the one or more non-stationary noise sources. Inversion of the behavior of the denoising may include inverting one or more denoiser operations with respect to the audio signal sample.

In some embodiments, the improved audio processing system may provide a multi-microphone DNN architecture and/or a multi-lobe DNN architecture to facilitate generation of a denoiser mask. Individual microphone elements may be employed to exploit direction of arrival differences of voice and noise components to improve denoising performance. Additionally or alternatively, beamformed lobes may be located at different locations in an audio environment to provide discoverable features in a DNN model related to varying signal-to-noise differences to improve denoising performance.

In still other embodiments, improved audio processing systems as discussed herein may be configured for other types of digital signal processing that differ from speech denoising. For example, in certain embodiments, improved audio processing systems may be configured for identifying sounds, characterizing sounds, determining sound field characteristics, jointly locating and characterizing sounds, etc. In certain embodiments, improved audio processing systems may include application of machine learning models that are trained to preserve audio signals other than speech. In such embodiments, different modes can be deployed such as, for example, an instrument (i.e., musical instrument) mode where non-instrument signals are removed, a background capture mode where only background audio is preserved, a public safety mode where only sirens, alarms or other public safety related audio signals are preserved, etc.

In still other embodiments, a DNN model as discussed herein can be employed to modulate active noise cancellation (ANC) for audio output associated with a listening device such as, for example, headphones, earphones, or speakers. For example, in an AI-modulated ANC mode, the DNN model can predict whether one or more audio signals include one or more signals of interest (e.g. speech). The DNN model can also be employed to predict one or more frequency bands associated with the one or more signals of interest. Accordingly, a signal employed for ANC (e.g., an anti-noise signal) can be modulated to reduce cancellation in response to the or more signals of interest being detected.

As will be appreciated by one of ordinary skill in the art in view of this disclosure, improved audio processing systems configured as discussed herein are adapted to produce improved audio signals with reduced noise even in view of exacting audio latency requirements. Such reduced noise may be stationary and/or non-stationary noise.

Improved audio processing systems may employ a fewer number of computing resources when compared to traditional audio processing systems that are used for digital signal processing and denoising. Additionally or alternatively, in one or more embodiments, improved audio processing systems may be configured to deploy a smaller number of memory resources allocated to denoising an audio signal sample. In still other embodiments, improved audio processing systems are configured to improve processing speed of denoising operations and/or reduce a number of computational resources associated with applying machine learning models to the task of denoising an audio signal sample. These improvements enable, in some embodiments, for the improved audio processing systems discussed herein to be deployed in microphones or other hardware/software configurations where processing and memory resources are limited, and/or where processing speed is important.

### Definitions

The term “or” is used herein in both the alternative and conjunctive sense, unless otherwise indicated. The terms “illustrative,” “example,” and “exemplary” are used to be examples with no indication of quality level. Like numbers refer to like elements throughout.

The term “comprising” means “including but not limited to,” and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The term “audio signal sample” refers to audio data or an audio data stream or portion thereof that is capable of being transmitted, received, processed, and/or stored in accordance with embodiments of the present invention. In some embodiments, the term audio signal sample refers to a defined portion of an audio signal (e.g., streaming audio data) that is made available for digital signal processing and denoising operations. In one or more embodiments, the audio signal sample is a time domain signal that represents one or more portions of the audio signal based on amplitude and time. An audio signal sample may be configured as a data chunk configured with a window size within a range from 2.5 milliseconds to 50 milliseconds. For example, an audio signal sample may be configured as a 30 milliseconds data chunk of an audio signal stream. In other embodiments, the audio signal sample may be configured as a 2.5 milliseconds data chunk, a 15 milliseconds data chunk, or a 50 milliseconds data chunk of an audio signal stream. In certain embodiments, a DNN model may be provided with input features related to multiple window sizes of an audio signal sample.

In various embodiments, the audio signal sample is a mixed audio signal sample that includes speech and noise (e.g., non-stationary noise). In some embodiments, the audio signal sample is provided by an automixer (e.g., an automatic microphone mixer) that processes one or more audio channels associated with one or more microphones.

The term “mixture audio signal sample” refers to audio data or an audio data stream or portion thereof that is generated based on a plurality of other audio signal samples. A mixture audio signal sample can be configured with a plurality of component audio signal samples.

In embodiments discussed below where a device and/or pipeline (e.g., a time frequency domain transformation pipeline) is described herein as configured to receive an audio signal sample from another device and/or another pipeline, it will be appreciated that the audio signal sample may be received directly from the other device and/or the other pipeline, or may be received indirectly via one or more intermediary devices and/or one or more intermediary pipelines. Similarly, where a device and/or pipeline is described herein as providing an audio signal sample from another device and/or another pipeline, it will be appreciated that the audio signal sample may be provided directly from the another device and/or the another pipeline, or may be provided indirectly via one or more intermediary devices and/or one or more intermediary pipelines. In certain embodiments, denoising may be preceded by a static noise reduction algorithm (e.g., a DSP-based statistic noise reduction algorithm) that provides stationary noise reduction processing of an audio signal sample prior to further non-stationary noise reduction processing of the audio signal sample.

The term “time-frequency domain transformation pipeline” refers to a DSP pipeline (e.g., a chain of audio processing elements) that transforms a time domain signal into a frequency domain signal via one or more digital transformation techniques. For instance, in one or more embodiments, the time-frequency domain transformation pipeline forms part of a DSP process that transforms a time domain signal into a frequency domain signal via one or more digital transformation techniques. In one or more embodiments, the time-frequency domain transformation transforms a segment of a time domain signal into a spectrogram frame that represents the time domain signal based on frequency and time for a specific duration of time. In one or more embodiments, the time-frequency domain transformation pipeline includes a time to frequency digital transform. In such embodiments, the time to frequency digital transform is a Fourier transform (e.g., a fast Fourier transform, a short-time Fourier transform, etc.) and/or a discrete cosine transform (DCT). In certain embodiments, the time-frequency domain transformation transforms a segment of a time domain signal into a cochleagram frame that provides a time-frequency representation of the time domain signal based on a gammatone filter.

The term “DNN processing loop” refers to a deep neural network pipeline that employs machine learning (e.g., deep learning) to predict noise (e.g., non-stationary noise) associated with an audio signal sample. In one or more embodiments, the DNN processing loop employs an artificial intelligence (AI) denoiser to identify noise (e.g., non-stationary noise) in the audio signal sample. In one or more embodiments, the DNN processing loop generates a denoiser mask that can be provided to the time-frequency domain transformation pipeline for application to audio signal samples. In one or more embodiments, the DNN processing loop is configured to process audio signal samples asynchronously from, and in parallel to (e.g., approximately in parallel to), operations performed by the time-frequency domain transformation pipeline.

The term “transformation period” refers to a period of time (e.g., an interval of time) that is deemed appropriate for completing one or more of the transformation pipeline steps. In one embodiment, the transformation period is a predefined time period deemed to approximate the time needed to complete operations for transforming a time domain signal into a frequency domain signal via the time-frequency domain transformation pipeline, for predicting a frequency domain mask, for applying a frequency domain mask to the frequency domain signal, and/or for transforming the frequency domain signal back into a time domain signal.

In another embodiment, the transformation period is a real-time period for transforming a time domain signal segment of time into a frequency domain signal frame via the time-frequency domain transformation pipeline, for predicting a frequency domain mask, for applying a frequency domain mask to the frequency domain signal frame, and/or for transforming the new frequency domain signal frame back into a time domain signal. For instance, in certain embodiments, the transformation period is equal to or less than a duration of the original time domain signal segment. In an example, an audio signal sample provided to the time-frequency domain transformation pipeline may be configured as a 30 milliseconds data chunk. Therefore, in such an example, the transformation period can be 30 milliseconds or less. The transformation period may also be less than or equal to a transformation window for a time domain signal.

The term “denoiser mask” refers to an output mask provided by the DNN processing loop. In one or more embodiments, the denoiser mask is a neural network noise mask provided by a DNN model. The denoiser mask can provide a noise prediction for respective portions of the audio signal sample. In one or more embodiments, the denoiser mask is a “soft” mask that includes a set of values that identify noise in the audio signal sample. For instance, in one or more embodiments, the denoiser mask is a soft mask that provides a set of values ranging from 0 to 1 that correspond to weighted values associated with a degree of noise in respective portions of the audio signal sample.

In other embodiments, the denoiser mask is a time-frequency mask associated with a noise prediction for the audio signal sample. A denoiser mask may be formatted as a spectrogram that provides a set of values ranging from 0 to 1 for the respective portions of the audio signal sample.

The term “time-frequency mask” refers to a denoiser mask that represents masking applied to an audio signal sample based on frequency and time. For example, in certain embodiments, the time-frequency mask is a spectrogram mask formatted based on frequency and time.

The term “denoised audio signal sample” refers to a modified version (e.g., a denoised version) of an audio signal sample where noise is removed or suppressed in accordance with various inventive operations discussed herein. For example, in one or more embodiments, the denoised audio signal sample is an audio signal sample that includes speech and without noise (e.g., without non-stationary noise) or at least with suppressed noise. In one or more embodiments, the denoised audio signal sample is a time domain signal that represents one or more portions of a modified version (e.g., a denoised version) of the audio signal sample based on amplitude and time.

The term “microphone” refers to an audio capturing device configured for capturing audio by converting sound into one or more electrical signals. A microphone can be a condenser microphone, a dynamic microphone, a piezoelectric microphone, an array microphone, one or more beamformed lobes of an array microphone, a linear array microphone, a ceiling array microphone, a table array microphone, a virtual microphone, a network microphone, a ribbon microphone, a micro-electro-mechanical systems (MEMS) microphone, or other types of microphones that will be apparent to one of ordinary skill in the art in view of this disclosure.

Additionally, a microphone as referenced herein can be associated with a polar pattern such as unidirectional, omnidirectional, bi-directional, cardioid, or another polar pattern. In certain embodiments, a microphone can be configured as multiple microphones and/or multiple beamformed lobes. In an embodiment, a microphone can be a wired microphone. In another embodiment, a microphone can be a single microphone array or multiple microphone arrays. In another embodiment, a microphone can be a wireless microphone. In certain embodiments, a microphone can be associated with a conferencing system (e.g., an audio conferencing system, a video conferencing system, a digital conference system, etc.). In certain embodiments, a microphone can be associated with an audio performance system and/or an audio recording system. In certain embodiments, a microphone can be associated with a digital audio workstation. In certain embodiments, a microphone can be associated with a listening functionality on a personal monitoring system such as headphones, earphones, or speakers. In certain embodiments, a microphone can be associated with ambient monitoring functionality. In certain embodiments, a microphone can be associated with public safety monitoring functionality.

The term “user denoiser control parameters” refers to user defined parameters that are used by improved audio processing systems herein described to control a degree of denoi sing for an audio signal sample. In one or more embodiments, the user denoiser control parameters are generated by a client device in response to user engagement with an audio processing control user interface (e.g., an audio processing control electronic interface, an audio processing control graphical user interface, etc.) rendered on a display of the client device. The audio processing control user interface can be configured to present a user engagement denoiser interface to facilitate determination of the user denoiser control parameters. In certain embodiments, the user engagement denoiser interface is a dynamic object that can be modified based on feedback provided by a user. The audio processing control user interface can be associated with a client device interface, a web user interface, a mobile application interface, or the like.

The term “client device” refers to a user device such as a device user interface, a computing device, an embedded computing device, a desktop computer, a laptop computer, a mobile device, a smartphone, a tablet computer, a netbook, a wearable device, a virtual reality device, a hardware interface, a hardware console, a conference unit (e.g., a portable conference unit, a flush-mount conference unit), an audio sound board, an automatic mixer, a channel mixer, a central control unit, a digital mixing unit, or the like. In certain embodiments, a client device can execute an “app” to facilitate obtaining user feedback (e.g., the user denoiser control parameters). Such apps are typically designed to execute on mobile devices, such as tablets or smartphones. For example, an app may be provided that executes on mobile device operating systems such as Apple Inc.'s iOS®, Google Inc.'s Android®, or Microsoft Inc.'s Windows 10®. These platforms typically provide frameworks that allow apps to communicate with one another and with particular hardware and software components of mobile devices. For example, the mobile operating systems named above each provide frameworks for interacting with location services circuitry, wired and wireless network interfaces, and other applications. In some embodiments, a mobile operating system may also provide for improved communication interfaces for interacting with external devices (e.g., DSP devices, microphones, conferencing systems, audio performance systems, audio recording system, and the like). Communication with hardware and software modules executing outside of the app is typically provided via application programming interfaces (APIs) provided by the mobile device operating system. In certain embodiments, the client device can include one or more control mechanisms such as, for example, one or more buttons, one or more knobs, one or more haptic feedback control mechanisms, one or more visual indicators, one or more touch screen interface control mechanisms, and/or one or more other hardware control mechanisms.

The term “audio conferencing processor” refers to a processor configured to execute instructions (e.g., computer program code, computer program instructions, etc.) related to audio conferencing. In one or more embodiments, the audio conferencing processor is a special-purpose electronic chip configured for DSP related to audio conferencing. In this regard, the instructions (e.g., computer program code, computer program instructions, etc.) related to audio conferencing can be optimized for processing by the audio conferencing processor. In certain embodiments, the audio conferencing processor is an embedded computing device or a cloud computing device.

The term “audio networking system” refers to an audio system that employs a digital audio networking protocol to facilitate distribution of audio via a network. The audio networking system generates audio packets based on digital audio. For instance, in one or more embodiments, the audio networking system segments the digital audio and/or formats the digital audio segments into Internet Protocol (IP) packets configured for transmission via an IP network.

The term “dynamic noise reduction interface object” refers to a data structure that includes data representing a degree of noise reduction provided by a denoiser mask. In some embodiments, the dynamic noise reduction interface object is a data structure that includes data for a dynamic noise reduction interface. For instance, the dynamic noise reduction interface object can be provided to a client device via one or more data instructions and a dynamic noise reduction interface can be configured based on the dynamic noise reduction interface object.

The term “dynamic noise reduction interface” refers to a dynamic interface graphic representing a degree of noise reduction provided by a denoiser mask. The dynamic noise reduction interface can be rendered via a display of a client device to visually indicate a degree of noise reduction provided by the denoiser mask. For example, in one or more embodiments, the dynamic noise reduction interface can provide a visualization (e.g., a visual representation) of the dynamic noise reduction interface object to facilitate human interpretation of the degree of noise reduction provided by the denoiser mask. In certain embodiments, the visualization of the dynamic noise reduction interface object includes graphic representation and/or textual representation of the degree of noise reduction provided by the denoiser mask. In certain embodiments, the dynamic noise reduction interface can be a noise reduction loss meter interface associated with the degree of noise reduction provided by the denoiser mask. The dynamic noise reduction interface can be rendered via a user interface (e.g., an electronic interface, a graphical user interface, etc.), a client device interface, a web user interface, a mobile application interface, or the like.

The term “noise reduction loss meter interface” refers to a graphic representation formatted as a meter to allow a user to visually assess the degree of noise reduction provided by the denoiser mask. A greater degree of noise reduction (e.g., a greater time/frequency energy removal of noise) can correspond to a larger value for the noise reduction loss meter interface. For example, the noise reduction loss meter can represent a range between 0 (e.g., where all sound energy is determined to be speech) and 1 (e.g., where all sound is determined to be noise). Furthermore, the range between 0 and 1 represented by the noise reduction loss meter interface can be configured segment by segment and/or averaged over time periods. In certain embodiments, the noise reduction loss meter interface can employ dynamically sized bar graphics and/or dynamically configured colors to visually represent the degree of noise reduction provided by the denoiser mask. In certain embodiments, one or more portions of the noise reduction loss meter interface can be configured to manage audible-related behavior with respect to denoising such as not allowing the noise reduction loss meter interface to display full denoising (e.g., a value of 1) unless time/frequency criteria is met (e.g., not allowing the noise reduction loss meter interface to display full denoising unless bandwidth of the noise that is removed is greater than the speech that is preserved).

The term “frequency domain audio signal sample” refers to an audio signal sample that has been transformed from a time domain audio signal sample. For example, in one or more embodiments, a frequency domain audio signal sample is generated as a result of a time to frequency digital transform of a time domain audio signal sample. In one or more embodiments, the time to frequency digital transform is a Fourier transform (e.g., a fast Fourier transform, a short-time Fourier transform, etc.) and/or a discrete cosine transform. In an aspect, a frequency domain audio signal sample represents one or more segments of the audio signal based on frequency and time. In an embodiment, a frequency domain audio signal sample is represented by a spectrogram. In another embodiment, a frequency domain audio signal sample is represented by a cochleargram. In another embodiment, a frequency domain audio signal sample is represented by a Mel-frequency cepstrum transformation. However, it is to be appreciated that, in certain embodiments, the frequency domain audio signal sample can be represented by a different technique.

The term “DNN model” refers to a neural network that employs deep learning. In one or more embodiments, a DNN model includes an input layer, two or more hidden layers, and/or an output layer. Furthermore, each layer of the DNN model can include multiple nodes configured as a hierarchy of nodes. Each node of the DNN can also be connected to each node in a subsequent layer of the DNN model. For example, each node in the input layer can be connected to each node in a hidden layer, each node in a hidden layer can be connected to each node in another hidden layer or the output layer, etc. Each node of the DNN model can be a computational component of the DNN model. Furthermore, each node of the DNN model can include an input value, a weight value, a bias value, and/or an output value. The DNN model can be configured with a non-linear activation function to produce an output. The DNN model can also be configured with one or more recurrent elements related to audio processing.

The term “convolutional neural network” refers to a type of deep neural network that includes one or more convolutional layers (e.g., one or more filtering layers with filter weights), one or more pooling layers (e.g., one or more subsampling layers), one or more fully connected layers, and/or one or more other layers within a hidden layer.

The term “spatial filtering” refers to post-processing of the denoiser mask to improve audio quality (e.g., speech quality, voice quality, etc.) of the denoised audio signal sample. For example, in one or more embodiments, the spatial filtering can include time/frequency enhancement of the denoiser mask based on a time-varying filter. In certain embodiments, adjacent frequency neighbors can be analyzed to determine whether denoising of the audio signal sample satisfies particular denoising quality criteria (e.g., whether denoising of the audio signal sample is greater than a particular denoising threshold for a particular sub-band). Behavior in a particular sub-band can be analyzed over time to determine coincidence of voice and noise. Furthermore, the spatial filtering can employ one or more filters related to time/frequency such as averaging, median filtering, and/or employing variance or standard deviation to determine a filtering state for the spatial filtering.

The term “user bypass input parameter” refers to a value associated with a user-selected option to bypass a particular functionality related to audio processing. For example, in one embodiment, the user bypass input parameter refers to a value associated with a user-selected option to bypass (e.g., remove) delay applied to the audio signal sample via the time-frequency domain transformation pipeline. In some embodiments, the user bypass input parameter refers to a value associated with a user-selected option to bypass (e.g., skip) application of a denoiser mask associated with the noise prediction to an audio signal sample.

The term “non-uniform-bandwidth frequency domain representation” refers to a data format where certain frequency domains of a frequency domain audio signal sample are removed from the frequency domain audio signal sample to facilitate a reduced amount of data for the frequency domain audio signal sample. In some embodiments, a non-uniform-bandwidth frequency domain representation corresponds to a Bark scale format (e.g., a psychoacoustical scale format) where certain frequency domains of the frequency domain audio signal sample that are generally not heard by a human ear are removed from the frequency domain audio signal sample to facilitate a reduced amount of data for the frequency domain audio signal sample.

The term “user-modified de-speech mask” refers to a denoiser mask without speech that is generated based on user denoiser control parameters during, for example, an audition of noise to be removed from an audio signal sample.

### Exemplary Audio Processing Systems

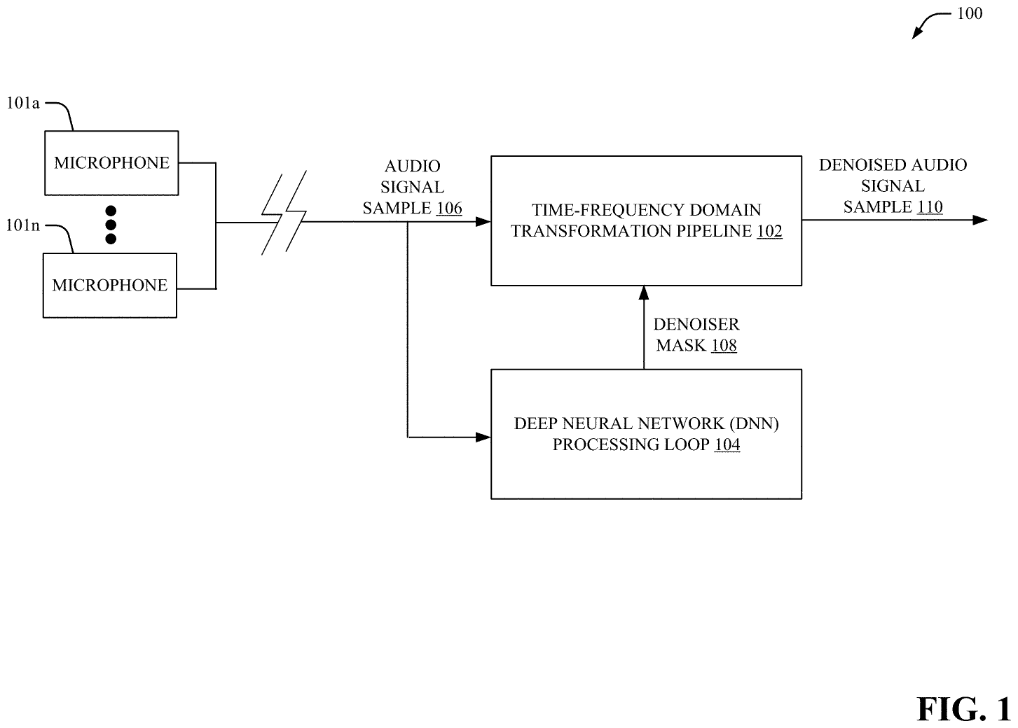

FIG. 1 illustrates an audio processing system 100 that provides an AI denoiser related to audio processing according to one or more embodiments of the present disclosure. The audio processing system 100 is an audio processing system that includes a time-frequency domain transformation pipeline 102 and a deep neural network (DNN) processing loop 104. The audio processing system 100 can be configured to reduce noise from an audio signal sample 106. The audio signal sample 106 can be associated with at least one microphone. For example, the audio signal sample 106 can be generated based on one or more microphones 101a-n. In an embodiment, the audio signal sample 106 can be generated based on a single microphone 101a. In another embodiment, the audio signal sample 106 can be generated based on multiple microphones 101a-n (e.g., at least a first microphone 101a and a second microphone 101b). The audio signal sample 106 can include speech and noise captured via at least one microphone (e.g., via the one or more microphones 101a-n). Additionally or alternatively, in certain embodiments, the audio signal sample 106 can be associated with a plurality of beamformed lobes of a microphone array. Furthermore, the audio signal sample 106 can be, for example, a time domain signal sample. In certain embodiments, the audio signal sample 106 can be a mixture audio signal sample generated based on a plurality of other audio signal samples. In certain embodiments, the audio signal sample 106 can be associated with multiple component audio signal samples.

In one or more embodiments, the audio signal sample 106 can be provided to the time-frequency domain transformation pipeline 102 for a transformation period. The time-frequency domain transformation pipeline 102 can be, for example, an audio processing pipeline that forms part of a DSP process. The transformation period can correspond to a period of time (e.g., an interval of time) that is deemed appropriate for completing one or more of transformation pipeline processes associated with the time-frequency domain transformation pipeline 102.

The audio signal sample 106 can also be provided to the DNN processing loop 104. As such, the audio signal sample 106 can be processed by the DNN processing loop 104 approximately in parallel to processing of the audio signal sample 106 via the time-frequency domain transformation pipeline 102. In certain embodiments, multiple component audio signal samples of the audio signal sample 106 can be provided to the DNN processing loop 104.

The DNN processing loop 104 is employed to suppress noise associated with the audio signal sample 106. The DNN processing loop 104 can be a deep neural network pipeline that employs AI or ML (e.g., deep learning) to determine one or more denoiser masks that can be applied to the audio signal sample 106 in a manner that satisfies exacting conversational speech latency requirements for the time-frequency domain transformation pipeline 102. Furthermore, the DNN processing loop 104 can be asynchronously decoupled from, and in parallel to (e.g., approximately in parallel to), one or more operations performed by the time-frequency domain transformation pipeline 102.

To facilitate suppressing noise associated with the audio signal sample 106, the DNN processing loop 104 can be configured to determine a denoiser mask 108 associated with a noise prediction for the audio signal sample 106. In one or more embodiments, the denoiser mask 108 can be a time-frequency mask associated with noise prediction for the audio signal sample 106. In certain embodiments, the denoiser mask 108 can be formatted as a spectrogram mask that provides a set of values ranging from 0 to 1. The values may be associated with noise prediction for the audio signal sample 106 for each pixel (e.g., each time and frequency component) in the spectrogram mask. As disclosed herein, a “spectrogram mask” refers to a time-frequency mask that is formatted as a spectrogram to digitally represent one or more mask values with respect to respective time values and/or respective frequency values.

The time-frequency domain transformation pipeline 102 is configured to apply the denoiser mask 108 associated with the noise prediction to the audio signal sample 106 associated with the time-frequency domain transformation pipeline 102. The time-frequency domain transformation pipeline 102 can apply the denoiser mask 108 to the audio signal sample 106 to generate a denoised audio signal sample 110 associated with the at least one microphone. For instance, the time-frequency domain transformation pipeline 102 can be configured to apply the denoiser mask 108 to a frequency domain version of the audio signal sample 106 to generate the denoised audio signal sample 110.

The denoiser mask can be applied to the audio signal sample 106 (e.g., the frequency domain version of the audio signal sample 106) via a matrix multiplication process to produce the denoised audio signal sample 110 (e.g., a denoised audio sample spectrogram). For example, the denoiser mask can be applied to the audio signal sample 106 via a Hadamard product to produce the denoised audio signal sample 110. In an embodiment, each cell or pixel represented as a respective time and frequency component in the denoiser mask is applied to each cell or pixel represented as the respective time and frequency component in the audio signal sample 106 to produce the denoised audio signal sample 110. In certain embodiments where the time-frequency domain transformation pipeline 102 configures the audio signal sample 106 as an audio sample spectrogram, the denoiser mask 108 formatted as a spectrogram mask can be applied to the audio signal sample 106 to produce a denoised audio sample spectrogram.

In one embodiment, the denoiser mask 108 can be a denoiser mask generated by a DNN model configured to predict noise associated with the audio signal sample 106. Furthermore, the time-frequency domain transformation pipeline 102 can be configured to apply the denoiser mask 108 (e.g., the denoiser mask generated by the DNN model) to the audio signal sample 106 to generate the denoised audio signal sample 110. The time-frequency domain transformation pipeline 102 can apply the denoiser mask 108 to the audio signal sample 106 in a circumstance where the denoiser mask 108 is determined prior to expiration of the transformation period.

It is important that audio processing systems configured in accordance with various embodiments discussed herein do not cause undue delays in digital signal processing of the audio signal sample 106. If such delays, also referred to herein as latency or latency effects, were introduced, they might create user-perceivable issues in the audio signal output. As such, it is desirable to accomplish one or more digital signal processing tasks of the audio signal sample 106 within a transformation period that corresponds to a period of time that is deemed appropriate for completing the one or more digital signal processing tasks of the audio signal sample 106.

The depicted time-frequency domain transformation is configured to process the audio signal sample 106 during a transformation period. Thus, the parallel or asynchronous operations occurring within the DNN processing loop 104 are desirably completed within the transformation period to avoid introducing new latency effects.

The DNN processing loop 104 can generate a new denoiser mask each time an audio signal sample is received by the DNN processing loop 104. In various circumstances, the DNN processing loop 104 can generate new denoiser mask (e.g., the denoiser mask 108) within a transformation period. However, in some circumstances, the depicted DNN processing loop 104 may be unable to determine a new denoiser mask for an audio signal sample within the transformation period (i.e., the denoiser mask is not determined until expiration of the transformation period). In such circumstances, the denoiser mask 108 can be a default denoiser mask associated with a default noise prediction (e.g., a predetermined denoiser mask associated with a predetermined noise prediction).

The depicted time-frequency domain transformation pipeline 102 can be configured to apply the denoiser mask 108 (e.g., the default denoiser mask) to the audio signal sample 106 associated with the time-frequency domain transformation pipeline 102 (e.g., to generate the denoised audio signal sample 110) in a circumstance where the denoiser mask 108 generated by the DNN model is not determined prior to expiration of the transformation period.

In certain embodiments in which the DNN processing loop 104 completes its operations late (e.g., not within the transformation period), the denoiser mask 108 can be a predicted denoiser mask and/or a prior denoiser mask associated with a prior noise prediction (e.g., a previously determine denoiser mask associated with a previously determined noise prediction). The depicted time-frequency domain transformation pipeline 102 can be configured to apply the denoiser mask 108 (e.g., the prior denoiser mask) to the audio signal sample 106 associated with the time-frequency domain transformation pipeline 102 (e.g., to generate the denoised audio signal sample 110) in a circumstance where the denoiser mask 108 generated by the DNN model is not determined prior to expiration of the transformation period.

In certain embodiments, the DNN processing loop 104 and/or the time-frequency domain transformation pipeline 102 can include and/or can be in communication with a buffer that stores one or more prior denoiser masks for employment in certain circumstances where the depicted DNN processing loop 104 is unable to determine the denoiser mask 108 prior to expiration of the transformation period. In certain embodiments, the DNN processing loop 104 modifies the prior denoiser mask (e.g., the prior denoiser mask stored in the buffer) in response to applying the prior denoiser mask to the audio signal sample 106 associated with the time-frequency domain transformation pipeline 102. In certain embodiments, the DNN processing loop 104 applies a prior denoiser mask configured without denoising to the audio signal sample 106 associated with the time-frequency domain transformation pipeline 102 (e.g., to generate the denoised audio signal sample 110) in a circumstance where the denoiser mask 108 generated by the DNN model is not determined prior to expiration of the transformation period.

In certain embodiments, the DNN processing loop 104 applies a passthrough denoiser mask configured without denoising to the audio signal sample 106 associated with the time-frequency domain transformation pipeline 102 (e.g., to generate the denoised audio signal sample 110) in a circumstance where the denoiser mask 108 generated by the DNN model is not determined prior to expiration of the transformation period. In a non-limiting example, all values of the passthrough denoiser mask (e.g., the passthrough denoiser mask configured without denoising) can correspond to “1” or approximately “1.”

In certain embodiments, the DNN processing loop 104 applies a band-pass shape denoiser mask to the audio signal sample 106 associated with the time-frequency domain transformation pipeline 102 (e.g., to generate the denoised audio signal sample 110) in a circumstance where the denoiser mask 108 generated by the DNN model is not determined prior to expiration of the transformation period. The band-pass shape denoiser mask can be configured to emphasize speech frequencies and deemphasize noise frequencies. In certain embodiments, the DNN processing loop 104 applies a low-pass shape denoiser mask to the audio signal sample 106 associated with the time-frequency domain transformation pipeline 102 (e.g., to generate the denoised audio signal sample 110) in a circumstance where the denoiser mask 108 generated by the DNN model is not determined prior to expiration of the transformation period. The low-pass shape denoiser mask can be configured to remove frequency noise above a frequency threshold level (e.g., the low-pass shape denoiser mask can be configured to remove high frequency noise).

The time-frequency domain transformation pipeline 102 can be configured to apply the denoiser mask 108 to the audio signal sample 106 associated with the time-frequency domain transformation pipeline 102 in a circumstance where a user bypass input parameter associated with the time-frequency domain transformation pipeline 102 satisfies a defined bypass criterion. For example, the time-frequency domain transformation pipeline 102 can be configured to apply the denoiser mask 108 to the audio signal sample 106 associated with the time-frequency domain transformation pipeline 102 in response to a determination that the user bypass input parameter provides an indication to apply the denoiser mask 108 to the audio signal sample. However, in some embodiments, the time-frequency domain transformation pipeline 102 can be configured to not apply the denoiser mask 108 to the audio signal sample 106 associated with the time-frequency domain transformation pipeline 102 in response to a determination that the user bypass input parameter provides an indication to bypass (e.g., not apply) the denoiser mask 108 to the audio signal sample.

In certain embodiments, the time-frequency domain transformation pipeline 102 and the DNN processing loop 104 can transform the audio signal sample 106 into respective frequency domain audio signal samples to facilitate denoising of the audio signal sample 106. A frequency domain audio signal sample can represent the audio signal sample 106 based on frequency and time. For instance, a frequency domain audio signal sample can be represented as a spectrogram, a cochleargram, or another type digital representation of an audio signal sample based on frequency and time. In this regard, the time-frequency domain transformation pipeline 102 can transform the audio signal sample 106 into a first frequency domain audio signal sample. Furthermore, the DNN processing loop 104 can transform the audio signal sample 106 into a second frequency domain audio signal sample. The second frequency domain audio signal sample can be provided to a DNN model of the DNN processing loop 104 that is configured to determine the denoiser mask 108.

In certain embodiments, the DNN processing loop 104 can configure the second frequency domain audio signal sample as a non-uniform-bandwidth frequency domain representation of the audio signal sample 106. For example, in certain embodiments, the DNN processing loop 104 can configure the second frequency domain audio signal sample in a Bark scale format of the audio signal sample 106. Additionally, in a circumstance where the denoiser mask 108 provided by the DNN model is determined prior to expiration of the transformation period, the time-frequency domain transformation pipeline 102 can apply the denoiser mask 108 to the first frequency domain audio signal sample to generate the denoised audio signal sample 110. In certain embodiments where the audio signal sample 106 is a mixture audio signal, the respective component audio signal samples of the mixture audio signal sample can be provided to the DNN model.

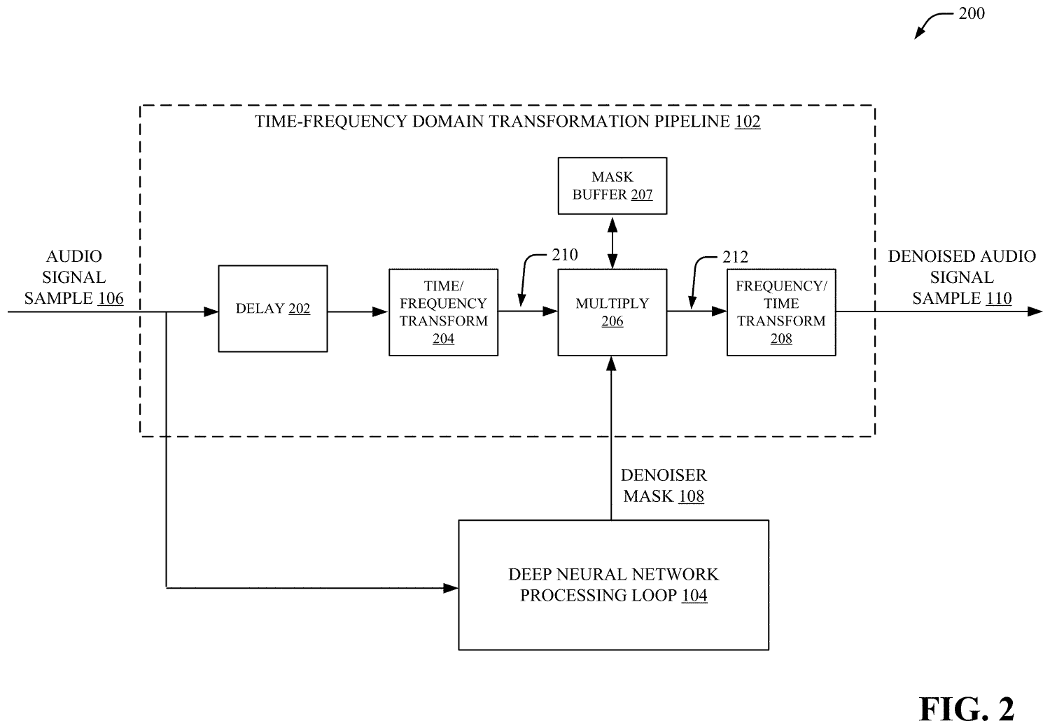

FIG. 2 illustrates an audio processing system 200 that provides an AI denoiser related to audio processing according to one or more embodiments of the present disclosure. The audio processing system 200 is an audio processing system that includes the time-frequency domain transformation pipeline 102 and the DNN processing loop 104. The audio processing system 200 can be configured to reduce noise from an audio signal sample 106. Furthermore, the time-frequency domain transformation pipeline 102 can include a delay 202, a time/frequency transform 204, a multiply 206, and/or a frequency/time transform 208.

The time-frequency domain transformation pipeline 102 can be a DSP pipeline (e.g., a chain of audio processing elements) that transforms the audio signal sample 106 into the denoised audio signal sample 110 via one or more digital transformation techniques and/or the denoiser mask 108 provided by the DNN processing loop 104. In this regard, the audio signal sample 106 can be provided to the delay 202 to add a certain period of delay to the processing of the audio signal sample 106. For instance, the delay 202 can be configured to lengthen a time period (e.g., a data chunk length) associated with the audio signal sample 106 to facilitate parallel processing between the time-frequency domain transformation pipeline 102 and the DNN processing loop 104. In an aspect, the delay 202 can be configured to add a certain amount of delay to the audio signal sample 106 to facilitate alignment of the time-frequency domain transformation pipeline 102 with the DNN processing loop 104. For example, the delay 202 can be configured to add a certain amount of delay to the audio signal sample 106 to facilitate alignment of one or more portions of the time-frequency domain transformation pipeline 102 with the denoiser mask 108 provided by the DNN processing loop 104.

In certain embodiments, the delay 202 can be configured to add a certain amount of delay to the audio signal sample 106 in response to a determination that a user bypass input parameter associated with the time-frequency domain transformation pipeline satisfies a defined bypass criterion. For example, the delay 202 can be configured to add a certain amount of delay to the audio signal sample 106 in response to a determination that the user bypass input parameter provides an indication to apply the delay. However, in some embodiments, the delay 202 can be configured to not add a certain amount of delay to the audio signal sample 106 in response to a determination that the user bypass input parameter provides an indication to bypass (e.g., not apply) the delay.

In certain embodiments, the delay 202 can be less than user bypass input parameter to align the time-frequency domain transformation pipeline 102 with the DNN processing loop 104. For example, the delay 202 can be configured less than a block size and/or a computation time to reduce denoising operation latency of the denoised audio signal sample 110 with respect to the audio signal sample 106. In an embodiment, the delay 202 can be implemented prior to the time/frequency transform 204. However, in another embodiment, the delay 202 can be implemented after the time/frequency transform 204.

The audio signal sample 106 (e.g., a delayed version of the audio signal sample 106) can be provided to the time/frequency transform 204. The time/frequency transform 204 can be configured to transform the audio signal sample 106 (e.g., a time domain signal sample version of the audio signal sample 106) into a frequency domain audio signal sample 210 (e.g., a frequency domain audio signal sample version of the audio signal sample 106).

In certain embodiments, the time/frequency transform 204 can include a Fourier transform (e.g., a fast Fourier transform, a short-time Fourier transform, etc.) that transforms the audio signal sample 106 into the frequency domain audio signal sample 210. In certain embodiments, the time/frequency transform 204 can include a discrete cosine transform that transforms the audio signal sample 106 into the frequency domain audio signal sample 210. In certain embodiments, the time/frequency transform 204 can include a cochleargram transform that transforms the audio signal sample 106 into the frequency domain audio signal sample 210. In certain embodiments, the time/frequency transform 204 can include a wavelet transform that transforms the audio signal sample 106 into the frequency domain audio signal sample 210. In certain embodiments, the time/frequency transform 204 can include one or more filter banks that facilitates transforming the audio signal sample 106 into the frequency domain audio signal sample 210.

The transformation period associated with the time-frequency domain transformation pipeline 102 can correspond to a time period that begins when the audio signal sample 106 is provided to the time-frequency domain transformation pipeline 102 and/or the DNN processing loop 104, and end when the frequency domain audio signal sample 210 is generated via the time/frequency transform 204. Alternatively, the transformation period associated with the time-frequency domain transformation pipeline 102 can be a predetermined time period.

The multiply 206 can be configured to apply the denoiser mask 108 to the frequency domain audio signal sample 210. For example, the multiply 206 can be configured to perform a multiply function, such as, for example, a Hadamard product, to apply the denoiser mask 108 to the frequency domain audio signal sample 210. In response to applying the denoiser mask 108 to the frequency domain audio signal sample 210, a denoised frequency domain audio signal sample 212 can be generated.

The frequency/time transform 208 can be configured to transform the denoised frequency domain audio signal sample 212 into the denoised audio signal sample 110. The denoised audio signal sample 110 can be, for example, a denoised time domain signal sample (e.g., a denoised version of the audio signal sample 106). The frequency/time transform 208 can include an inverse Fourier transform (e.g., an inverse fast Fourier transform, an inverse short-time Fourier transform, an inverse discrete cosine transform, an inverse cochleargram transform, etc.) that transforms the denoised frequency domain audio signal sample 212 into the denoised audio signal sample 110 associated with the time domain.

Phase of the frequency domain audio signal sample 210 can be preserved and, in one or more embodiments, magnitudes can be matrix multiplied such that the original phase of the frequency domain audio signal sample 210 is combined with the denoised frequency domain audio signal sample 212 and provided to send to the frequency/time transform 208. In an embodiment, the multiply 206 can employ a matrix multiply. Furthermore, in certain embodiments, phase is not predicted by the DNN processing loop 104 and/or phase is concatenated in the denoised frequency domain audio signal sample 212 prior to being provided to the frequency/time transform 208.

In certain embodiments, the time-frequency domain transformation pipeline 102 can include and/or can be in communication with a mask buffer 207 that stores one or more prior denoiser masks, one or more passthrough denoiser masks, one or more band-pass shape denoiser mask, one or more low-pass shape denoiser mask, and/or one or more other denoiser masks for employment in certain circumstances where the DNN processing loop 104 is unable to determine the denoiser mask 108 prior to expiration of the transformation period. In such embodiments, the multiply 206 can be configured to apply a prior denoiser mask, a passthrough denoiser mask, a band-pass shape denoiser mask, a low-pass shape denoiser mask, and/or another denoiser mask stored in the mask buffer 207 to the frequency domain audio signal sample 210 to generate the denoised frequency domain audio signal sample 212.

A prior denoiser mask stored in the mask buffer 207 can also be repeatedly modified at a particular rate toward a defined denoising value to facilitate applying the prior denoiser mask to the frequency domain audio signal sample 210 during future circumstances where the DNN processing loop 104 is unable to determine the denoiser mask 108 prior to expiration of the transformation period.

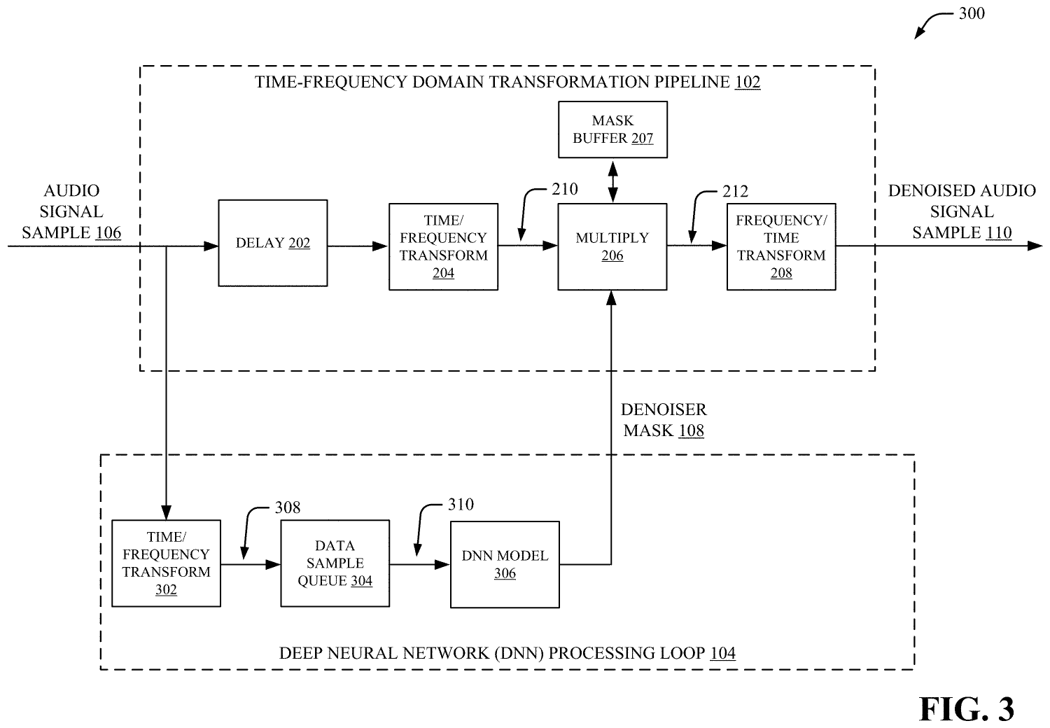

FIG. 3 illustrates an audio processing system 300 that provides an AI denoiser related to audio processing according to one or more embodiments of the present disclosure. The audio processing system 300 is an audio processing system that includes the time-frequency domain transformation pipeline 102 and the DNN processing loop 104. The audio processing system 300 can be configured to reduce noise from an audio signal sample 106. The time-frequency domain transformation pipeline 102 can include the delay 202, the time/frequency transform 204, the multiply 206, the mask buffer 207, and/or the frequency/time transform 208. Furthermore, the DNN processing loop 104 can include time/frequency transform 302, a data sample queue 304, and/or a DNN model 306.

The DNN processing loop 104 can be a DNN pipeline that employs machine learning (e.g., deep learning) to predict noise (e.g., non-stationary noise) associated with the audio signal sample 106. For instance, the DNN processing loop 104 can employ the DNN model 306 to identify noise (e.g., non-stationary noise) in the audio signal sample 106. To facilitate machine learning with respect to the audio signal sample 106, the audio signal sample 106 can be provided to the time/frequency transform 302. The time/frequency transform 302 can be configured to transform the audio signal sample 106 (e.g., a time domain signal sample version of the audio signal sample 106) into a frequency domain audio signal sample 308 (e.g., a frequency domain audio signal sample version of the audio signal sample 106).

In certain embodiments, the time/frequency transform 302 can include a Fourier transform (e.g., a fast Fourier transform, a short-time Fourier transform, etc.) that transforms the audio signal sample 106 into the frequency domain audio signal sample 308. In certain embodiments, the time/frequency transform 302 can include a discrete cosine transform that transforms the audio signal sample 106 into the frequency domain audio signal sample 308. In certain embodiments, the time/frequency transform 302 can include a cochleargram transform that transforms the audio signal sample 106 into the frequency domain audio signal sample 308. In certain embodiments, the time/frequency transform 302 can include a wavelet transform that transforms the audio signal sample 106 into the frequency domain audio signal sample 308.

In certain embodiments, the time/frequency transform 302 can include one or more filter banks that facilitates transforming the audio signal sample 106 into the frequency domain audio signal sample 308. The time/frequency transform 302 of the DNN processing loop 104 increases computational efficiency between the processing thread of the DNN processing loop 104 and the processing thread of the time-frequency domain transformation pipeline 102. For example, the time/frequency transform 302 of the DNN processing loop 104 can increase computational efficiency by providing separation between the time/frequency transform 204 and the time/frequency transform 302 onto separate processing threads.

In certain embodiments, the frequency domain audio signal sample 308 can be provided to the data sample queue 304 to facilitate providing input data to the DNN model 306. For example, a set of data samples 310 (e.g., a set of frequency data points) associated with the frequency domain audio signal sample 308 can be stored in the data sample queue 304. The set of data samples 310 stored in the data sample queue 304 can be provided as input to the DNN model 306. In certain embodiments, respective component audio signal samples of the audio signal sample 106 can be provided to the DNN model 306.

The DNN model 306 can perform deep learning associated with noise prediction to generate the denoiser mask 108. In an embodiment, the denoiser mask 108 can include a set of mask data samples (e.g., a set of frequency masks) associated with noise prediction for the audio signal sample 106. In certain embodiments, the DNN model 306 can be a convolutional neural network. In certain embodiments, the DNN model 306 can be a recurrent neural network. However, it is to be appreciated that, in certain embodiments, the DNN model 306 can be configured as a different type of deep neural network.

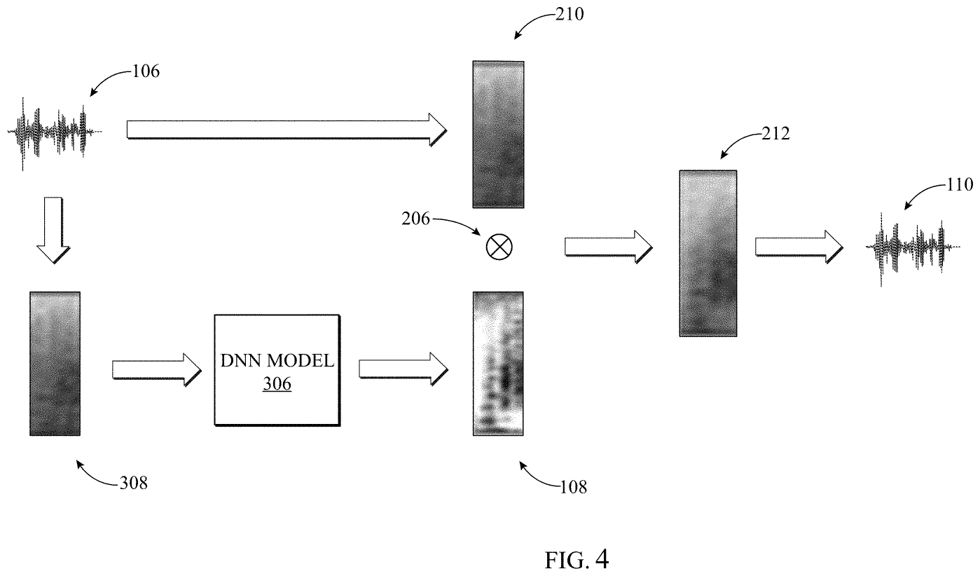

FIG. 4 illustrates processing performed by the time-frequency domain transformation pipeline 102 and the DNN processing loop 104 according to one or more embodiments of the present disclosure. The time-frequency domain transformation pipeline 102 can transform the audio signal sample 106 into the frequency domain audio signal sample 210 that is formatted as a linear input spectrogram. Approximately in parallel to the processing performed by the time-frequency domain transformation pipeline 102, the DNN processing loop 104 can transform the audio signal sample 106 into the frequency domain audio signal sample 308 that is formatted as a linear input spectrogram. The DNN processing loop 104 can provide the frequency domain audio signal sample 308 to the DNN model 306. Based on deep learning training operations with respect to the frequency domain audio signal sample 308, the DNN model 306 can output the denoiser mask 108 formatted as a linear mask.

In another embodiment, the multiply 206 associated with the time-frequency domain transformation pipeline 102 can apply the denoiser mask 108 to the frequency domain audio signal sample 210 to generate the denoised frequency domain audio signal sample 212 formatted as a denoised spectrogram. The time-frequency domain transformation pipeline 102 can perform the frequency/time transform 208 of the denoised frequency domain audio signal sample 212 to generate the denoised audio signal sample 110.

In an embodiment, the frequency domain audio signal sample 210, the frequency domain audio signal sample 308, the denoiser mask 108, and the denoised frequency domain audio signal sample 212 is formatted with f rows and t columns in a spectrogram (e.g., f×t spectrogram dimensionality). However, in an embodiment related to perceptual transforms (e.g., bark scale transforms, wavelet transforms, binary tree transforms, filter bank transforms, etc.), the frequency domain audio signal sample 308 can be transformed into a transformed frequency domain audio signal sample formatted with z rows and t columns, where z is typically smaller than f.

In the embodiment related to perceptual transforms (e.g., bark scale transforms), the transformed frequency domain audio signal sample formatted with z rows and t columns can then be provided to the DNN model 306 and the DNN model 306 can provide the denoiser mask 108 with z rows and t columns. The denoiser mask 108 with z rows and t columns can then be inverse transformed into a linear mask with f rows and t columns. Alternatively, the denoiser mask 108 with z rows and t columns can be applied to a transformed version of the frequency domain audio signal sample 210 with z rows and t columns to provide a modified denoised frequency domain audio signal sample with z rows and t columns that can be transformed into the denoised frequency domain audio signal sample 212 with f rows and t columns.

In some embodiments, f rows can be summed within z bins for every t column to transform a spectrogram with f rows and t columns into a spectrogram formatted with z rows and t columns. For example, linear components of a spectrogram can be grouped into perceptual bins (e.g., the z bins) to provide a new spectrogram formatted with a lower number of rows. The new spectrogram formatted with the lower number of rows can, for example, reduce processing time by the DNN model 306. In one or more embodiments, the z bins can be data bins corresponding to critical bands of a human hear to thereby reduce an amount of data processed by the DNN model 306 and/or to increase likelihood of the denoiser mask 108 being generated within the transformation period. For instance, the z bins can be data bins corresponding to one or more frequency ranges able to be heard by a normal human ear.

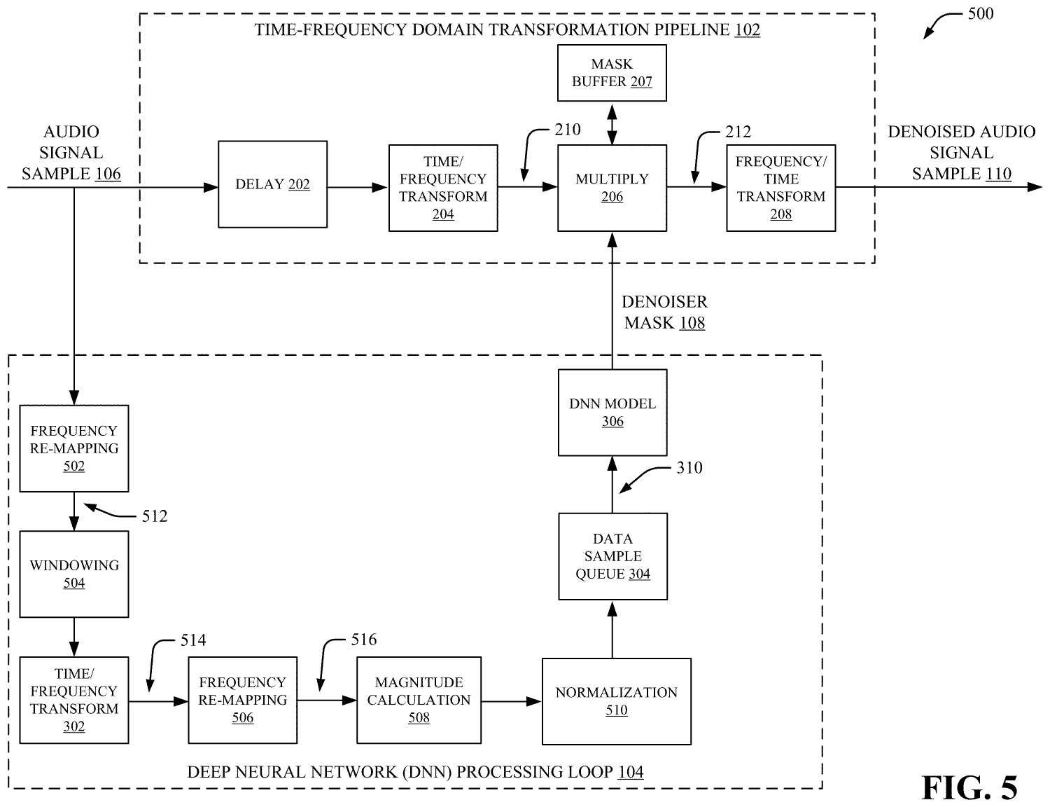

FIG. 5 illustrates an audio processing system 500 that provides an AI denoiser related to audio processing according to one or more embodiments of the present disclosure. The audio processing system 500 is an audio processing system that includes the time-frequency domain transformation pipeline 102 and the DNN processing loop 104. The audio processing system 500 can be configured to reduce noise from an audio signal sample 106. The time-frequency domain transformation pipeline 102 can include the delay 202, the time/frequency transform 204, the multiply 206, the mask buffer 207, and/or the frequency/time transform 208. Furthermore, the DNN processing loop 104 can include frequency re-mapping 502, windowing 504, the time/frequency transform 302, frequency re-mapping 506, a magnitude calculation 508, normalization 510, the data sample queue 304, and/or the DNN model 306.

To reduce computation time and/or lower input dimensionality to the DNN model 306, the audio signal sample 106 can be provided to the frequency re-mapping 502. The frequency re-mapping 502 can be configured to modify (e.g., scale) frequency of one or more portions of the audio signal sample 106 to generate a modified audio signal sample 512. The modified audio signal sample 512 can be a modified version of the audio signal sample 106 where a frequency scale for the modified audio signal sample 512 is different than a frequency scale for the audio signal sample 106. For example, the audio signal sample 106 can be associated with a first frequency scale (e.g., a uniformly spaced frequency representation) and the modified audio signal sample 512 can be associated with a second frequency scale (e.g., a non-uniformly spaced frequency representation). A combination of the frequency re-mapping 502, the windowing 504 and the time/frequency transform 302 can correspond to a warped discrete Fourier transform.

The frequency re-mapping 502 can employ one or more digital filters associated with one or more frequency warping operations (e.g., a bilinear transform, an all-pass transformation, etc.) to provide the modified audio signal sample 512. In one or more embodiments, the windowing 504 can perform one or more windowing operations with respect to the modified audio signal sample 512 to segment the modified audio signal sample 512 into a set of segmented portions for processing by the time/frequency transform 302. The time/frequency transform 302 can be configured to transform the modified audio signal sample 512 (e.g., a time domain signal sample version of the modified audio signal sample 512) into a frequency domain audio signal sample 514 (e.g., a frequency domain audio signal sample version of the modified audio signal sample 512). In certain embodiments, the time/frequency transform 302 can be the same as the time/frequency transform 204 (e.g., the time/frequency transform 302 and the time/frequency transform 204 can be configured as a single time/frequency transform).

The frequency re-mapping 506 facilitates reduced latency by reducing computation time and/or by lowering input dimensionality to the DNN model 306. For example, the frequency re-mapping 506 can be configured for remapping and/or reducing frequency dimensionality for the DNN model 306. Furthermore, the frequency re-mapping 502 facilitates improved quality of the denoiser mask 108 by allocating lower frequencies to the DNN model 306 and/or by reducing a number of computing resources allocated to higher frequencies (e.g., similar to how a human ear operates). For example, the frequency re-mapping 502 can be configured for improved accuracy of the denoiser mask 108.

In one or more embodiments, the frequency domain audio signal sample 514 can be provided to the frequency re-mapping 506. The frequency re-mapping 506 can be configured to modify (e.g., scale) frequency of one or more portions of the frequency domain audio signal sample 514 to generate a modified frequency domain audio signal sample 516 (e.g., Bark scale). The modified frequency domain audio signal sample 516 can be a modified version of the frequency domain audio signal sample 514 where a frequency scale for the modified frequency domain audio signal sample 516 is different than a frequency scale for the frequency domain audio signal sample 514. For example, the frequency domain audio signal sample 514 can be associated with the second frequency scale (e.g., Bark scale) and the modified frequency domain audio signal sample 516 can be associated with the frequency scale (e.g., frequency domain).

In some embodiments, the frequency re-mapping 506 can employ one or more digital filters and/or one or more transformation filters associated with one or more frequency warping operations (e.g., a bilinear transform, a Bark transformation, etc.) to provide the modified frequency domain audio signal sample 516. In certain embodiments, the magnitude calculation 508 can determine magnitude of one or more portions of the modified frequency domain audio signal sample 516. The magnitude calculation 508 can facilitate generation of a magnitude spectrogram associated with the modified frequency domain audio signal sample 516. Based on the magnitude of one or more portions of the modified frequency domain audio signal sample 516 (e.g., based on the magnitude spectrogram associated with the modified frequency domain audio signal sample 516), the normalization 510 can normalize an energy mean and/or a variance of the modified frequency domain audio signal sample 516.

The modified frequency domain audio signal sample 516 can be provided to the data sample queue 304 to facilitate providing input data to the DNN model 306. For example, in one or more embodiments, a set of data samples (e.g., a set of frequency data points) associated with the modified frequency domain audio signal sample 516 can be stored in the data sample queue 304. The modified frequency domain audio signal sample 516 can facilitate reducing latency between the DNN processing loop 104 and the time-frequency domain transformation pipeline 102 by reducing processing time related to the DNN model 306. In an embodiment, the modified frequency domain audio signal sample 516 can facilitate generation of the denoiser mask 108 within the transformation period. In an embodiment, the modified frequency domain audio signal sample 516 can facilitate a reduction of the transformation period associated with processing of the audio signal sample 106 by the time-frequency domain transformation pipeline 102 and/or the DNN processing loop 104.

In certain embodiments, input dimensionality of the DNN model 306 can be increased to include multiple time resolutions (e.g., multiple window sizes) to provide improved time resolution and/or improved frequency resolution simultaneously. For instance, in certain embodiments, the frequency domain audio signal sample 308 can be configured as a concatenation of multiple window sizes. As an example, one data window of 1024 samples, two data windows of 512 samples, and/or four data windows of 256 can be provided to the DNN model 306. The DNN model 306 can be configured, in certain embodiments, with downsampling and/or data duplication in one or more network layers of the DNN model 306 to process multi-resolution input data and/or to produce N instances of denoiser masks matching a frequency resolution of the time/frequency transform 204 that can be directly applied via the multiply 206, where N is an integer. Therefore, in certain embodiments, multiple sized data windows for data stored in the data sample queue 304 can be provided to the DNN model 306.

In one or more embodiments, the set of data samples stored in the data sample queue 304 can be provided as input to the DNN model 306. The DNN model 306 can perform deep learning associated with noise prediction to generate the denoiser mask 108. The denoiser mask 108 can include a set of mask data samples (e.g., a set of frequency masks) associated with noise prediction for the audio signal sample 106. In certain embodiments, the DNN model 306 can be a convolutional neural network. In certain embodiments, the DNN model 306 can be a recurrent neural network. In certain embodiments, the DNN model 306 can be a hybrid network associated with a set of convolutional layers and a set of recurrent layers. However, it is to be appreciated that, in certain embodiments, the DNN model 306 can be configured as a different type of deep neural network.

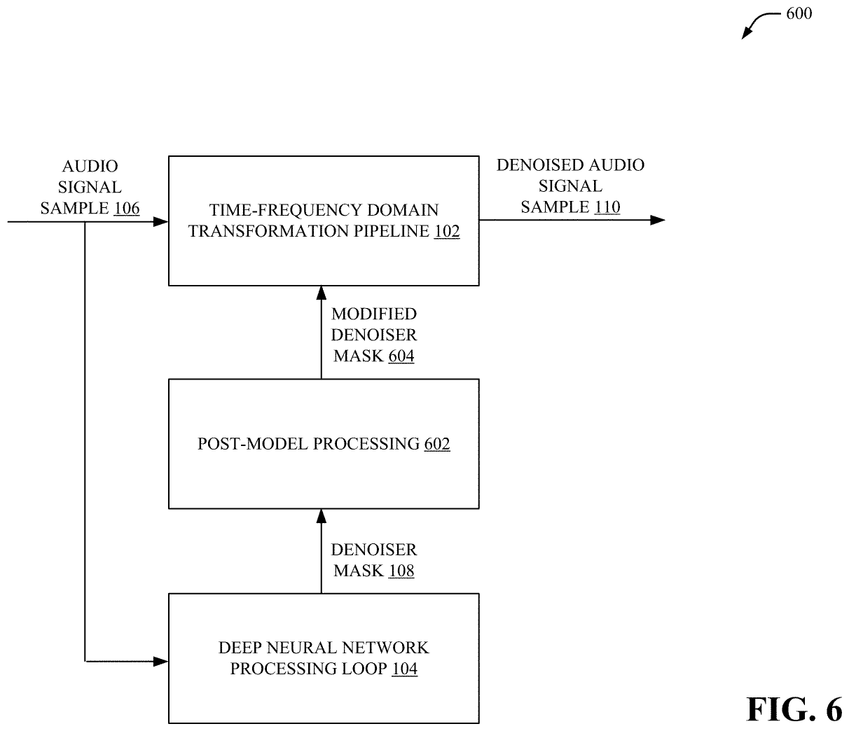

FIG. 6 illustrates an audio processing system 600 that provides an AI denoiser related to audio processing according to one or more embodiments of the present disclosure. The audio processing system 600 is an audio processing system that includes the time-frequency domain transformation pipeline 102, the DNN processing loop 104, and post-model processing 602. The audio processing system 600 can be configured to reduce noise from an audio signal sample 106. The time-frequency domain transformation pipeline 102 can include the delay 202, the time/frequency transform 204, the multiply 206, and/or the frequency/time transform 208. Furthermore, the DNN processing loop 104 can include the frequency re-mapping 502, the windowing 504, the time/frequency transform 302, the frequency re-mapping 506, the magnitude calculation 508, the normalization 510, the data sample queue 304, and/or the DNN model 306.

The post-model processing 602 can be employed to enhance (e.g., optimize) the denoiser mask 108. In one or more embodiments, the post-model processing 602 can perform one or more audio processing techniques to modify the denoiser mask 108 and generate a modified denoiser mask 604. For example, in certain embodiments, the post-model processing 602 can alter one or more values of the denoiser mask 108 (e.g., one or more frequency values of the denoiser mask 108) to generate the modified denoiser mask 604.

In certain embodiments, the post-model processing 602 can perform one or more DSP processing techniques to post-process the denoiser mask 108 and/or to apply noise removal capabilities higher than a sample rate at which the DNN model 306 operates. For example, the audio signal sample 106 can be associated with a first sampling rate (e.g., 48 kHz) and the DNN model 306 can be associated with a second sampling rate (e.g., 8 kHz, 12 kHz, 16 kHz, or 32 kHz) and the post-model processing 602 can facilitate applying the denoiser mask 108 associated with the second sampling rate to the audio signal sample 106 can be associated with a first sampling rate.

The post-model processing 602 can employ a combinatorial function to create estimated masks above a bandwidth of the DNN model 306. For example, the combinatorial function can be a linear combination of calculated masks to apply to the denoiser mask 108. In another embodiment, the combinatorial function can apply a set of extended masks to the denoiser mask 108. In certain embodiments, the set of extended masks can be created using a spectral band replication process of continuing trends related to frequency periodicity of a fundamental frequency associated with the denoiser mask 108.

In another embodiment, the combinatorial function can apply an optimized curve fit to the denoiser mask 108. The optimized curve fit can be associated with an algebraic expression related to a shape of a highest frequency calculated mask to model shaped noise. Additionally, in a circumstance where the modified denoiser mask 604 is determined prior to expiration of the transformation period, the modified denoiser mask 604 can be applied to the audio signal sample 106 associated with the time-frequency domain transformation pipeline 102 to generate the denoised audio signal sample 110 (e.g., an optimized version of the denoised audio signal sample 110).

In certain embodiments, the post-model processing 602 can employ estimates of static noise floor of a noise environment to postprocess the denoiser mask 108 into the modified denoiser mask 604. The post-model processing 602 can preserve an original spectral shape of the static noise floor while lowering the static noise floor by a certain decibel value commensurate with one or more user denoiser control parameters. In certain embodiments, the post-model processing 602 is configured for time/frequency filtering of the denoiser mask 108 to, for example, improve voice quality of the denoised audio signal sample 110. In certain embodiments, the post-model processing 602 is configured for frequency axis limiting to, for example improve attenuation of one or more bands of the denoised audio signal sample 110.

In certain embodiments, the post-model processing 602 is configured for performing one or more clipping operations with respect to the denoiser mask 108 to, for example improve attenuation of one or more bands of the denoised audio signal sample 110. In certain embodiments, the post-model processing 602 is configured for inferring a state of audio (e.g., a silence state, a speech only state, a noise only state, a speech+noise state) based on mask statistics associated with the denoiser mask 108.

In certain embodiments, the post-model processing 602 is configured for applying one or more post processing rules based on the state of audio. For example, when in a speech only state, potential attenuation values can be reduced via the post-model processing 602 to further improve speech quality. In another example, when in a noise only state, maximum attenuation can be applied via the post-model processing 602. In certain embodiments, the post-model processing 602 is configured to modify post-processing functionality (e.g., to be more or less conservative) based on user denoiser control parameters (e.g., user denoiser control parameters 704) configured, for example, with an off value, a low value, a medium value, a high value, or another type of value to facilitate post-model processing performed via the post-model processing 602.

In certain embodiments, the post-model processing 602 can be configured to generate a dynamic noise reduction interface object that is configured to cause a client device to render a dynamic noise reduction interface to visually indicate a degree of noise reduction provided by the denoiser mask 108. Additionally, the post-model processing 602 can be configured to output the dynamic noise reduction interface object to the client device. The dynamic noise reduction interface can be configured, in certain embodiments, as a noise reduction loss meter interface associated with the degree of noise reduction provided by the denoiser mask 108.

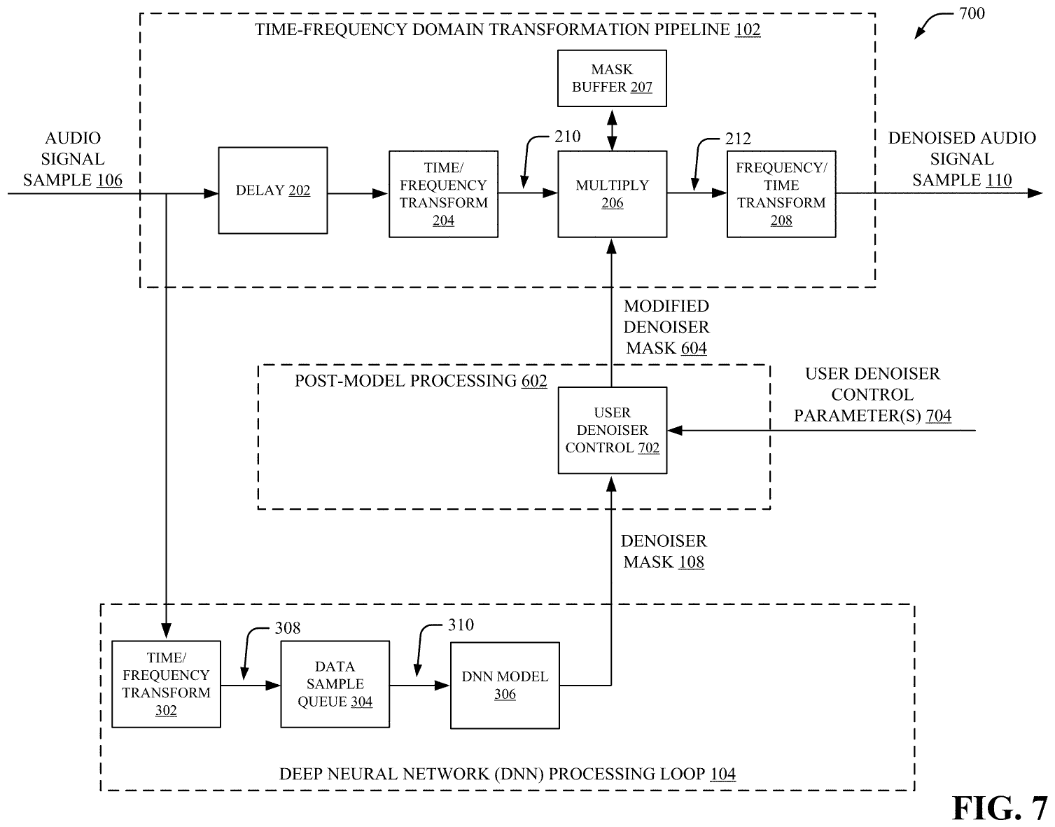

FIG. 7 illustrates an audio processing system 700 that provides an AI denoiser related to audio processing according to one or more embodiments of the present disclosure. The audio processing system 700 is an audio processing system that includes the time-frequency domain transformation pipeline 102, the DNN processing loop 104, and the post-model processing 602. The audio processing system 700 can be configured to reduce noise from an audio signal sample 106. The time-frequency domain transformation pipeline 102 can include the delay 202, the time/frequency transform 204, the multiply 206, the mask buffer 207, and/or the frequency/time transform 208. Furthermore, the DNN processing loop 104 can include the frequency re-mapping 502, the windowing 504, the time/frequency transform 302, the frequency re-mapping 506, the magnitude calculation 508, the normalization 510, the data sample queue 304, and/or the DNN model 306.

To facilitate processing of the denoiser mask 108 based on user input, the post-model processing 602 can include a user denoiser control 702. In one or more embodiments, the user denoiser control 702 can apply a denoiser user level to the denoiser mask 108 to generate the modified denoiser mask 604. For example, the user denoiser control 702 can receive one or more user denoiser control parameters 704. The one or more user denoiser control parameters 704 can be generated by a client device in response to user engagement with an audio processing control user interface. For example, the one or more user denoiser control parameters 704 can be generated via a user engagement denoiser interface associated with an audio processing control user interface. Furthermore, the user denoiser control 702 can apply the one or more user denoiser control parameters 704 to the denoiser mask 108 to generate the modified denoiser mask 604. As such, in an embodiment, the modified denoiser mask 604 can be a user-modified denoiser mask.

In an embodiment, the user denoiser control parameters 704 can be configured with an off value, a low denoising value, a medium denoising value, a high denoising value, or another type of value. Furthermore, the user denoiser control 702 can be configured to modify the denoiser mask 108 (e.g., to generate the modified denoiser mask 604) based on the user denoiser control parameters 704 configured with an off value, a low denoising value, a medium denoising value, a high denoising value, or another type of value. In certain embodiments, the user denoiser control parameters 704 can be mapped to behavior of the DNN model 306 based on time and/or frequency. As the user denoiser control parameters 704 are configured with increased denoising, behavior of mask control can be modified according to perception.

In an example, the user denoiser control 702 can apply a mask attenuation clipping threshold to all frequency regions of the denoiser mask 108 in response to a low denoising value associated with the user denoiser control parameters 704. In another example, the user denoiser control 702 can a mask attenuation clipping threshold to speech frequency regions of the denoiser mask 108 in response to a medium denoising value associated with the user denoiser control parameters 704. In another example, the user denoiser control 702 can withhold from modifying the denoiser mask 108 in response to a high denoising value associated with the user denoiser control parameters 704. In certain embodiments, the user denoiser control 702 can be configured for time filtering based on the user denoiser control parameters 704.

In certain embodiments, the user denoiser control 702 can receive the user denoiser control parameters 704 to facilitate audition of noise to be removed from the audio signal sample 106. The user denoiser control 702 can also apply the user denoiser control parameters 704 associated with the audition of noise to the denoiser mask 108 to generate the modified denoiser mask 604 (e.g., a user-modified de-speech mask). In the circumstance where the modified denoiser mask 604 (e.g., the user-modified de-speech mask) is determined prior to expiration of the transformation period associated with a time-frequency domain transformation pipeline 102, the modified denoiser mask 604 (e.g., a user-modified de-speech mask) can be applied to the frequency domain audio signal sample 210 to generate a user-modified de-speech audio signal sample.

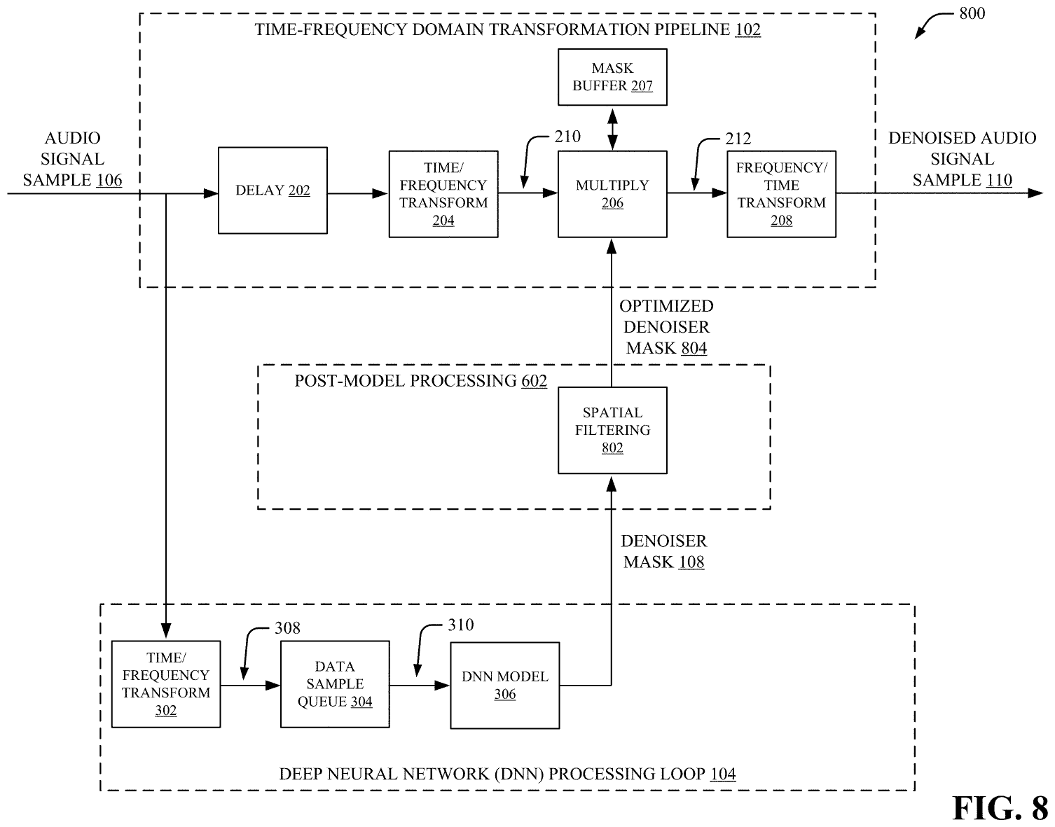

FIG. 8 illustrates an audio processing system 800 that provides an AI denoiser related to audio processing according to one or more embodiments of the present disclosure. The audio processing system 800 is an audio processing system that includes the time-frequency domain transformation pipeline 102, the DNN processing loop 104, and the post-model processing 602. The audio processing system 800 can be configured to reduce noise from an audio signal sample 106. The time-frequency domain transformation pipeline 102 can include the delay 202, the time/frequency transform 204, the multiply 206, the mask buffer 207, and/or the frequency/time transform 208. Furthermore, the DNN processing loop 104 can include the frequency re-mapping 502, the windowing 504, the time/frequency transform 302, the frequency re-mapping 506, the magnitude calculation 508, the normalization 510, the data sample queue 304, and/or the DNN model 306.

The audio processing system 800 can provide improved audio processing for the denoised audio signal sample 110 by providing one or more post-processing techniques via the post-processing pipeline 902. In an embodiment, the post-model processing 602 can include spatial filtering 802. The spatial filtering 802 can perform one or more spatial filtering techniques with respect to the denoiser mask 108 to generate an optimized denoiser mask 804. Furthermore, the spatial filtering 802 can apply spectral weighting to the denoiser mask via one or more spatial filters (e.g., a linear filter, a time-varying filter, a spatial filter transfer function, etc.). Additionally, in a circumstance where the optimized denoiser mask 804 is determined prior to expiration of the transformation period, the optimized denoiser mask 804 can be applied to the audio signal sample 106 associated with the time-frequency domain transformation pipeline 102 to generate the denoised audio signal sample 110 (e.g., an optimized version of the denoised audio signal sample 110).

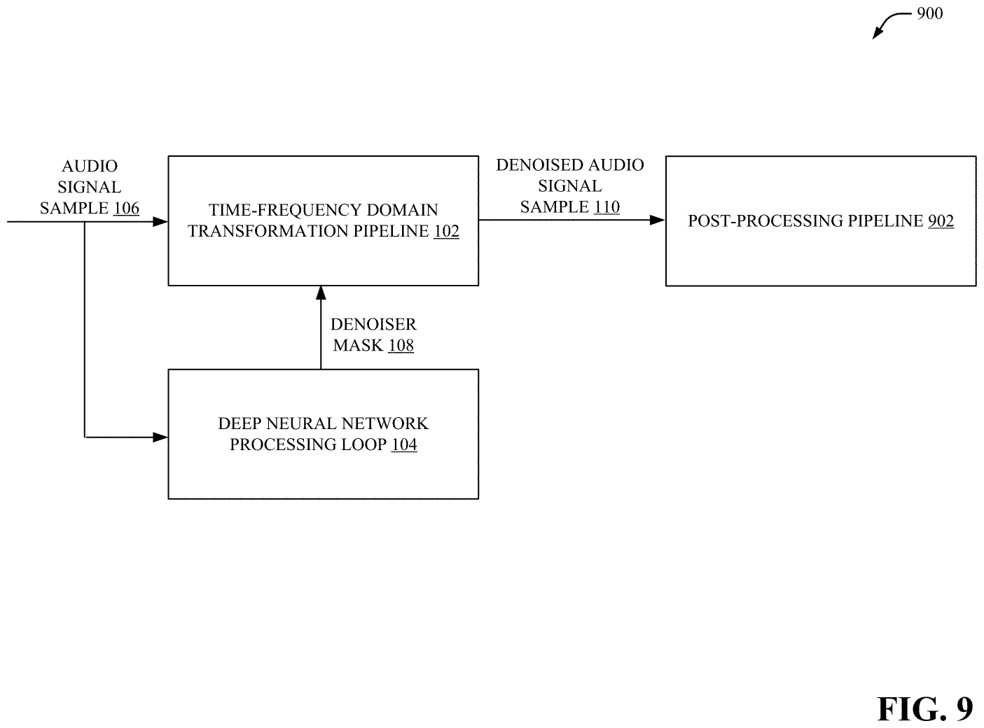

FIG. 9 illustrates an audio processing system 900 that provides an AI denoiser related to audio processing according to one or more embodiments of the present disclosure. The audio processing system 900 is an audio processing system that includes the time-frequency domain transformation pipeline 102, the DNN processing loop 104, and a post-processing pipeline 902. The audio processing system 900 can be configured to reduce noise from an audio signal sample 106. The time-frequency domain transformation pipeline 102 can include the delay 202, the time/frequency transform 204, the multiply 206, and/or the frequency/time transform 208. Furthermore, the DNN processing loop 104 can include the frequency re-mapping 502, the windowing 504, the time/frequency transform 302, the frequency re-mapping 506, the magnitude calculation 508, the normalization 510, the data sample queue 304, and/or the DNN model 306.

The post-processing pipeline 902 can include one or more audio processing elements to facilitate post-processing of the denoised audio signal sample 110. In an embodiment, the post-processing pipeline 902 can include one or more parametric equalizers to modify and/or balance audio frequencies of the denoised audio signal sample 110, one or more compressors to compress a dynamic range of the denoised audio signal sample 110, one or more delays to add delay to the denoised audio signal sample 110, one or more compression codecs (e.g., one or more audio compression codecs and/or one or more video compression codecs), a dynamics processor, a matrix mixer, one or more communication codecs, and/or one or more other audio processing components to enhance the denoised audio signal sample 110.

In certain embodiments, the post-processing pipeline 902 can be associated with an audio conferencing processor. For example, the one or more parametric equalizers, the one or more compressors, the one or more delays, and/or the one or more other audio processing components can be included in an audio conferencing processor.

Additionally or alternatively, the post-processing pipeline 902 can be associated with an audio networking system. For example, the one or more parametric equalizers, the one or more compressors, the one or more delays, the one or more compression codecs, the dynamics processor, the matrix mixer, the one or more communication codecs, and/or the one or more other audio processing components can be included in an audio networking system. In certain embodiments, the post-processing pipeline 902 can enhance the denoised audio signal sample 110 for employment of the denoised audio signal sample 110 by the audio conferencing processor and/or the audio networking system. In an embodiment, the post-processing pipeline 902 configures the denoised audio signal sample 110 as a digital output signal. In another embodiment, the post-processing pipeline 902 configures the denoised audio signal sample 110 as an analog output signal.

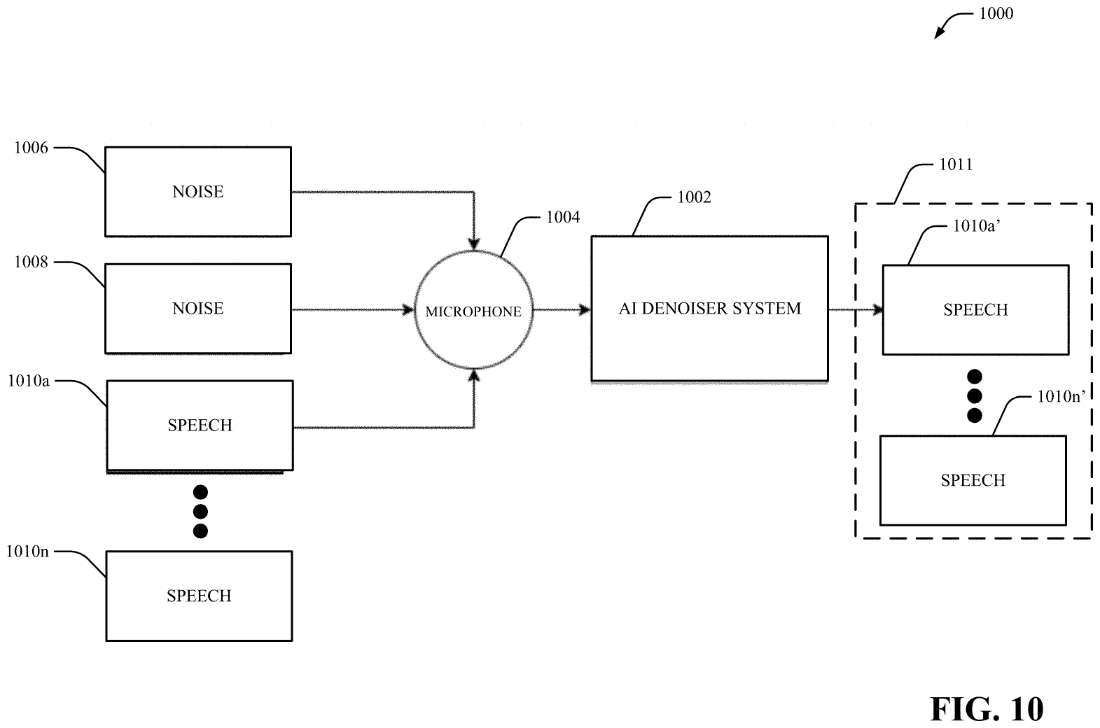

FIG. 10 illustrates a system 1000 that provides an AI denoiser related to audio processing according to one or more embodiments of the present disclosure. The system 1000 is an audio processing system that includes an AI denoiser system 1002. In an embodiment, the AI denoiser system 1002 can correspond to the audio processing system 100, the audio processing system 200, the audio processing system 300, the audio processing system 500, the audio processing system 600, the audio processing system 700, the audio processing system 800 or the audio processing system 900.

Sound provided to a microphone 1004 can include noise 1006, noise 1008 and/or speech 1010a-n. The speech 1010a-n can include one or more speech sources. For example, in an embodiment, the speech 1010a-n can include at least a single speech source 1010a. In another embodiment, the speech 1010a-n can include at least a first speech source 1010a and a second speech source 1010b. As such, an audio signal (e.g., the audio signal sample 106) provided to the AI denoiser system 1002 include the noise 1006, the noise 1008 and/or the speech 1010a-n.

The noise 1006 and/or the noise 1008 can be non-stationary noise. For example, the noise 1006 can be a typing sound, the noise 1008 can be room noise floor, and the speech 1010a-n can be at least one person speaking (e.g., the first speech source 1010a can be a first person speaking, the second speech source 1010b can be a second person speaking, etc.). In another example, the noise 1006 and/or the noise 1008 can be sporting event audio such as voice audio related to an athlete speaking to a coach and/or other non-speech sporting event noises such as a squeak of shoes worn by the athlete, bouncing or kicking of a ball, the “swish” of a basketball passing through a net, etc. In another example, the noise 1006 and/or the noise 1008 can be recreational event audio such as non-speech noises in a gym environment (e.g., the noise of weights while exercising, etc.), non-speech noises in a park (e.g., birds chirping in a park, a lawnmower cutting grass, etc.). However, it is to be appreciated that the noise 1006 and/or the noise 1008 can be different types of noise. According to various embodiments disclosed herein, the AI denoiser system 1002 can employ an AI denoiser related to audio processing (e.g., the DNN processing loop 104, the DNN model 306, etc.) to provide audio output 1011 (e.g., the denoised audio signal sample 110) that includes speech 1010a′-n′ without the noise 1006 and/or the noise 1008. The speech 1010a′-n′ included in the audio output 1011 can be approximations of the speech 1010a-n. For example, the audio output 1011 can contain approximations of the speech 1010a-n (e.g., approximation of the mixture of the speech 1010a-n) that correspond to the speech 1010a′-n′.

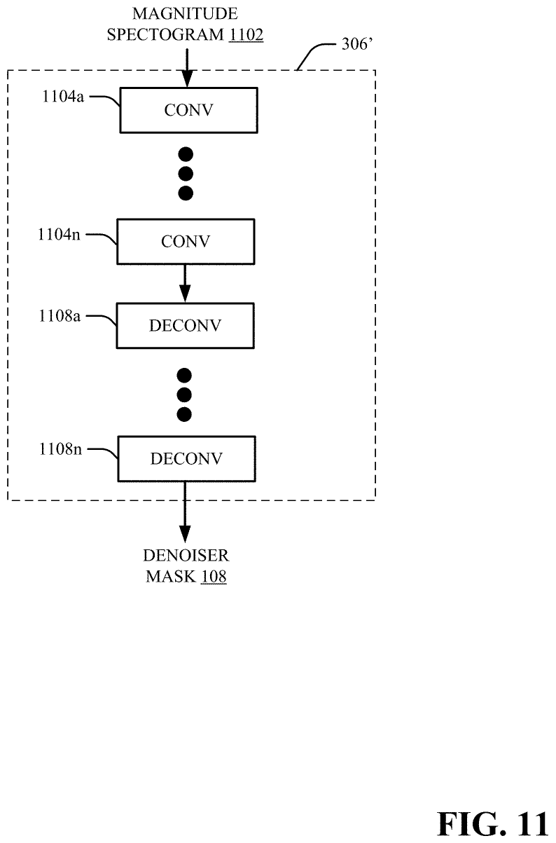

FIG. 11 illustrates a DNN model 306′ according to one or more embodiments of the present disclosure. The DNN model 306′ can illustrate an exemplary embodiment of the DNN model 306. In an embodiment, an input of the DNN model 306′ is a magnitude spectrogram 1102 associated with the set of data samples 310. For instance, the magnitude spectrogram 1102 can be magnitude spectrogram of noisy audio that is provided as a set of input features for the DNN model 306′. In certain embodiments, the magnitude spectrogram 1102 can be associated with multiple component audio signal samples. In certain embodiments, the magnitude spectrogram 1102 can include multiple magnitude spectrograms. The DNN model 306′ can be configured to predict the denoiser mask 108. The denoiser mask 108 can be a ratio mask associated with the noise prediction.

In one or more embodiments, the DNN model 306′ includes a set of downsampling layers 1104a-n associated with convolutional gated linear units and a set of upsampling layers 1108a-n associated with deconvolutional gated linear units. In certain embodiments, the DNN model 306′ can include a set of long short-term memory (LSTM) layers (e.g., one or more LSTM layers) between the set of downsampling layers 1104a-n and the set of upsampling layers 1108a-n. In certain embodiments, each gated linear unit can include two streams of convolutional layers and a sigmoid layer associated with gating. Additionally or alternatively, batch normalization and/or parametric rectified linear unit activation can be performed after the gating. In certain embodiments, dimensionality of an input layer of the DNN model 306′ can be configured to process two or more audio signal samples (e.g., two or more audio signal samples associated with two or more audio sources).

In one or more embodiments, the downsampling layer 1104 includes one or more convolutional layers and/or a sigmoid layer. Additionally, the downsampling layer 1104a-n includes batch normalization and/or a parametric rectified linear unit layer. In one or more embodiments, the upsampling layer 1108a-n includes one or more convolutional transpose layers and/or a sigmoid layer. Additionally, the upsampling layer 1108a-n includes batch normalization and/or a parametric rectified linear unit layer. In one or more embodiments, intermediate output features from the set of downsampling layers 1104a-n can be concatenated with the input features of the set of upsampling layers 1108a-n to form, for example, skip connections. In certain embodiments, a sigmoid layer can be added to the final output of the DNN model 306′ to produce denoiser mask 108 that includes a set of values within the range of (0,1).

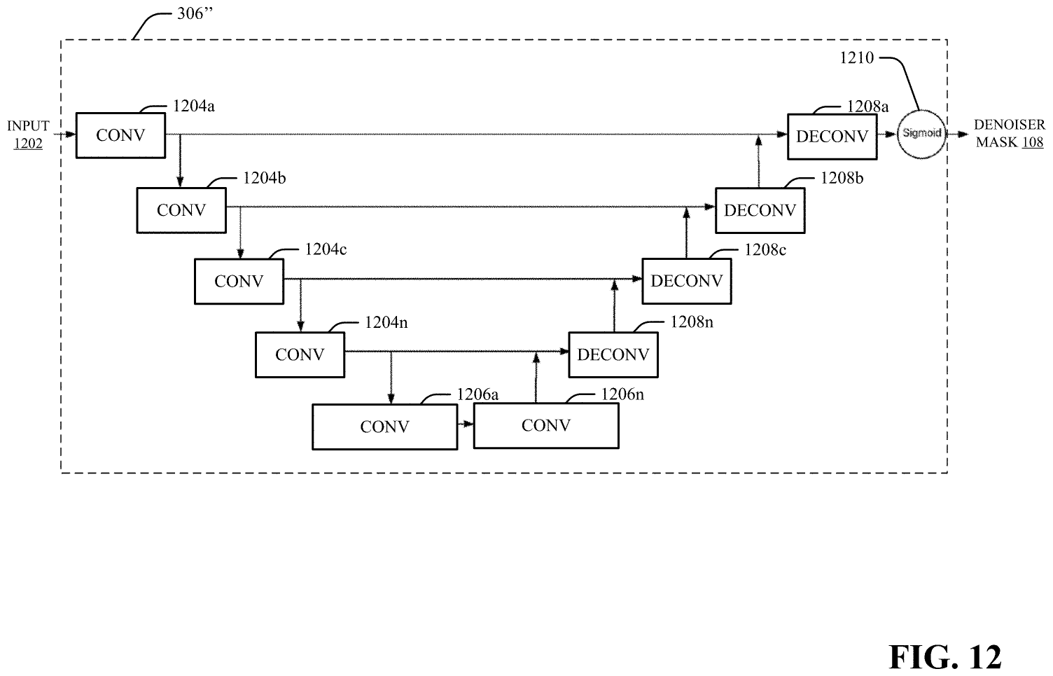

FIG. 12 illustrates a DNN model 306″ according to one or more embodiments of the present disclosure. The DNN model 306″ can illustrate an exemplary embodiment of the DNN model 306. Furthermore, the DNN model 306″ can be a fully convolutional DNN. In an aspect, the DNN model 306″ can include a set of convolutional layers configured in a U-Net architecture. In another aspect, the DNN model 306″ can include an encoder/decoder network structure with skip connections. In an embodiment, input 1202 is provided to the DNN model 306″. The input 1202 can correspond to the set of data samples 310 and/or the magnitude spectrogram 1102, for example. The DNN model 306″ includes a set of downsampling layers 1204a-n associated and a set of upsampling layers 1208a-n associated with deconvolutional gated linear units.

In one embodiment, an encoder branch of the DNN model 306″ is formed by the set of downsampling layers 1204a-n that downsample the input 1202 in a frequency axis by a factor of two while keeping a time axis at a same resolution to reduce latency during real-time implementation of the DNN model 306″. In another embodiment, a decoder branch of the DNN model 306″ is formed by the set of upsampling layers 1208a-n that upsample the input 1202 back an original size of the input 1202. Each gated linear unit can include a convolutional layer gated by another parallel convolutional layer with a sigmoid layer configured as an activation function. Additionally or alternatively, batch normalization and/or parametric rectified linear unit activation can be performed after the gating.

In one or more embodiments, the downsampling layer 1204a-n includes one or more convolutional layers and/or a sigmoid layer. Additionally, the downsampling layer 1204a-n includes batch normalization and/or a parametric rectified linear unit layer. The upsampling layer 1208a-n can include one or more convolutional transpose layers and/or a sigmoid layer. Additionally, the upsampling layer 1208a-n includes batch normalization and/or a parametric rectified linear unit layer. In one or more embodiments, intermediate output features from the set of downsampling layers 1204a-n can be concatenated with the input features of the set of upsampling layers 1208a-n to form, for example, skip connections.

In certain embodiments, a bottleneck portion of the DNN model 306″ between the set of downsampling layers 1204a-n and the set of upsampling layers 1108a-n can include a set of convolutional layers 1206a-n. A first convolutional layer 1206a from the set of convolutional layers 1206a-n can include first downsampling, first batch normalization and/or first parametric rectified linear unit activation. Furthermore, a second convolutional layer 1206n from the set of convolutional layers 1206a-n can include second downsampling, second batch normalization and/or second parametric rectified linear unit activation. In certain embodiments, a sigmoid layer 1210 can be added to the final output of the DNN model 306″ to produce denoiser mask 108 that includes a set of values within the range of (0,1).

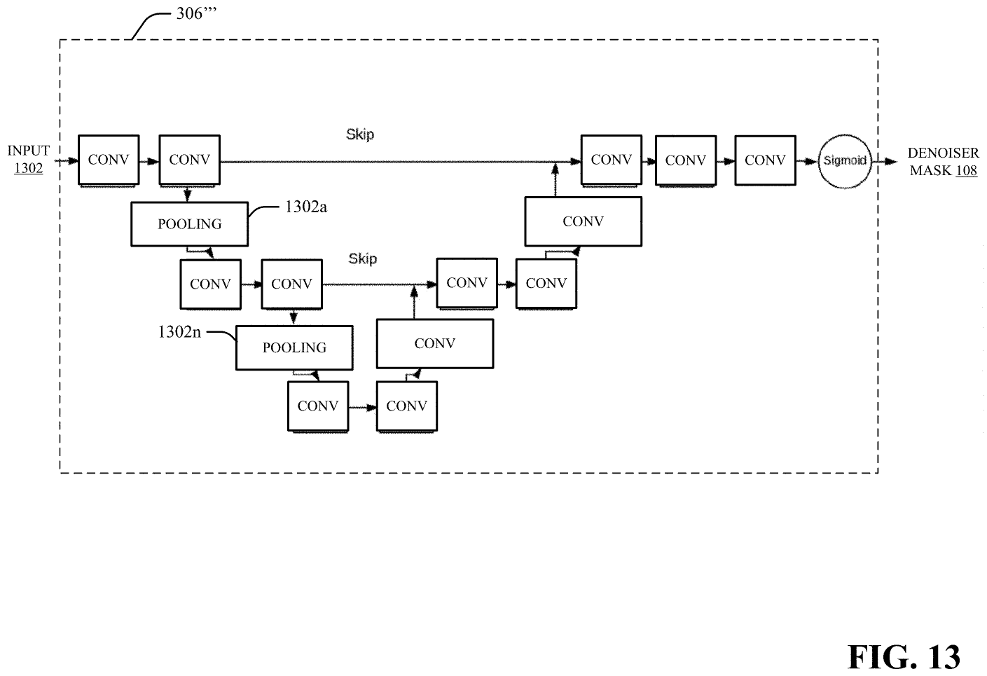

FIG. 13 illustrates a DNN model 306′″ according to one or more embodiments of the present disclosure. The DNN model 306′″ can illustrate an exemplary embodiment of the DNN model 306. Furthermore, the DNN model 306′″ can be a fully convolutional DNN. In an aspect, the DNN model 306′″ can include a set of convolutional layers configured with three levels in a U-Net architecture. In another aspect, the DNN model 306′″ can include an encoder/decoder network structure with skip connections. Input 1302 is provided to the DNN model 306′″. The input 1302 can correspond to the set of data samples 310 and/or the magnitude spectrogram 1102, for example. In one or more embodiments, the DNN model 306′″ includes a set of downsampling layers associated with convolutional gated linear units, a set of upsampling layers associated with deconvolutional gated linear units, and a set of pooling layers associated with the downsampling. For instance, in an embodiment, the DNN model 306′″ includes at least a pooling layer 1302a and/or a pooling layer 1302n associated with downsampling via one or more convolutional layers.

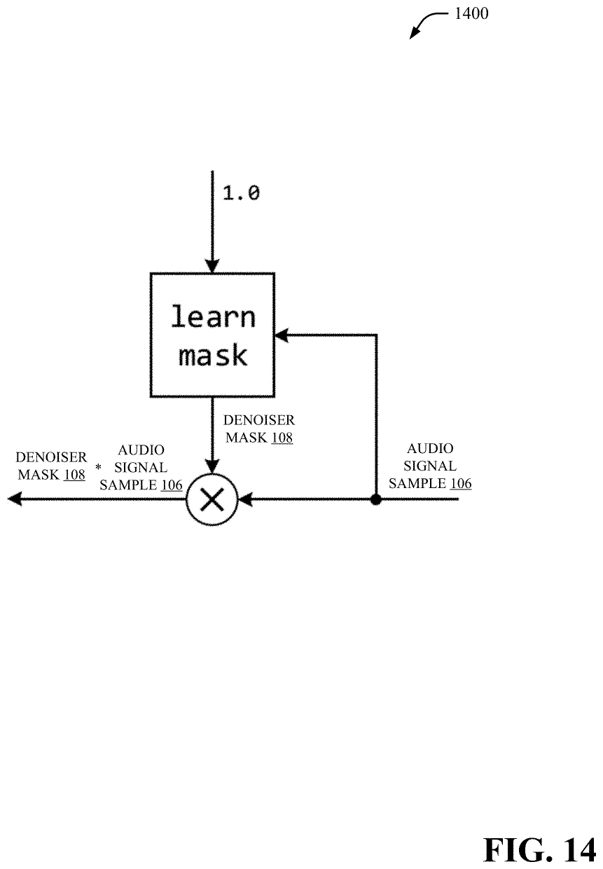

FIG. 14 illustrates noise return loss processing 1400 related to a noise reduction loss meter interface. In an embodiment, the noise return loss processing 1400 determines an average mask value associated with the denoiser mask 108. For example, the noise return loss processing 1400 can determine a ratio of an average of mask values associated with the denoiser mask 108 to an average of a vector of values associated with the audio signal sample 106. The noise return loss processing 1400 can provide a dynamic noise reduction interface object related to the noise reduction loss meter interface. The dynamic noise reduction interface object can correspond to noise return loss associated with the denoiser mask 108. For instance, a value of the dynamic noise reduction interface object can correspond to an average of values of the denoiser mask 108 as compared to an average of values of the audio signal sample 106. In certain embodiments, the noise return loss processing 1400 can provide the dynamic noise reduction interface object as an inverse of noise return loss.

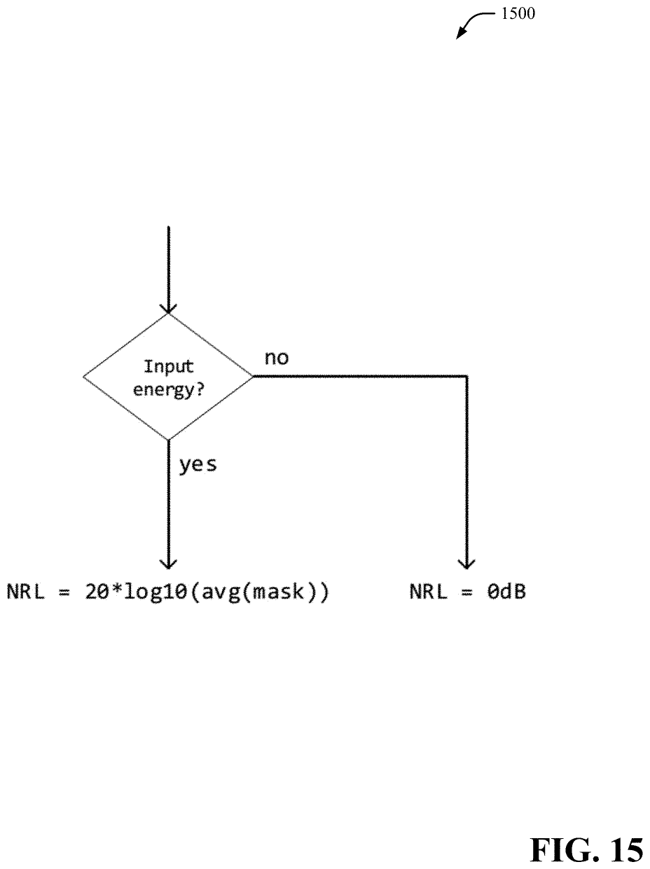

In certain embodiments, the noise return loss processing 1400 can provide the dynamic noise reduction interface object in response to a determination that input energy associated with the denoiser mask 108 satisfies a defined threshold level. FIG. 15 illustrates signal flow processing 1500 related to a noise reduction loss meter interface. For example, the signal flow processing 1500 illustrates a determination as to whether input energy associated with the denoiser mask 108 satisfies a defined threshold level. If yes, the dynamic noise reduction interface object can correspond to a noise return loss value (e.g., 20*log 10(avg(mask))). However, if no, the dynamic noise reduction interface object can correspond to OdB.

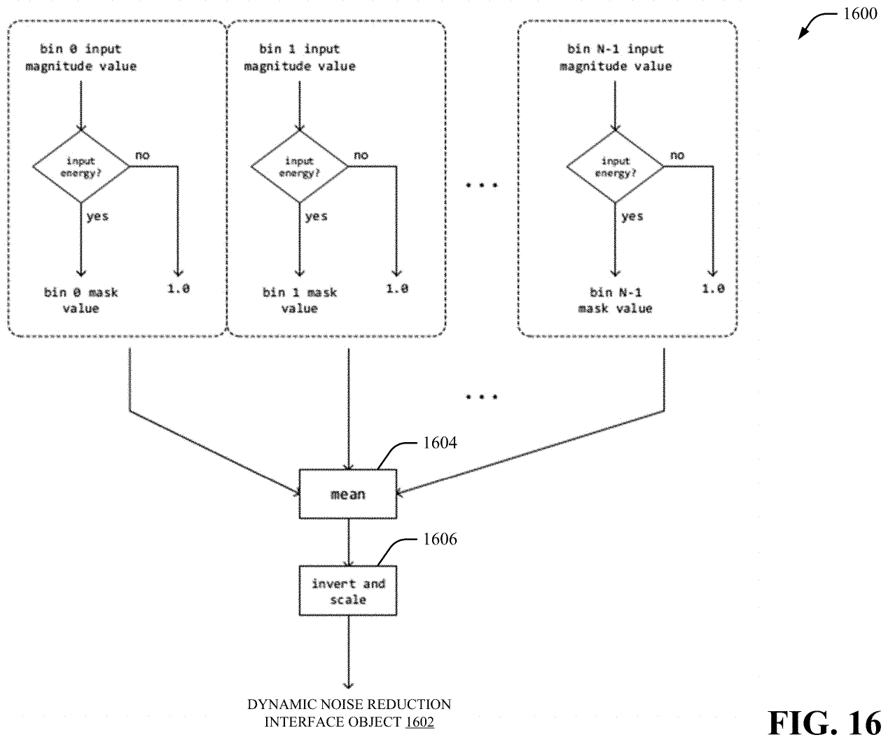

FIG. 16 illustrates noise return loss processing 1600 related to a noise reduction loss meter interface. In an embodiment, the noise return loss processing 1600 determines a dynamic noise reduction interface object 1602 from a data bin value of each data bin according to a set of rules. The dynamic noise reduction interface object 1602 can be a combined noise return loss value associated with the denoiser mask 108. In an embodiment, in response to a determination by the noise return loss processing 1600 that energy is detected in a particular data bin, a corresponding contribution to the dynamic noise reduction interface object 1602 can correspond to a corresponding mask value of the data bin. However, in response to a determination by the noise return loss processing 1600 that energy is not detected in a particular data bin, a corresponding contribution to the dynamic noise reduction interface object 1602 can correspond to a value of “1.0.” Each contribution can be combined via mean 1604 to provide the dynamic noise reduction interface object 1602 for the noise reduction loss meter interface. In certain embodiment, the noise return loss processing 1600 can be configured for invert and scale processing 1606 to facilitate generation of the dynamic noise reduction interface object 1602 for the noise reduction loss meter interface.

### Example System Architecture

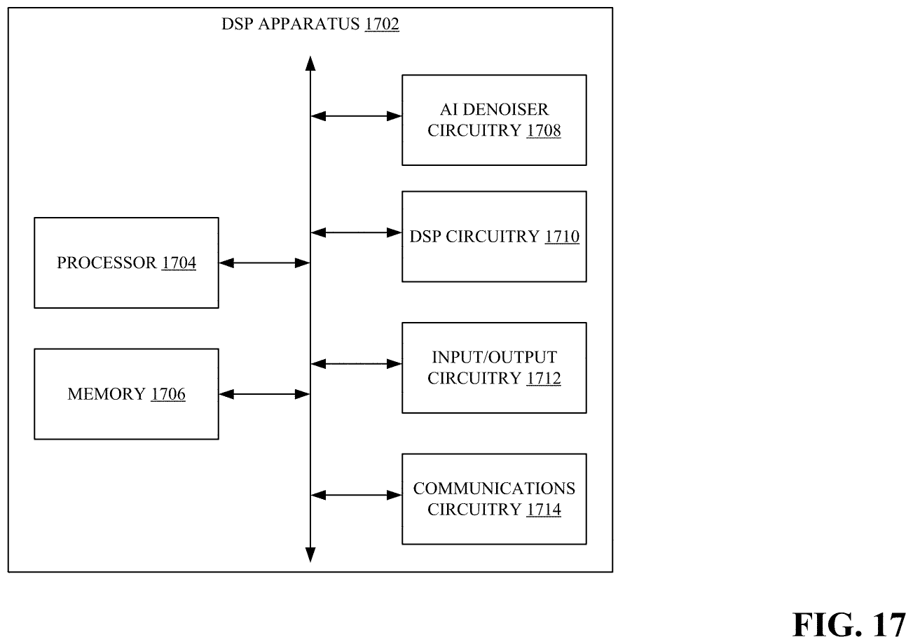

FIG. 17 illustrates an example DSP apparatus 1702 configured in accordance with one or more embodiments of the present disclosure. In one or more embodiments, the DSP apparatus 1702 may be embedded in a DSP audio processing system and/or an AI denoiser system. In certain embodiments, the DSP apparatus 1702 may be embedded in a conferencing system. In certain embodiments, the DSP apparatus 1702 may be embedded in a microphone.

In some cases, the DSP apparatus 1702 may be a firmware computing system communicatively coupled with, and configured to control, one or more circuit modules associated with DSP audio processing and/or an AI denoising. For example, the DSP apparatus 1702 may be a firmware computing system and/or a computing system communicatively coupled with one or more circuit modules related to DSP audio processing and/or AI denoising. In some embodiments, the DSP apparatus 1702 may correspond to and/or be embedded within a virtual audio driver associated with DSP audio processing and/or AI denoising. In some embodiments, the DSP apparatus 1702 may correspond to and/or be embedded within a web assembly system (e.g., a web assembly codec) or a cloud-based system (e.g., a cloud-based codec) associated with DSP audio processing and/or AI denoising. In some embodiments, the DSP apparatus 1702 may correspond to and/or be embedded within an audio plugin associated with DSP audio processing and/or AI denoising. In some embodiments, the DSP apparatus 1702 may correspond to and/or be embedded within a mobile recording application executed via a mobile device (e.g., a smartphone, a tablet computer, a wearable device, a virtual reality device, etc.). The DSP apparatus 1702 may include or otherwise be in communication with a processor 1704, a memory 1706, AI denoiser circuitry 1708, DSP circuitry 1710, input/output circuitry 1712, and/or communications circuitry 1714. In some embodiments, the processor 1704 (which may include multiple or co-processors or any other processing circuitry associated with the processor) may be in communication with the memory 1706.

The memory 1706 may comprise non-transitory memory circuitry and may include one or more volatile and/or non-volatile memories. In some examples, the memory 1706 may be an electronic storage device (e.g., a computer readable storage medium) configured to store data that may be retrievable by the processor 1704. In some examples, the data stored in the memory 1706 may include audio signal sample data, DNN model data, denoiser mask data, or the like, for enabling the apparatus to carry out various functions or methods in accordance with embodiments of the present invention, described herein.

In some examples, the processor 1704 may be embodied in a number of different ways. For example, the processor may be embodied as one or more of various hardware processing means such as a central processing unit (CPU), a microprocessor, a coprocessor, a digital signal processor (DSP), an Advanced RISC Machine (ARM), a field programmable gate array (FPGA), a neural processing unit (NPU), a graphics processing unit (GPU), a system on chip (SoC), a cloud server processing element, a controller, or a processing element with or without an accompanying DSP. The processor 1704 may also be embodied in various other processing circuitry including integrated circuits such as, for example, a microcontroller unit (MCU), an ASIC (application specific integrated circuit), a hardware accelerator, a cloud computing chip, or a special-purpose electronic chip. Furthermore, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining, and/or multithreading.

In an example embodiment, the processor 1704 may be configured to execute instructions, such as computer program code or instructions, stored in the memory 1706 or otherwise accessible to the processor 1704. Alternatively or additionally, the processor 1704 may be configured to execute hard-coded functionality. As such, whether configured by hardware or software instructions, or by a combination thereof, the processor 1704 may represent a computing entity (e.g., physically embodied in circuitry) configured to perform operations according to an embodiment of the present invention described herein. For example, when the processor 1704 is embodied as an CPU, DSP, ARM, FPGA, ASIC, or similar, the processor may be configured as hardware for conducting the operations of an embodiment of the invention. Alternatively, when the processor 1704 is embodied to execute software or computer program instructions, the instructions may specifically configure the processor 1704 to perform the algorithms and/or operations described herein when the instructions are executed. However, in some cases, the processor 1704 may be a processor of a device (e.g., a mobile terminal, a fixed computing device, an edge device, etc.) specifically configured to employ an embodiment of the present invention by further configuration of the processor using instructions for performing the algorithms and/or operations described herein. The processor 1704 may further include a clock, an arithmetic logic unit (ALU) and logic gates configured to support operation of the processor 1704, among other things.

In one or more embodiments, the DSP apparatus 1702 may include the AI denoiser circuitry 1708. The AI denoiser circuitry 1708 may be any means embodied in either hardware or a combination of hardware and software that is configured to perform one or more functions disclosed herein related to the DNN processing loop 104 and/or the post-model processing 602. In one or more embodiments, the DSP apparatus 1702 may include the DSP circuitry 1710. The DSP circuitry 1710 may be any means embodied in either hardware or a combination of hardware and software that is configured to perform one or more functions disclosed herein related to the time-frequency domain transformation pipeline 102 and/or the post-processing pipeline 902.

In certain embodiments, the DSP apparatus 1702 may include the input/output circuitry 1712 that may, in turn, be in communication with processor 1704 to provide output to the user and, in some embodiments, to receive an indication of a user input. The input/output circuitry 1712 may comprise a user interface and may include a display, and may comprise an electronic interface, a web user interface, a mobile application, a query-initiating computing device, a kiosk, or the like. In some embodiments, the input/output circuitry 1712 may also include a keyboard, a mouse, a joystick, a touch screen, touch areas, soft keys, a microphone, a speaker, or other input/output mechanisms. In some embodiments, the processor 1704 may be configured to control one or more functions of one or more user interface elements through computer program instructions (e.g., software and/or firmware) stored on memory (e.g., memory 1706, and/or the like) accessible to the processor 1704.

In certain embodiments, the DSP apparatus 1702 may include the communications circuitry 1714. The communications circuitry 1714 may be any means embodied in either hardware or a combination of hardware and software that is configured to receive and/or transmit data from/to a network and/or any other device or module in communication with the DSP apparatus 1702. In this regard, the communications circuitry 1714 may include, for example, a network interface for enabling communications with a wired or wireless communication network. For example, the communications circuitry 1714 may include one or more network interface cards, antennae, buses, switches, routers, modems, and supporting hardware and/or software, or any other device suitable for enabling communications via a network. Additionally or alternatively, the communications circuitry 1714 may include the circuitry for interacting with the antenna/antennae to cause transmission of signals via the antenna/antennae or to handle receipt of signals received via the antenna/antennae.

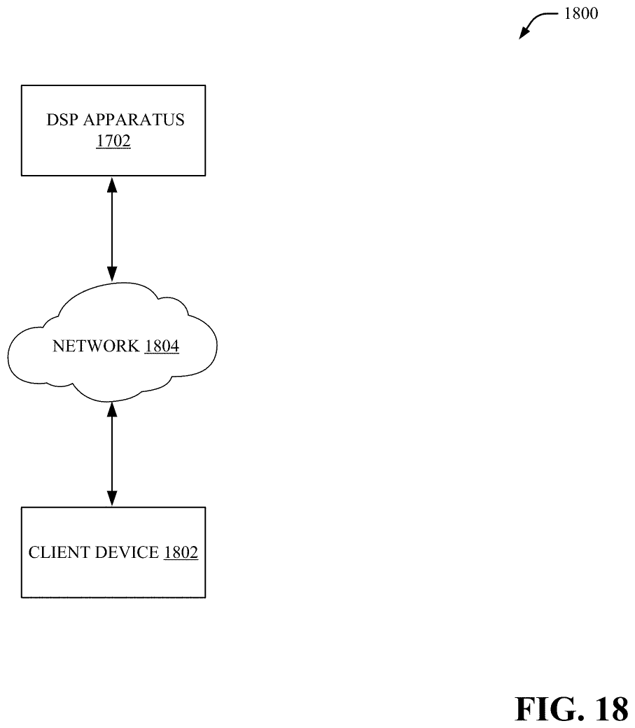

FIG. 18 illustrates an example system 1800 according to one or more embodiments of the present disclosure. The system 1800 includes a client device 1802 configured to interact with the DSP apparatus 1702 via a network 1804. For example, in one or more embodiments, the client device 1802 may be configured to send data to the DSP apparatus 1702 and/or receive data from the DSP apparatus 1702. In certain embodiments, the client device 1802 may be configured to send the one or more user denoiser control parameters 704 to the DSP apparatus 1702. In certain embodiments, the client device 1802 may be configured to receive dynamic noise reduction interface data (e.g., the dynamic noise reduction interface object, data associated with the dynamic noise reduction interface, data associated with the noise reduction loss meter interface) from the DSP apparatus 1702.

In certain embodiments, the client device 1802 can be configured to render a dynamic noise reduction interface to visually indicate a degree of noise reduction provided by the denoiser mask 108. For example, in certain embodiments, the client device 1802 can be configured to render a noise reduction loss meter interface to visually indicate a degree of noise reduction provided by the denoiser mask 108. The client device 1802 can be a user device such as a computing device, a desktop computer, a laptop computer, a mobile device, a smartphone, a tablet computer, a netbook, a wearable device, a virtual reality device, or the like.

The network 1804 may include any wired or wireless communication network including, for example, a wired or wireless local area network (LAN), personal area network (PAN), metropolitan area network (MAN), wide area network (WAN), the like, or combinations thereof, as well as any hardware, software and/or firmware required to implement the network 1804 (e.g., network routers, etc.). For example, the network 1804 may include a cellular telephone, an 802.11, 802.16, 802.18, and/or WiMAX network. Further, the network 1804 may include a public network, such as the Internet, a private network, such as an intranet, or combinations thereof, and may utilize a variety of networking protocols now available or later developed including, but not limited to Transmission Control Protocol/Internet Protocol (TCP/IP) based networking protocols. In some embodiments, the protocol is a custom protocol of JSON objects sent via a Web Socket channel. In some embodiments, the protocol is JSON over RPC, JSON over REST/HTTP, the like, or combinations thereof. In some embodiments, the network 1804 is configured for exchanging data over short distances (e.g., less than 33 feet) using ultra high frequency (UHF) radio waves.

Embodiments of the present disclosure are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices/entities, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time.

In some example embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

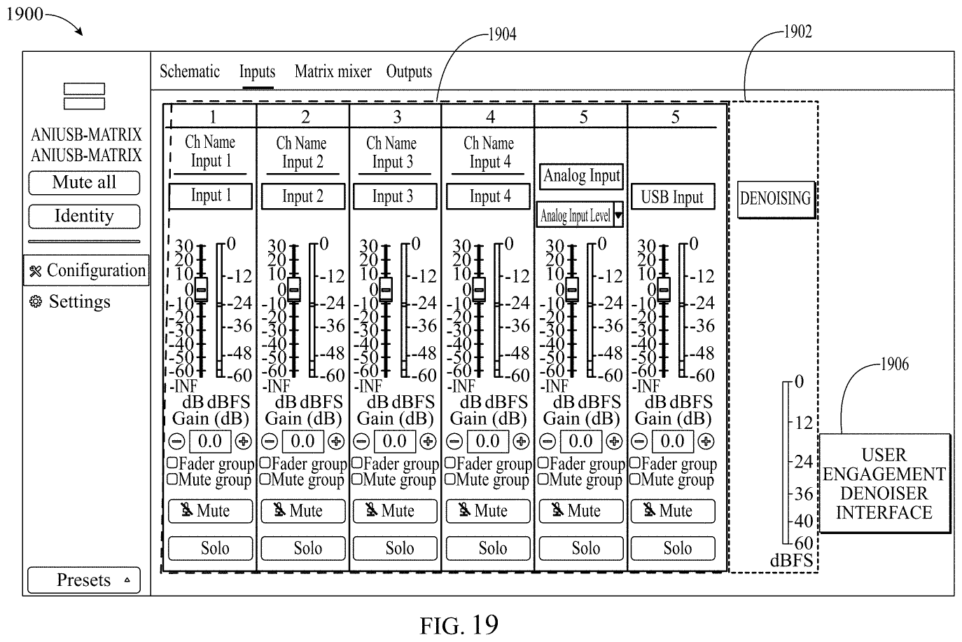

FIG. 19 illustrates an audio processing control user interface 1900 according to one or more embodiments of the present disclosure. The audio processing control user interface 1900 can be, for example, an electronic interface (e.g., a graphical user interface) of a client device (e.g., the client device 1802). For example, the audio processing control user interface 1900 can be a client device interface, a web user interface, a mobile application interface, or the like.

In one or more embodiments, the audio processing control user interface 1900 includes a dynamic noise reduction interface 1902. The dynamic noise reduction interface 1902 can visually indicate a degree of noise reduction provided by the denoiser mask 108. In one or more embodiments, the dynamic noise reduction interface 1902 can provide a visualization (e.g., a visual representation) of a dynamic noise reduction interface object associated with the denoiser mask 108 to facilitate human interpretation of the degree of noise reduction provided by the denoiser mask 108. In certain embodiments, the dynamic noise reduction interface 1902 includes graphic representation and/or textual representation of the degree of noise reduction provided by the denoiser mask. In certain embodiments, the dynamic noise reduction interface 1902 can be a noise reduction loss meter interface to visually indicate a degree of noise reduction provided by the denoiser mask 108. In certain embodiments, the audio processing control user interface 1900 additionally includes other visualizations such as audio processing controls 1904 to facilitate modifying audio processing and/or DSP processing related to an audio signal (e.g., the audio signal sample 106).

In certain embodiments, the audio processing control user interface 1900 additionally or alternatively includes a user engagement denoiser interface 1906. The user engagement denoiser interface 1906 can facilitate determination of the one or more user denoiser control parameters 704. For example, the user engagement denoiser interface 1906 can be a dynamic object that can be modified based on feedback provided by a user via the audio processing control user interface 1900. The user engagement denoiser interface 1906 can be one or more interface knobs configured to control and/or modify a value of the one or more user denoiser control parameters 704. Alternatively, the user engagement denoiser interface 1906 can be a slide control interface configured to control and/or modify a value of the one or more user denoiser control parameters 704. However, it is to be appreciated that, in certain embodiments, the user engagement denoiser interface 1906 can be configured as a different user engagement denoiser interface to control and/or modify a value of the one or more user denoiser control parameters 704. In an embodiment, the user denoiser control 702 can apply the one or more user denoiser control parameters 704 generated via the user engagement denoiser interface 1906 to the denoiser mask 108 to generate the modified denoiser mask 604.

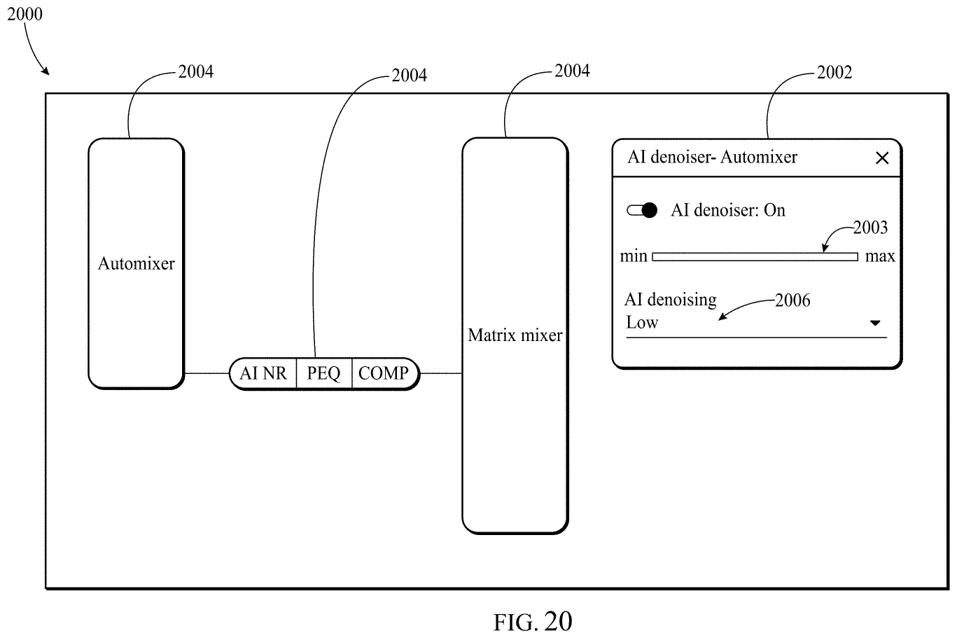

FIG. 20 illustrates an audio processing control user interface 2000 according to one or more embodiments of the present disclosure. The audio processing control user interface 2000 can be, for example, an electronic interface (e.g., a graphical user interface) of a client device (e.g., the client device 1802). For example, the audio processing control user interface 2000 can be a client device interface, a web user interface, a mobile application interface, or the like.

In one or more embodiments, the audio processing control user interface 2000 includes a dynamic noise reduction interface 2002. The dynamic noise reduction interface 2002 can visually indicate a degree of noise reduction provided by the denoiser mask 108. In one or more embodiments, the dynamic noise reduction interface 2002 can provide a visualization (e.g., a visual representation) of a dynamic noise reduction interface object associated with the denoiser mask 108 to facilitate human interpretation of the degree of noise reduction provided by the denoiser mask 108. In certain embodiments, the dynamic noise reduction interface 2002 includes graphic representation and/or textual representation of the degree of noise reduction provided by the denoiser mask. In certain embodiments, the dynamic noise reduction interface 2002 can be a noise reduction loss meter interface 2003 to visually indicate a degree of noise reduction provided by the denoiser mask 108. In certain embodiments, the audio processing control user interface 2000 additionally includes other visualizations such as audio processing controls 2004 to facilitate modifying audio processing and/or DSP processing related to an audio signal (e.g., the audio signal sample 106).

In certain embodiments, the audio processing control user interface 2000 additionally or alternatively includes a user engagement denoiser interface 2006. The user engagement denoiser interface 2006 can facilitate determination of the one or more user denoiser control parameters 704. For example, the user engagement denoiser interface 2006 can be a dynamic object that can be modified based on feedback provided by a user via the audio processing control user interface 2000. The user engagement denoiser interface 2006 can be a drop-down menu configured to control and/or modify a value of the one or more user denoiser control parameters 704. Alternatively, the user engagement denoiser interface 2006 can be one or more interface knobs configured to control and/or modify a value of the one or more user denoiser control parameters 704. Alternatively, the user engagement denoiser interface 2006 can be a slide control interface configured to control and/or modify a value of the one or more user denoiser control parameters 704. However, it is to be appreciated that, in certain embodiments, the user engagement denoiser interface 2006 can be configured as a different user engagement denoiser interface to control and/or modify a value of the one or more user denoiser control parameters 704. In an embodiment, the user denoiser control 702 can apply the one or more user denoiser control parameters 704 generated via the user engagement denoiser interface 2006 to the denoiser mask 108 to generate the modified denoiser mask 604.

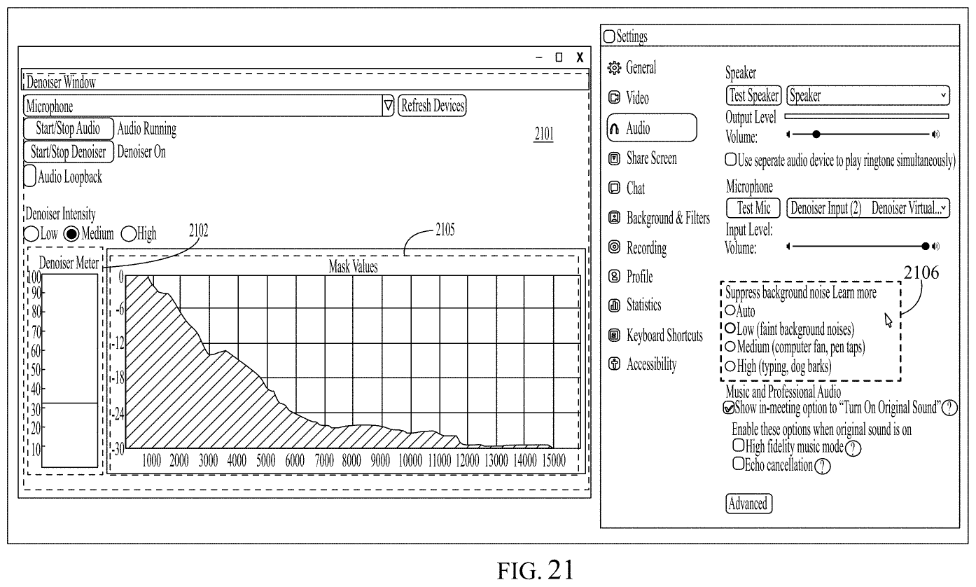

FIG. 21 illustrates an audio processing control user interface 2100 according to one or more embodiments of the present disclosure. The audio processing control user interface 2100 can be, for example, an electronic interface (e.g., a graphical user interface) of a client device (e.g., the client device 1802). For example, the audio processing control user interface 2100 can be a client device interface, a web user interface, a mobile application interface, or the like.

The audio processing control user interface 2100 can include a denoiser dashboard interface 2101. The denoiser dashboard interface 2101 can provide one or more visualizations related to real-time denoising of an audio signal sample such as, for example, the audio signal sample 106 via the time-frequency domain transformation pipeline 102 and/or the DNN processing loop 104. In one or more embodiments, the denoiser dashboard interface 2101 includes a dynamic noise reduction interface 2102. The dynamic noise reduction interface 2102 can visually indicate a degree of noise reduction provided by the denoiser mask 108.

In one or more embodiments, the dynamic noise reduction interface 2102 can provide a visualization (e.g., a visual representation) of a dynamic noise reduction interface object associated with the denoiser mask 108 to facilitate human interpretation of the degree of noise reduction provided by the denoiser mask 108. In certain embodiments, the dynamic noise reduction interface 2102 includes graphic representation and/or textual representation of the degree of noise reduction provided by the denoiser mask. In certain embodiments, the dynamic noise reduction interface 2102 can be a noise reduction loss meter interface. Additionally or alternatively, the denoiser dashboard interface 2101 includes a real-time mask viewer 2105. The real-time mask viewer 2105 can provide a visualization (e.g., a visual representation) of real-time mask values associated with the denoiser mask 108.

In certain embodiments, the audio processing control user interface 2100 additionally or alternatively includes a user engagement denoiser interface 2106. The user engagement denoiser interface 2106 can facilitate determination of the one or more user denoiser control parameters 704. For example, the user engagement denoiser interface 2106 can be a dynamic object that can be modified based on feedback provided by a user via the user engagement denoiser interface 2106. In an embodiment, the user engagement denoiser interface 2106 can include a set of predetermined denoising levels (e.g., high, medium, or low) that can be selected to control and/or modify a value of the one or more user denoiser control parameters 704. However, it is to be appreciated that, in certain embodiments, the user engagement denoiser interface 2106 can be configured as a different user engagement denoiser interface to control and/or modify a value of the one or more user denoiser control parameters 704. In an embodiment, the user denoiser control 702 can apply the one or more user denoiser control parameters 704 generated via the user engagement denoiser interface 2106 to the denoiser mask 108 to generate the modified denoiser mask 604.

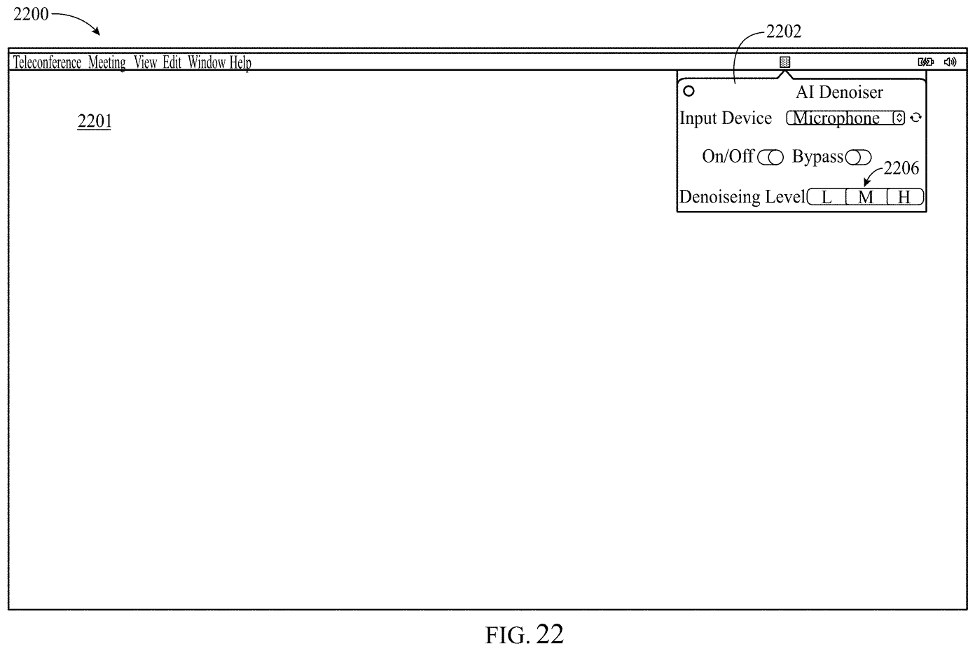

FIG. 22 illustrates an audio processing control user interface 2200 according to one or more embodiments of the present disclosure. The audio processing control user interface 2200 can be, for example, an electronic interface (e.g., a graphical user interface) of a client device (e.g., the client device 1802). For example, the audio processing control user interface 2200 can be a client device interface, an operating system interface, a mobile application interface, or the like.

The audio processing control user interface 2200 can include an operating system interface 2201. The operating system interface 2201 can be, for example, a screen for macOS®, Windows®, or another operating system. The operating system interface 2201 can provide one or more visualizations related to real-time denoising of an audio signal sample such as, for example, the audio signal sample 106 via the time-frequency domain transformation pipeline 102 and/or the DNN processing loop 104.

In one or more embodiments, the operating system interface 2101 includes a dynamic noise reduction interface 2202. In certain embodiments, the dynamic noise reduction interface 2202 can be integrated within a virtual audio driver associated with the operating system. For example, in certain embodiments, the dynamic noise reduction interface 2202 can be integrated within a virtual audio driver of a teleconference application (e.g., a video teleconference application, etc.) executed via the operating system. In certain embodiments, the dynamic noise reduction interface 2202 can be accessed via a menu bar for the operating system and/or the teleconference application. The dynamic noise reduction interface 2202 can visually indicate a degree of noise reduction provided by the denoiser mask 108. In one or more embodiments, the dynamic noise reduction interface 2202 can provide a visualization (e.g., a visual representation) of a dynamic noise reduction interface object associated with the denoiser mask 108 to facilitate human interpretation of the degree of noise reduction provided by the denoiser mask 108. In certain embodiments, the dynamic noise reduction interface 2202 includes graphic representation and/or textual representation of the degree of noise reduction provided by the denoiser mask.

In certain embodiments, the dynamic noise reduction interface 2202 includes a user engagement denoiser interface 2206. The user engagement denoiser interface 2206 can facilitate determination of the one or more user denoiser control parameters 704. For example, the user engagement denoiser interface 2206 can be a dynamic object that can be modified based on feedback provided by a user via the user engagement denoiser interface 2206. In an embodiment, the user engagement denoiser interface 2206 can include a set of predetermined denoising levels (e.g., high, medium, or low) that can be selected to control and/or modify a value of the one or more user denoiser control parameters 704. However, it is to be appreciated that, in certain embodiments, the user engagement denoiser interface 2206 can be configured as a different user engagement denoiser interface to control and/or modify a value of the one or more user denoiser control parameters 704. In an embodiment, the user denoiser control 702 can apply the one or more user denoiser control parameters 704 generated via the user engagement denoiser interface 2206 to the denoiser mask 108 to generate the modified denoiser mask 604.

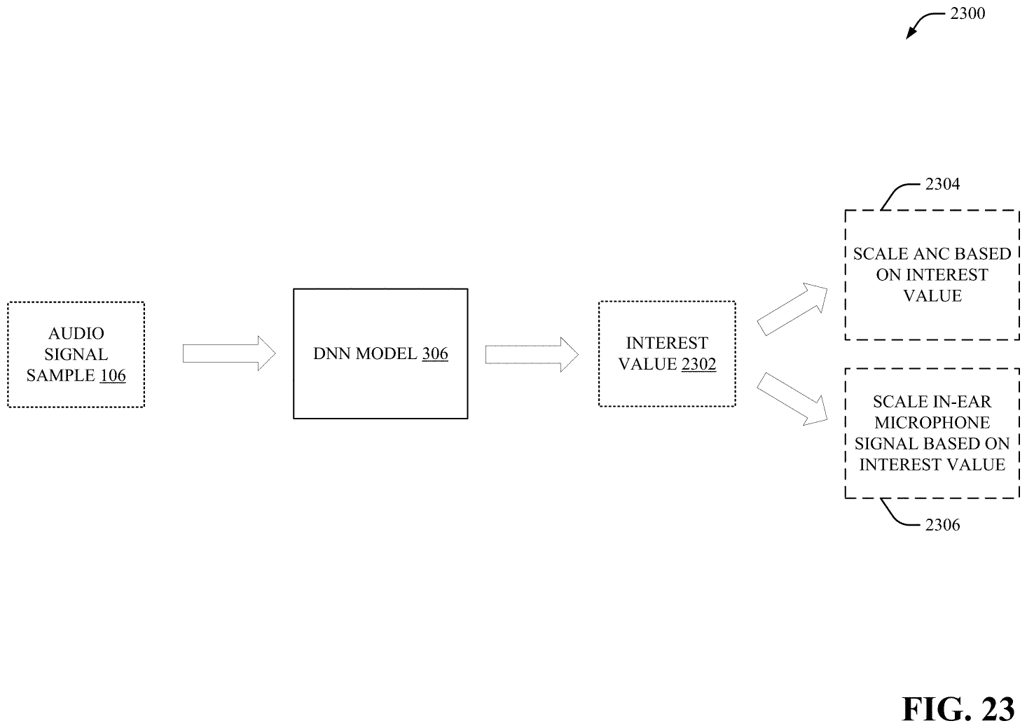

FIG. 23 illustrates a system 2300 that provides an AI denoiser related to active noise cancellation (ANC) according to one or more embodiments of the present disclosure. The system 2300 includes the DNN model 306 that can be employed to modulate ANC for audio output associated with a listening device such as, for example, headphones, earphones, or speakers. For example, in an AI-modulated ANC mode, the DNN model 306 can predict whether the audio signal sample 106 includes one or more signals of interest. A signal of interest can include speech or non-speech audio such as, for example, music. In another example, a signal of interest can include sporting event audio such as voice audio related to an athlete speaking to a coach and/or other non-speech sporting event noises such as a squeak of shoes worn by the athlete, bouncing of a basketball on a basketball court, the “swish” of a basketball passing through a net, etc. In various embodiments, the DNN model 306 can determine an interest value 2302 associated with a signal of interest. A first value (e.g., a “0” value) for the interest value 2302 can correspond to an instance in which the DNN model 306 identifies all noise in the audio signal sample 106. Furthermore, a second value (e.g., a “1” value) for the interest value 2302 can correspond to an instance in which the DNN model 306 identifies all speech or another signal of interest in the audio signal sample 106. Based on the interest value 2302 determined by the DNN model 306, one or more ANC processes can be performed.

In one embodiment, an ANC process 2304 can be performed to scale an ANC signal based on the interest value 2302. The ANC signal can be an ambient reference signal, an anti-noise signal, or another type of ANC signal. Additionally or alternatively, an ANC process 2306 can be performed to scale an in-ear microphone signal based on the interest value 2302 such as, for example, to maintain ANC adaptive filtering stability. However, it is to be appreciated that the interest value 2302 can additionally or alternatively be employed for one or more other types of ANC processes.

In certain embodiments, the interest value 2302 can be employed for class-specific ANC modulation. A sound class can be, for example, a speech classification or a noise classification. Additionally or alternatively, the DNN model 306 can be configured to determine one or more other sound classes other than speech and noise. For example, the DNN model 306 can be trained to detect modulate one or more ANC processes to remove a first sound class (e.g., pet noises) and not remove a second sound class (e.g. a baby crying) from the audio signal sample 106. In certain embodiments, a sound class for removed noise can be related to noise associated with a sporting event such as, for example, crowd noise, speech from a sporting event announcer, whistles during the sporting event, a particular word from a set of blacklist words uttered by fans or participants at a sporting event, and/or another noise classifications associated with a sporting event.

In certain embodiments, the interest value 2302 can be employed for ANC mode optimization. For example, a sound class detected by the DNN model 306 can be employed to tune one or more ANC processes by selecting an optimized mode of ANC for specific sound classifications (e.g., a concert audio environment vs. a subway audio environment vs. an office audio environment).

In still other embodiments, the interest value 2302 can be employed for ambient event detection. For example, the DNN model 306 can be trained to recognize certain sound classes that represent a predetermined event (e.g., a threat event). Furthermore, in response to a sound class that represents a predetermined event trigger, one or more alerts or other actions for a client device (e.g., the client device 1802) and/or a listening device (e.g., headphones, earphones, or speakers) can be generated based on the sound class that represents the predetermined event trigger. In one example, alert audio (e.g., alert speech) can be inserted into audio output for a listening device (e.g., “a threat event has been detected nearby,” “beware of broken glass,” etc.).

In certain embodiments, the interest value 2302 can be employed for subliminal signal classification. For example, the DNN model 306 can receive (e.g., in addition to or instead of external speech or speech of a user associated with a listening device) otoacoustic emissions (OAE) from an ambient microphone and/or an in-ear microphone of the listening device. OAE are signals emitted by an inner ear of a user associated with a listening device and can include one or more attributes that reflect biometric information, mental state information, and physical state information related to the user. The OAE can be classified into signals of interest and one or more actions associated with the listening device and/or a client device (e.g., the client device 1802) can be performed accordingly.

In one example, the DNN model 306 can detect one or more signals of interest for OAE related the user and equalization for the listening device can be applied accordingly. In another example, the DNN model 306 can detect a signal of interest that indicates that the user is in a stressed state and one or more actions associated with the listening device and/or a client device (e.g., the client device 1802) can be performed or enhanced accordingly.

In certain embodiments, the audio signal sample 106 can correspond to an OAE signal sample provided by an in-ear microphone of the listening device. Additionally, the OAE signal sample can be provided to the DNN model 306 such that the DNN model 306 is configured to predict whether the OAE signal sample includes one or more signals of interest. A denoiser mask can also be configured, in certain embodiments, based on the one or more signals of interest associated with the OAE signal sample.

In an alternate embodiment, an OAE signal sample can be provided in addition to the audio signal sample 106. For example, the OAE signal sample can be provided by an in-ear microphone of the listening device. Additionally, the audio signal sample 106 can be provided by one or more microphones external to the listening device. Accordingly, the OAE signal sample and the audio signal sample 106 can be provided to the DNN model 306. The DNN model 306 can then predict whether the OAE signal sample and the audio signal sample 106 includes one or more signals of interest. For example, the DNN model 306 can predict whether the OAE signal sample includes one or more signals of interest associated with particular biometric information, mental state information, and/or physical state information related to the user. Additionally, the DNN model 306 can predict whether the audio signal sample 106 includes one or more signals of interest associated with speech or non-speech audio. A denoiser mask can also be configured, in certain embodiments, based on the signals of interest associated with the OAE signal sample and the audio signal sample 106.

In certain embodiments, the DNN model 306 can configure a denoiser mask provided by the DNN model 306 based on the one or more signals of interest. For example, the DNN model 306 can configure a denoiser mask provided by the DNN model 306 based on the interest value 2302. Additionally, in a circumstance where the denoiser mask is determined prior to expiration of a transformation period associated with the time-frequency domain transformation pipeline 102, active noise cancellation associated with the audio signal sample 106 can be scaled based on the denoiser mask.

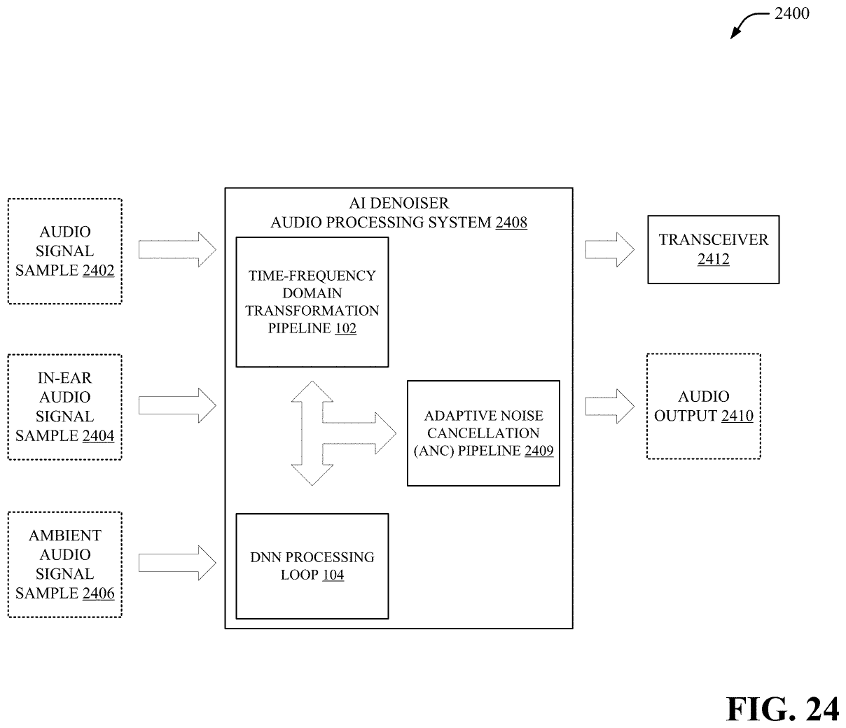

FIG. 24 illustrates a system 2400 that provides an audio processing system related to active noise cancellation (ANC) according to one or more embodiments of the present disclosure. The system 2400 includes an AI denoiser audio processing system 2408 that includes the time-frequency domain transformation pipeline 102 and the DNN processing loop 104. The AI denoiser audio processing system 2408 can be employed to modulate ANC for audio output 2410. The audio output 2410 can be audio output for a wearable listening device such as, for example, earphones, headphones, or another type of wearable listening device. In various embodiments, the DNN processing loop can include a DNN model (e.g., the DNN model 306) to predict whether an audio signal sample 2402 includes one or more signals of interest. In a non-limiting example, the audio signal sample 2402 can be a voice audio signal sample. However, it is to be appreciated that the audio signal sample 2402 can include another type of signal of interest. The audio signal sample 2402, the in-ear audio signal sample 2404, and/or the ambient audio signal sample 2406 can also be employed for one or more ANC processes associated with the wearable listening device. In certain embodiments, the AI denoiser audio processing system 2408 can be communicatively coupled (e.g., wired or wirelessly) to a transceiver 2412 to facilitate providing the audio output 2410 to one or more audio output devices such as, for example, one or more output speakers. The AI denoiser audio processing system 2408 can be communicatively coupled (e.g., wired or wirelessly) to the transceiver 2412 to additionally or alternatively facilitate receiving the audio signal sample 2402, the in-ear audio signal sample 2404, and/or the ambient audio signal sample 2406.

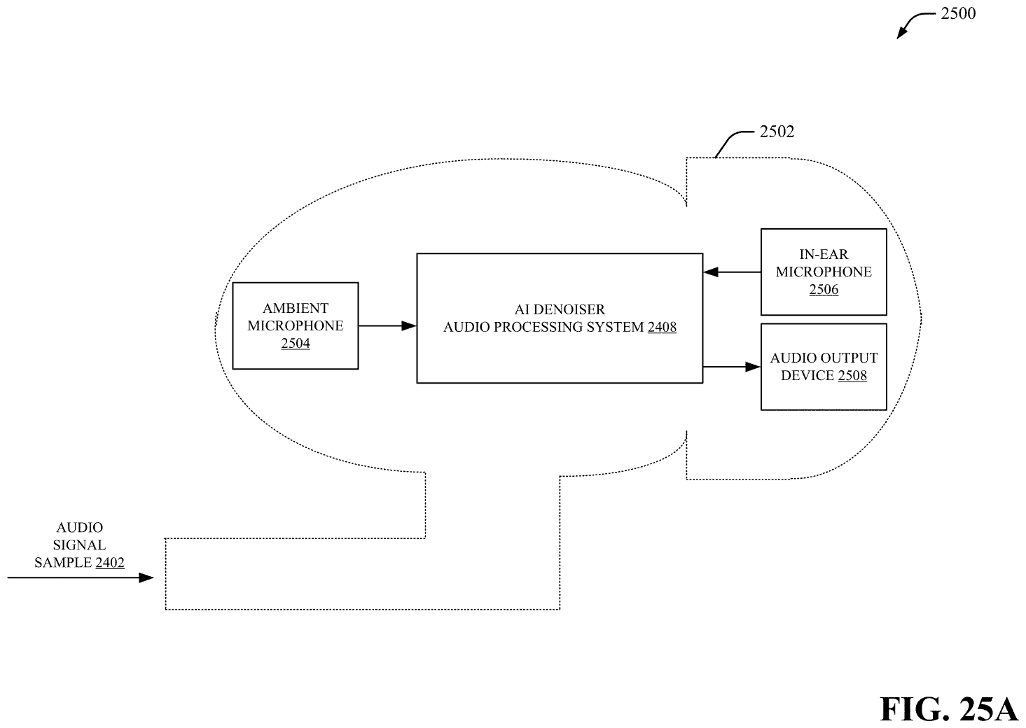

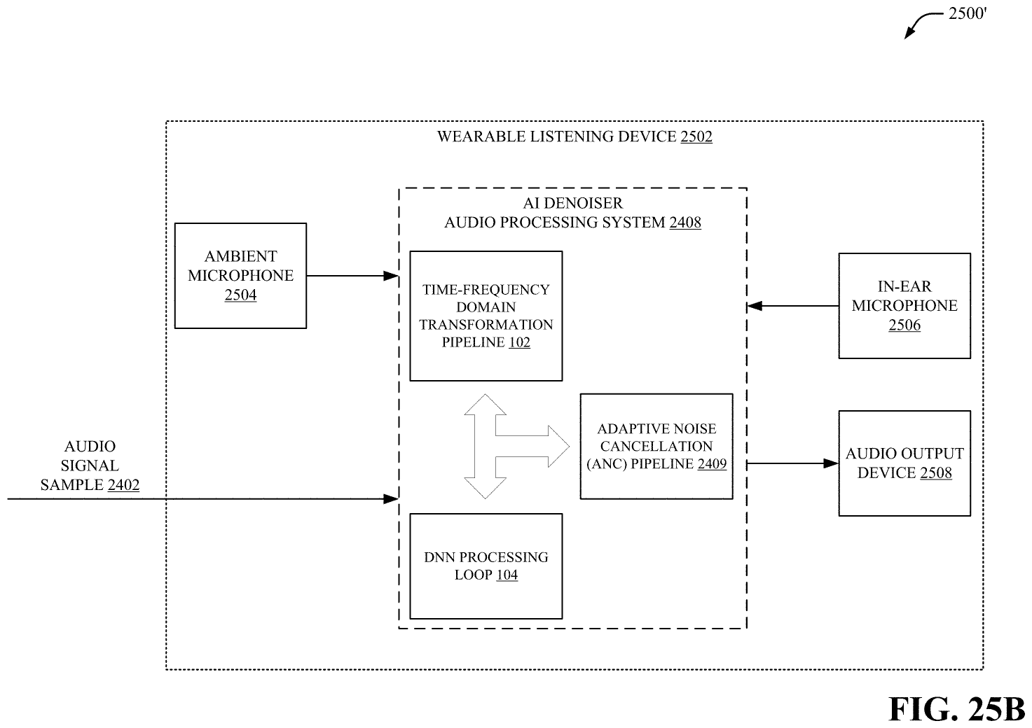

In certain embodiments, an ANC pipeline 2409 can be integrated in the time-frequency domain transformation pipeline 102 to facilitate the one or more ANC processes associated with the wearable listening device. Alternatively, in certain embodiments, the AI denoiser audio processing system 2408 can include the ANC pipeline 2409 as an audio processing pipeline distinct from the time-frequency domain transformation pipeline 102. The ANC pipeline 2409 can be configured to perform ANC processing with respect to the audio signal sample 106 using one or more ANC processing techniques. For example, the ANC pipeline 2409 can be configured to measure external sound (e.g., noise, speech, etc.) based on an ambient microphone (e.g., ambient microphone 2504 shown in FIG. 25) implemented on an outside of a wearable listening device such as, for example, an earphone or a headphone. The ambient audio signal sample 2406 can include the external sound associated with the ambient microphone. Furthermore, the ANC pipeline 2409 can be configured to generate an anti-noise signal (e.g., an anti-noise ANC signal) that is provided to a transceiver 2412 to cancel the external sound.

In one or more embodiments, the ANC pipeline 2409 can employ the in-ear audio signal sample 2406 to measure how much reference noise is passed through the wearable listening device. The in-ear audio signal sample 2406 can be provided by an in-ear microphone (e.g., in-ear microphone 2506 shown in FIG. 25) implemented on an inside of the listening device. The ANC pipeline 2409 can employ the reference noise associated with the in-ear audio signal sample 2406 for one or more ANC adaptive filtering processes performed by the ANC pipeline 2409 to reduce external noise in the audio output 2410. Based on data (e.g., the interest value 2302) provided by the DNN processing loop 104, the ANC pipeline 2409 can be configured to modulate the in-ear audio signal sample 2404 to adjust error signal data provided for the one or more ANC adaptive filtering processes. Additionally or alternatively, based on data (e.g., the interest value 2302) provided by the DNN processing loop 104, the ANC pipeline 2409 can scale one or more other portions of an ANC process such as, for example, the ambient audio signal sample 2406 to improve the one or more ANC adaptive filtering processes.

FIG. 25A illustrates a system 2500 that provides a wearable listening device associated with an audio processing system related to ANC according to one or more embodiments of the present disclosure. In this regard, the system 2500 includes a wearable listening device 2502 that comprises the AI denoiser audio processing system 2408. The wearable listening device 2502 can be an earphone, a headphone, or another type of wearable listening device capable of providing ANC for a listener (e.g., a human ear). The wearable listening device 2502 also includes an ambient microphone 2504, an in-ear microphone 2506, and/or an audio output device 2508. In one or more embodiments, the ambient microphone 2504 can provide the ambient audio signal sample 2406 and the in-ear microphone 2506 can provide the in-ear audio signal sample 2404. Furthermore, the audio output device 2508 can output the audio output 2410. In certain embodiments, the in-ear microphone 2506 can be configured as an error microphone and/or the ambient microphone 2504 can be configured as a reference microphone (e.g., an external reference microphone).

In various embodiments, the DNN model 306 of the DNN processing loop 104 can be trained for ANC and can be stored in a memory of the wearable listening device 2502. Furthermore, as compared to traditional audio processing systems that are used for digital signal processing and denoising, the DNN model 306 may employ a fewer number of computing resources to provide ANC associated with the audio signal sample 2402. Accordingly, high-fidelity and/or low latency ANC audio processing associated with an AI denoiser can be integrated into the wearable listening device 2502.

To provide an anti-noise ANC signal for performing ANC associated with the audio signal sample 2402, the AI denoiser audio processing system 2408 of the wearable listening device 2502 can combine the ambient audio signal sample 2406 provided by the ambient microphone 2504 with the in-ear audio signal sample 2404 provided by the in-ear microphone 2506. The anti-noise ANC signal can then be employed by the wearable listening device 2502 to cancel ambient noise associated with the audio signal sample 2402 to provide the audio output 2410. As such, the audio output 2410 provided by the wearable listening device 2502 can correspond to an ANC version of the audio signal sample 2402 with no noise or minimal noise.

FIG. 25B illustrates a system 2500′ that further illustrates one or more embodiments related to the wearable listening device 2502 shown in the system 2500. The AI denoiser audio processing system 2408 of the wearable listening device 2502 includes the time-frequency domain transformation pipeline 102, the DNN processing loop 104, and/or the ANC pipeline 2409. In various embodiments, the DNN processing loop 104 can be configured to modulate one or more processes of the ANC pipeline 2409 based on the interest value 2302 provided by the DNN model 306. For instance, the denoiser mask 108 can be configured as the interest value 2302 to modulate the audio signal sample 2402, the ambient audio signal sample 2406 provided by the ambient microphone 2504, and/or the in-ear audio signal sample 2404 provided by the in-ear microphone 2506.

In certain embodiments, the ANC pipeline 2409 can be implemented as a standalone ANC pipeline (e.g., without the time-frequency domain transformation pipeline 102) that is modulated based on the interest value 2302 provided by the DNN model 306 of the DNN processing loop 104. For example, the AI denoiser audio processing system 2408 can provide the audio signal sample 2402 to the DNN model 306 of the DNN processing loop 104. Furthermore, the DNN model 306 can predict whether the audio signal sample 2402 includes one or more signals of interest. The DNN model 306 can configure the interest value 2302 based on the one or more signals of interest to facilitate ANC processing associated with the ANC pipeline 2409. For example, one or more adaptive noise cancellation processes associated with the ANC pipeline 2409 can be scaled based on the interest value 2302. In an embodiment, the ambient audio signal sample 2406 provided by the ambient microphone 2504 can be scaled based on the interest value 2302 and/or the in-ear audio signal sample 2404 provided by the in-ear microphone 2506 can be scaled based on the interest value 2302.

In certain embodiments, the ANC pipeline 2409 can be implemented as the time-frequency domain transformation pipeline 102 such that the interest value 2302 is applied to the ANC pipeline 2409 in a circumstance where the interest value 2302 is determined by the DNN model 306 prior to expiration of the transformation period associated with the time-frequency domain transformation pipeline 102. In certain embodiments, the interest value 2302 can be applied to the ANC pipeline 2409 regardless of timing associated with asynchronous processing by the DNN processing loop 104 (e.g., without consideration of the transformation period associated with the time-frequency domain transformation pipeline 102).

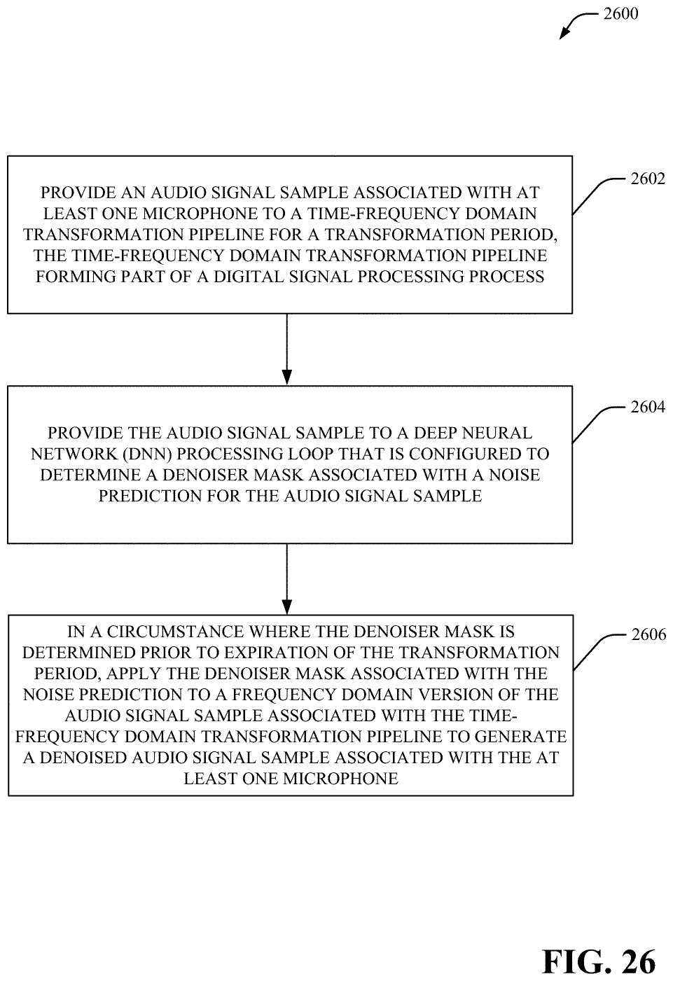

FIG. 26 is a flowchart diagram of an example process 2600, for digital signal processing of an audio sample that is configured to include an asynchronous deep neural network processing loop, in accordance with, for example, the DSP apparatus 1702. Via the various operations of process 2600, the DSP apparatus 1702 can enhance accuracy, efficiency, reliability and/or effectiveness of denoising an audio signal. The process 2600 begins at operation 2602 where an audio signal sample associated with at least one microphone is provided to a time-frequency domain transformation pipeline for a transformation period, the time-frequency domain transformation pipeline forming part of a digital signal processing process. At operation 2604, the audio signal sample is provided to a deep neural network (DNN) processing loop that is configured to determine a denoiser mask associated with a noise prediction for the audio signal sample. At operation 2606, in a circumstance where the denoiser mask is determined prior to expiration of the transformation period, the denoiser mask associated with the noise prediction is applied to a frequency domain version of the audio signal sample associated with the time-frequency domain transformation pipeline to generate a denoised audio signal sample associated with the at least one microphone.

In some embodiments, the process 2600 further includes applying a default denoiser mask associated with a default noise prediction to the frequency domain version of the audio signal sample associated with the time-frequency domain transformation pipeline in a circumstance where the denoiser mask is not determined prior to expiration of the transformation period. In some embodiments, the process 2600 further includes applying a prior denoiser mask associated with a prior noise prediction to the frequency domain version of the audio signal sample associated with the time-frequency domain transformation pipeline in a circumstance where the denoiser mask is not determined prior to expiration of the transformation period.

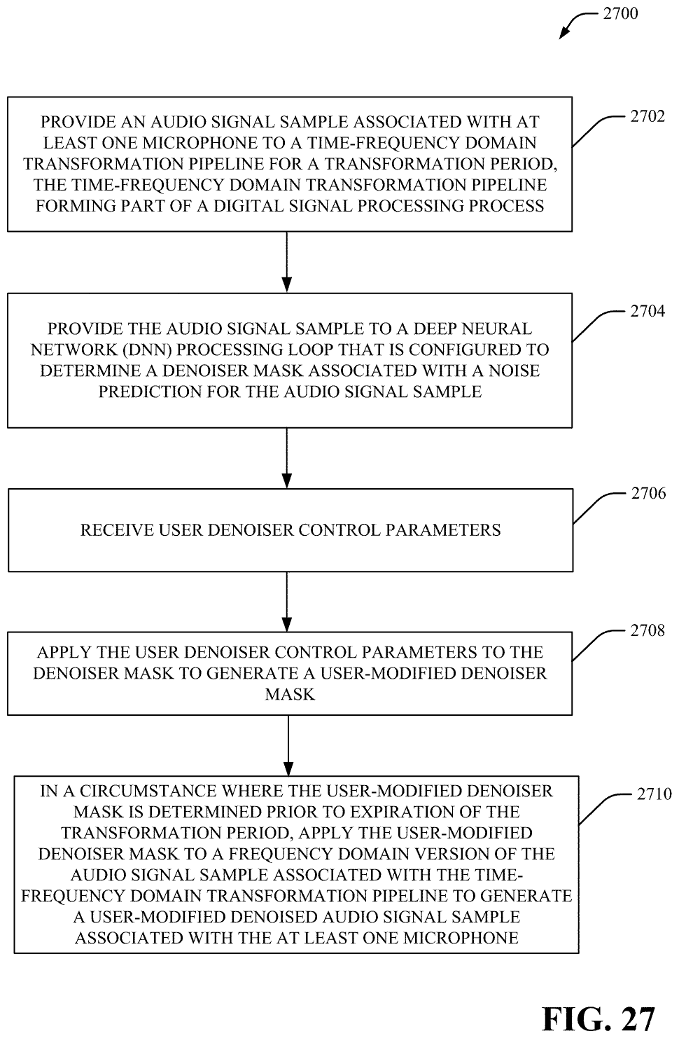

FIG. 27 is a flowchart diagram of an example process 2700, for digital signal processing of an audio sample that is configured to include an asynchronous deep neural network processing loop and user-defined control parameters, in accordance with, for example, the DSP apparatus 1702. Via the various operations of process 2700, the DSP apparatus 1702 can enhance accuracy, efficiency, reliability and/or effectiveness of denoising an audio signal. The process 2700 begins at operation 2702 where an audio signal sample associated with at least one microphone is provided to a time-frequency domain transformation pipeline for a transformation period, the time-frequency domain transformation pipeline forming part of a digital signal processing process.

At operation 2704, the audio signal sample is provided to a deep neural network (DNN) processing loop that is configured to determine a denoiser mask associated with a noise prediction for the audio signal sample. At operation 2706, user denoiser control parameters are received. At operation 2708, the user denoiser control parameters are applied to the denoiser mask to generate a user-modified denoiser mask. At operation 2710, in a circumstance where the user-modified denoiser mask is determined prior to expiration of the transformation period, the user-modified denoiser mask is applied to a frequency domain version of the audio signal sample associated with the time-frequency domain transformation pipeline to generate a user-modified denoised audio signal sample associated with the at least one microphone.

In some embodiments, the process 2700 further includes applying a default denoiser mask associated with a default noise prediction to the frequency domain version of the audio signal sample associated with the time-frequency domain transformation pipeline in a circumstance where the user-modified denoiser mask is not determined prior to expiration of the transformation period. In some embodiments, the process 2600 further includes applying a prior denoiser mask associated with a prior noise prediction to the frequency domain version of the audio signal sample associated with the time-frequency domain transformation pipeline in a circumstance where the user-modified denoiser mask is not determined prior to expiration of the transformation period.

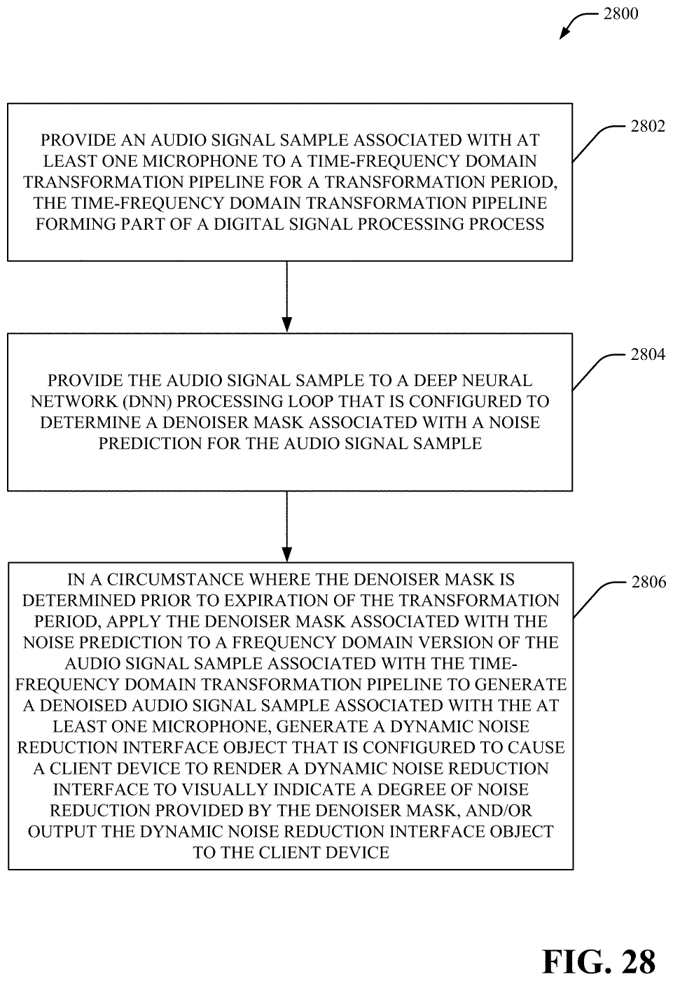

FIG. 28 is a flowchart diagram of an example process 2800, for digital signal processing of an audio sample that is configured to include an asynchronous deep neural network processing loop and a dynamic noise reduction user interface, in accordance with, for example, the DSP apparatus 1702. Via the various operations of process 2800, the DSP apparatus 1702 can enhance accuracy, efficiency, reliability and/or effectiveness of denoising an audio signal. The process 2800 begins at operation 2802 where an audio signal sample associated with at least one microphone is provided to a time-frequency domain transformation pipeline for a transformation period, the time-frequency domain transformation pipeline forming part of a digital signal processing process.

At operation 2804, the audio signal sample is provided to a deep neural network (DNN) processing loop that is configured to determine a denoiser mask associated with a noise prediction for the audio signal sample. At operation 2806, in a circumstance where the denoiser mask is determined prior to expiration of the transformation period, the denoiser mask associated with the noise prediction is applied to a frequency domain version of the audio signal sample associated with the time-frequency domain transformation pipeline to generate a denoised audio signal sample associated with the at least one microphone, a dynamic noise reduction interface object that is configured to cause a client device to render a dynamic noise reduction interface to visually indicate a degree of noise reduction provided by the denoiser mask is generated, and/or the dynamic noise reduction interface object is output to the client device.

In some embodiments, the process 2800 further includes applying a default denoiser mask associated with a default noise prediction to the frequency domain version of the audio signal sample associated with the time-frequency domain transformation pipeline in a circumstance where the denoiser mask is not determined prior to expiration of the transformation period. In some embodiments, the process 2800 further includes applying a prior denoiser mask associated with a prior noise prediction to the frequency domain version of the audio signal sample associated with the time-frequency domain transformation pipeline in a circumstance where the denoiser mask is not determined prior to expiration of the transformation period.

Hereinafter, various characteristics will be highlighted in a set of numbered clauses or paragraphs. These characteristics are not to be interpreted as being limiting on the invention or inventive concept, but are provided merely as a highlighting of some characteristics as described herein, without suggesting a particular order of importance or relevancy of such characteristics.

Clause 1. A digital signal processing (DSP) apparatus configured to reduce noise from an audio signal sample associated with at least one microphone, the DSP apparatus comprising one or more processors and one or more storage devices storing instructions that are operable, when executed by the one or more processors, to cause the DSP apparatus to: provide the audio signal sample to a time-frequency domain transformation pipeline for a transformation period.

Clause 2. The DSP apparatus of clause 1, wherein the time-frequency domain transformation pipeline forms part of a digital signal processing process.

Clause 3. The DSP apparatus of any one of clauses 1-2, wherein the instructions are further operable to cause the DSP apparatus to: provide the audio signal sample to a deep neural network (DNN) processing loop that is configured to determine a denoiser mask associated with a noise prediction for the audio signal sample.

Clause 4. The DSP apparatus of any one of clauses 1-3, wherein the instructions are further operable to cause the DSP apparatus to: in a circumstance where the denoiser mask is determined prior to expiration of the transformation period, apply the denoiser mask associated with the noise prediction to a frequency domain version of the audio signal sample associated with the time-frequency domain transformation pipeline to generate a denoised audio signal sample associated with the at least one microphone.

Clause 5. The DSP apparatus of any one of clauses 1-4, wherein the instructions are further operable to cause the DSP apparatus to: in a circumstance where the denoiser mask is not determined prior to expiration of the transformation period, apply a default denoiser mask associated with a default noise prediction to the frequency domain version of the audio signal sample associated with the time-frequency domain transformation pipeline.

Clause 6. The DSP apparatus of any one of clauses 1-4, wherein the instructions are further operable to cause the DSP apparatus to: in a circumstance where the denoiser mask is not determined prior to expiration of the transformation period, apply a predicted denoiser mask to the frequency domain version of the audio signal sample associated with the time-frequency domain transformation pipeline.

Clause 7. The DSP apparatus of any one of clauses 1-4, wherein the instructions are further operable to cause the DSP apparatus to: in a circumstance where the denoiser mask is not determined prior to expiration of the transformation period, apply a prior denoiser mask associated with a prior noise prediction to the frequency domain version of the audio signal sample associated with the time-frequency domain transformation pipeline.

Clause 8. The DSP apparatus of clause 7, wherein the instructions are further operable to cause the DSP apparatus to: modify the prior denoiser mask in response to applying the prior denoiser mask to the frequency domain version of the audio signal sample associated with the time-frequency domain transformation pipeline.

Clause 9. The DSP apparatus of any one of clauses 1-4, wherein the instructions are further operable to cause the DSP apparatus to: in a circumstance where the denoiser mask is not determined prior to expiration of the transformation period, apply a prior denoiser mask configured without denoising to the frequency domain version of the audio signal sample associated with the time-frequency domain transformation pipeline.

Clause 10. The DSP apparatus of any one of clauses 1-4, wherein the instructions are further operable to cause the DSP apparatus to: in a circumstance where the denoiser mask is not determined prior to expiration of the transformation period, apply a passthrough denoiser mask configured without denoising to the frequency domain version of the audio signal sample associated with the time-frequency domain transformation pipeline.

Clause 11. The DSP apparatus of any one of clauses 1-4, wherein the instructions are further operable to cause the DSP apparatus to: in a circumstance where the denoiser mask is not determined prior to expiration of the transformation period, apply a band-pass shape denoiser mask to the frequency domain version of the audio signal sample associated with the time-frequency domain transformation pipeline.

Clause 12. The DSP apparatus of any one of clauses 1-4, wherein the instructions are further operable to cause the DSP apparatus to: in a circumstance where the denoiser mask is not determined prior to expiration of the transformation period, apply a low-pass shape denoiser mask to the frequency domain version of the audio signal sample associated with the time-frequency domain transformation pipeline.

Clause 13. The DSP apparatus of any one of clauses 1-12, wherein the instructions are further operable to cause the DSP apparatus to: receive user denoiser control parameters.

Clause 14. The DSP apparatus of clause 13, wherein the instructions are further operable to cause the DSP apparatus to: apply the user denoiser control parameters to the denoiser mask to generate a user-modified denoiser mask.

Clause 15. The DSP apparatus of clause 14, wherein the instructions are further operable to cause the DSP apparatus to: in the circumstance where the user-modified denoiser mask is determined prior to expiration of the transformation period, apply the user-modified denoiser mask to the frequency domain version of the audio signal sample associated with the time-frequency domain transformation pipeline to generate a user-modified denoised audio signal sample.

Clause 16. The DSP apparatus of any one of clauses 1-15, wherein the instructions are further operable to cause the DSP apparatus to: provide the denoised audio signal sample associated with the at least one microphone to an audio conferencing processor.

Clause 17. The DSP apparatus of any one of clauses 1-15, wherein the instructions are further operable to cause the DSP apparatus to: provide the denoised audio signal sample associated with the at least one microphone to one or more compression codecs.

Clause 18. The DSP apparatus of any one of clauses 1-15, wherein the instructions are further operable to cause the DSP apparatus to: provide the denoised audio signal sample associated with the at least one microphone to at least one of a parametric equalizer, a dynamics processor, a matrix mixer, or a communications codec.

Clause 19. The DSP apparatus of any one of clauses 1-18, wherein the instructions are further operable to cause the DSP apparatus to: configure the denoised audio signal sample as a digital output signal.

Clause 20. The DSP apparatus of any one of clauses 1-18, wherein the instructions are further operable to cause the DSP apparatus to: configure the denoised audio signal sample as an analog output signal.

Clause 21. The DSP apparatus of any one of clauses 1-15, wherein the instructions are further operable to cause the DSP apparatus to: provide the denoised audio signal sample associated with the at least one microphone to an audio networking system.

Clause 22. The DSP apparatus of any one of clauses 1-21, wherein the instructions are further operable to cause the DSP apparatus to: generate a dynamic noise reduction interface object that is configured to cause a client device to render a dynamic noise reduction interface to visually indicate a degree of noise reduction provided by the denoiser mask.

Clause 23. The DSP apparatus of clause 22, wherein the instructions are further operable to cause the DSP apparatus to: output the dynamic noise reduction interface object to the client device.

Clause 24. The DSP apparatus of clause 23, wherein the dynamic noise reduction interface is configured as a noise reduction loss meter interface associated with the degree of noise reduction provided by the denoiser mask.

Clause 25. The DSP apparatus of any one of clauses 1-4, wherein the frequency domain version of the audio signal sample is a first frequency domain audio signal sample.

Clause 26. The DSP apparatus of clause 25, wherein the instructions are further operable to cause the DSP apparatus to: transform the audio signal sample into the first frequency domain audio signal sample via the time-frequency domain transformation pipeline.

Clause 27. The DSP apparatus of clause 26, wherein the instructions are further operable to cause the DSP apparatus to: transform the audio signal sample into a second frequency domain audio signal sample via the DNN processing loop.

Clause 28. The DSP apparatus of clause 27, wherein the instructions are further operable to cause the DSP apparatus to: provide the second frequency domain audio signal sample to a DNN model that is configured to determine the denoiser mask.

Clause 29. The DSP apparatus of clause 28, wherein the instructions are further operable to cause the DSP apparatus to: in the circumstance where the denoiser mask is determined prior to expiration of the transformation period, apply the denoiser mask to the first frequency domain audio signal sample.

Clause 30. The DSP apparatus of clause 27, wherein the instructions are further operable to cause the DSP apparatus to: configure the second frequency domain audio signal sample as a non-uniform-bandwidth frequency domain representation of the audio signal sample.

Clause 31. The DSP apparatus of clause 27, wherein the instructions are further operable to cause the DSP apparatus to: configure the second frequency domain audio signal sample in a Bark scale format associated with the audio signal sample.

Clause 32. The DSP apparatus of clause 27, wherein the second frequency domain audio signal sample is configured as a concatenation of multiple window sizes.

Clause 33. The DSP apparatus of any one of clauses 1-4, wherein the instructions are further operable to cause the DSP apparatus to: modify frequency of one or more portions of the audio signal sample to generate a modified audio signal sample.

Clause 34. The DSP apparatus of clause 33, wherein the instructions are further operable to cause the DSP apparatus to: transform the modified audio signal sample into a frequency domain audio signal sample.

Clause 35. The DSP apparatus of clause 34, wherein the instructions are further operable to cause the DSP apparatus to: modify frequency of one or more portions of the frequency domain audio signal sample to generate a modified frequency domain audio signal sample.

Clause 36. The DSP apparatus of clause 35, wherein the instructions are further operable to cause the DSP apparatus to: determine the denoiser mask associated with the noise prediction based on the modified frequency domain audio signal sample.

Clause 37. The DSP apparatus of clause 36, wherein the instructions are further operable to cause the DSP apparatus to: provide the modified frequency domain audio signal sample to a DNN model that is configured to determine the denoiser mask.

Clause 38. The DSP apparatus of clause 37, wherein the instructions are further operable to cause the DSP apparatus to: in the circumstance where the denoiser mask is determined prior to expiration of the transformation period, apply the denoiser mask to the frequency domain version of the audio signal sample associated with the time-frequency domain transformation pipeline.

Clause 39. The DSP apparatus of any one of clauses 1-4, wherein the instructions are further operable to cause the DSP apparatus to: perform spatial filtering of the denoiser mask to generate an optimized denoiser mask.

Clause 40. The DSP apparatus of clause 39, wherein the instructions are further operable to cause the DSP apparatus to: in a circumstance where the optimized denoiser mask is determined prior to expiration of the transformation period, apply the optimized denoiser mask to the frequency domain version of the audio signal sample associated with the time-frequency domain transformation pipeline to generate an optimized denoised audio signal sample associated with the at least one microphone.

Clause 41. The DSP apparatus of any one of clauses 1-4, wherein the instructions are further operable to cause the DSP apparatus to: apply the denoiser mask associated with the noise prediction to the frequency domain version of the audio signal sample associated with the time-frequency domain transformation pipeline in a circumstance where a user bypass input parameter associated with the time-frequency domain transformation pipeline satisfies a defined bypass criterion.

Clause 42. The DSP apparatus of any one of clauses 1-41, wherein the DNN processing loop comprises a convolutional neural network that is configured to determine the denoiser mask.

Clause 43. The DSP apparatus of any one of clauses 1-41, wherein the DNN processing loop comprises a recurrent neural network configured to determine the denoiser mask.

Clause 44. The DSP apparatus of any one of clauses 1-41, wherein the DNN processing loop comprises a hybrid network associated with a set of convolutional layers and a set of recurrent layers configured to determine the denoiser mask.

Clause 45. The DSP apparatus of any one of clauses 1-44, wherein the denoiser mask is a time-frequency mask associated with the noise prediction for the audio signal sample.

Clause 46. The DSP apparatus of any one of clauses 1-45, wherein the audio signal sample is associated with a plurality of beamformed lobes of a microphone array.

Clause 47. The DSP apparatus of any one of clauses 1-46, wherein the DSP apparatus is a DSP processor, an Advanced RISC Machine (ARM) processor, or a field programmable gate array (FPGA) processor.

Clause 48. The DSP apparatus of any one of clauses 1-47, wherein the DSP apparatus is embedded within a virtual audio driver.

Clause 49. The DSP apparatus of any one of clauses 1-48, wherein the instructions are further operable to cause the DSP apparatus to: provide the audio signal sample to a DNN model of the DNN processing loop that is configured to predict whether the audio signal sample includes one or more signals of interest and to configure the denoiser mask based on the one or more signals of interest.

Clause 50. The DSP apparatus of clause 49, wherein the instructions are further operable to cause the DSP apparatus to: in the circumstance where the denoiser mask is determined prior to expiration of the transformation period, scale active noise cancellation associated with the audio signal sample based on the denoiser mask. Clause 51. The DSP apparatus of any one of clauses 1-50, wherein the DSP apparatus performs a computer-implemented method related to any one of clauses 1-50.

Clause 52. The DSP apparatus of any one of clauses 1-50, wherein a computer program product, stored on a computer readable medium, comprising instructions that, when executed by one or more processors of the DSP apparatus, cause the one or more processors to perform one or more operations related to any one of clauses 1-50.

Clause 53. A digital signal processing (DSP) apparatus configured to reduce noise from an audio signal sample associated with at least one microphone, the DSP apparatus comprising one or more processors and one or more storage devices storing instructions that are operable, when executed by the one or more processors, to cause the DSP apparatus to: provide the audio signal sample to a time-frequency domain transformation pipeline for a transformation period.

Clause 54. The DSP apparatus of clause 53, wherein the time-frequency domain transformation pipeline forms part of a digital signal processing process.

Clause 55. The DSP apparatus of any one of clauses 53-54, wherein the instructions are further operable to cause the DSP apparatus to: provide the audio signal sample to a deep neural net (DNN) processing loop that is configured to determine a denoiser mask associated with a noise prediction for the audio signal sample.

Clause 56. The DSP apparatus of any one of clauses 53-55, wherein the instructions are further operable to cause the DSP apparatus to: receive user denoiser control parameters.

Clause 57. The DSP apparatus of any one of clauses 53-56, wherein the instructions are further operable to cause the DSP apparatus to: apply the user denoiser control parameters to the denoiser mask to generate a user-modified denoiser mask.

Clause 58. The DSP apparatus of any one of clauses 53-56, wherein the instructions are further operable to cause the DSP apparatus to: in a circumstance where the user-modified denoiser mask is determined prior to expiration of the transformation period, apply the user-modified denoiser mask to a frequency domain version of the audio signal sample associated with the time-frequency domain transformation pipeline to generate a user-modified denoised audio signal sample.

Clause 59. The DSP apparatus of any one of clauses 53-58, wherein the instructions are further operable to cause the DSP apparatus to: in a circumstance where the user-modified denoiser mask is not determined prior to expiration of the transformation period, apply a default denoiser mask associated with a default noise prediction to the frequency domain version of the audio signal sample associated with the time-frequency domain transformation pipeline.

Clause 60. The DSP apparatus of any one of clauses 53-58, wherein the instructions are further operable to cause the DSP apparatus to: in a circumstance where the user-modified denoiser mask is not determined prior to expiration of the transformation period, apply a predicted denoiser mask to the frequency domain version of the audio signal sample associated with the time-frequency domain transformation pipeline.

Clause 61. The DSP apparatus of any one of clauses 53-58, wherein the instructions are further operable to cause the DSP apparatus to: in a circumstance where the user-modified denoiser mask is not determined prior to expiration of the transformation period, apply a prior denoiser mask associated with a prior noise prediction to the frequency domain version of the audio signal sample associated with the time-frequency domain transformation pipeline.

Clause 62. The DSP apparatus of clause 61, wherein the instructions are further operable to cause the DSP apparatus to: modify the prior denoiser mask in response to applying the prior denoiser mask to the frequency domain version of the audio signal sample associated with the time-frequency domain transformation pipeline.

Clause 63. The DSP apparatus of any one of clauses 53-58, wherein the instructions are further operable to cause the DSP apparatus to: in a circumstance where the user-modified denoiser mask is not determined prior to expiration of the transformation period, apply a prior denoiser mask configured without denoising to the frequency domain version of the audio signal sample associated with the time-frequency domain transformation pipeline.

Clause 64. The DSP apparatus of any one of clauses 53-63, wherein the DSP apparatus performs a computer-implemented method related to any one of clauses 53-63.

Clause 65. The DSP apparatus of any one of clauses 53-63, wherein a computer program product, stored on a computer readable medium, comprising instructions that, when executed by one or more processors of the DSP apparatus, cause the one or more processors to perform one or more operations related to any one of clauses 53-63.

Clause 66. A digital signal processing (DSP) apparatus configured to reduce noise from an audio signal sample associated with at least one microphone, the DSP apparatus comprising one or more processors and one or more storage devices storing instructions that are operable, when executed by the one or more processors, to cause the DSP apparatus to: provide the audio signal sample to a time-frequency domain transformation pipeline for a transformation period.

Clause 67. The DSP apparatus of clause 66, wherein the time-frequency domain transformation pipeline forms part of a digital signal processing process.

Clause 68. The DSP apparatus of any one of clauses 66-67, wherein the instructions are further operable to cause the DSP apparatus to: provide the audio signal sample to a deep neural net (DNN) processing loop that is configured to determine a denoiser mask associated with a noise prediction for the audio signal sample.

Clause 69. The DSP apparatus of any one of clauses 66-68, wherein the instructions are further operable to cause the DSP apparatus to: in a circumstance where the denoiser mask is determined prior to expiration of the transformation period, apply the denoiser mask associated with the noise prediction to a frequency domain version of the audio signal sample associated with the time-frequency domain transformation pipeline to generate a denoised audio signal sample, generate a dynamic noise reduction interface object that is configured to cause a client device to render a dynamic noise reduction interface to visually indicate a degree of noise reduction provided by the denoiser mask, and/or output the dynamic noise reduction interface object to the client device.

Clause 70. The DSP apparatus of any one of clauses 66-69, wherein the instructions are further operable to cause the DSP apparatus to: in a circumstance where the denoiser mask is not determined prior to expiration of the transformation period, apply a default denoiser mask associated with a default noise prediction to the frequency domain version of the audio signal sample associated with the time-frequency domain transformation pipeline.

Clause 71. The DSP apparatus of any one of clauses 66-69, wherein the instructions are further operable to cause the DSP apparatus to: in a circumstance where the denoiser mask is not determined prior to expiration of the transformation period, apply a predicted denoiser mask to the frequency domain version of the audio signal sample associated with the time-frequency domain transformation pipeline.

Clause 72. The DSP apparatus of any one of clauses 66-69, wherein the instructions are further operable to cause the DSP apparatus to: in a circumstance where the denoiser mask is not determined prior to expiration of the transformation period, apply a prior denoiser mask associated with a prior noise prediction to the frequency domain version of the audio signal sample associated with the time-frequency domain transformation pipeline.

Clause 73. The DSP apparatus of clause 72, wherein the instructions are further operable to cause the DSP apparatus to: modify the prior denoiser mask in response to applying the prior denoiser mask to the frequency domain version of the audio signal sample associated with the time-frequency domain transformation pipeline.

Clause 74. The DSP apparatus of any one of clauses 66-69, wherein the instructions are further operable to cause the DSP apparatus to: in a circumstance where the denoiser mask is not determined prior to expiration of the transformation period, apply a prior denoiser mask configured without denoising to the frequency domain version of the audio signal sample associated with the time-frequency domain transformation pipeline.

Clause 75. The DSP apparatus of any one of clauses 66-74, wherein the DSP apparatus performs a computer-implemented method related to any one of clauses 66-74.

Clause 76. The DSP apparatus of any one of clauses 66-74, wherein a computer program product, stored on a computer readable medium, comprising instructions that, when executed by one or more processors of the DSP apparatus, cause the one or more processors to perform one or more operations related to any one of clauses 66-74.

Clause 77. A digital signal processing (DSP) apparatus configured to reduce noise from an audio signal sample associated with at least one microphone, the DSP apparatus comprising one or more processors and one or more storage devices storing instructions that are operable, when executed by the one or more processors, to cause the DSP apparatus to: provide the audio signal sample to a time-frequency domain transformation pipeline for a transformation period.

Clause 78. The DSP apparatus of clause 77, wherein the time-frequency domain transformation pipeline forms part of a digital signal processing process.

Clause 79. The DSP apparatus of any one of clauses 77-78, wherein the instructions are further operable to cause the DSP apparatus to: provide the audio signal sample to a deep neural net (DNN) processing loop that is configured to determine a denoiser mask associated with a noise prediction for the audio signal sample.

Clause 80. The DSP apparatus of any one of clauses 77-79, wherein the instructions are further operable to cause the DSP apparatus to: in a circumstance where the denoiser mask is determined prior to expiration of the transformation period, apply the denoiser mask associated with the noise prediction to a frequency domain version of the audio signal sample associated with the time-frequency domain transformation pipeline to generate a denoised audio signal sample associated with the at least one microphone, generate a dynamic noise reduction interface object that is configured to cause a client device to render a dynamic noise reduction interface to visually indicate a degree of noise reduction provided by the denoiser mask, and/or output the dynamic noise reduction interface object to the client device.

Clause 81. The DSP apparatus of any one of clauses 77-80, wherein the instructions are further operable to cause the DSP apparatus to: in a circumstance where the denoiser mask is not determined prior to expiration of the transformation period, apply a default denoiser mask associated with a default noise prediction to the frequency domain version of the audio signal sample associated with the time-frequency domain transformation pipeline.

Clause 82. The DSP apparatus of any one of clauses 77-80, wherein the instructions are further operable to cause the DSP apparatus to: in a circumstance where the denoiser mask is not determined prior to expiration of the transformation period, apply a predicted denoiser mask to the frequency domain version of the audio signal sample associated with the time-frequency domain transformation pipeline.

Clause 83. The DSP apparatus of any one of clauses 77-80, wherein the instructions are further operable to cause the DSP apparatus to: in a circumstance where the denoiser mask is not determined prior to expiration of the transformation period, apply a prior denoiser mask associated with a prior noise prediction to the frequency domain version of the audio signal sample associated with the time-frequency domain transformation pipeline.

Clause 84. The DSP apparatus of clause 83, wherein the instructions are further operable to cause the DSP apparatus to: modify the prior denoiser mask in response to applying the prior denoiser mask to the frequency domain version of the audio signal sample associated with the time-frequency domain transformation pipeline.

Clause 85. The DSP apparatus of any one of clauses 77-80, wherein the instructions are further operable to cause the DSP apparatus to: in a circumstance where the denoiser mask is not determined prior to expiration of the transformation period, apply a prior denoiser mask configured without denoising to the frequency domain version of the audio signal sample associated with the time-frequency domain transformation pipeline.

Clause 86. The DSP apparatus of any one of clauses 77-85, wherein the DSP apparatus performs a computer-implemented method related to any one of clauses 77-85.

Clause 87. The DSP apparatus of any one of clauses 77-85, wherein a computer program product, stored on a computer readable medium, comprising instructions that, when executed by one or more processors of the DSP apparatus, cause the one or more processors to perform one or more operations related to any one of clauses 75-82.

Clause 88. A digital signal processing (DSP) apparatus configured to reduce noise from a mixture audio signal sample generated based on a plurality of other audio signal samples, the DSP apparatus comprising one or more processors and one or more storage devices storing instructions that are operable, when executed by the one or more processors, to cause the DSP apparatus to: provide the mixture audio signal sample to a time-frequency domain transformation pipeline for a transformation period.

Clause 89. The DSP apparatus of clause 88, wherein the time-frequency domain transformation pipeline forms part of a digital signal processing process.

Clause 90. The DSP apparatus of any one of clauses 88-89, wherein the instructions are further operable to cause the DSP apparatus to: provide respective component audio signal samples of the mixture audio signal sample to a deep neural network (DNN) processing loop that is configured to determine a denoiser mask associated with a noise prediction for the mixture audio signal sample.

Clause 91. The DSP apparatus of any one of clauses 88-89, wherein the instructions are further operable to cause the DSP apparatus to: in a circumstance where the denoiser mask is determined prior to expiration of the transformation period, apply the denoiser mask associated with the noise prediction to a frequency domain version of the mixture audio signal sample associated with the time-frequency domain transformation pipeline to generate a denoised audio signal sample.

Clause 92. The DSP apparatus of any one of clauses 88-91, wherein the respective component audio signal samples of the mixture audio signal sample are generated by respective beamformed lobes of a microphone array.

Clause 93. The DSP apparatus of any one of clauses 88-91, wherein the instructions are further operable to cause the DSP apparatus to: in a circumstance where the denoiser mask is not determined prior to expiration of the transformation period, apply a default denoiser mask associated with a default noise prediction to the frequency domain version of the mixture audio signal sample associated with the time-frequency domain transformation pipeline.

Clause 94. The DSP apparatus of any one of clauses 88-91, wherein the instructions are further operable to cause the DSP apparatus to: in a circumstance where the denoiser mask is not determined prior to expiration of the transformation period, apply a predicted denoiser mask to the frequency domain version of the mixture audio signal sample associated with the time-frequency domain transformation pipeline.

Clause 95. The DSP apparatus of any one of clauses 88-91, wherein the instructions are further operable to cause the DSP apparatus to: in a circumstance where the denoiser mask is not determined prior to expiration of the transformation period, apply a prior denoiser mask associated with a prior noise prediction to the frequency domain version of the mixture audio signal sample associated with the time-frequency domain transformation pipeline.

Clause 96. The DSP apparatus of clause 95, wherein the instructions are further operable to cause the DSP apparatus to: modify the prior denoiser mask in response to applying the prior denoiser mask to the frequency domain version of the mixture audio signal sample associated with the time-frequency domain transformation pipeline.

Clause 97. The DSP apparatus of any one of clauses 88-91, wherein the instructions are further operable to cause the DSP apparatus to: in a circumstance where the denoiser mask is not determined prior to expiration of the transformation period, apply a prior denoiser mask configured without denoising to the frequency domain version of the mixture audio signal sample associated with the time-frequency domain transformation pipeline.

Clause 98. The DSP apparatus of any one of clauses 88-98, wherein the DSP apparatus performs a computer-implemented method related to any one of clauses 88-98.

Clause 99. The DSP apparatus of any one of clauses 88-98, wherein a computer program product, stored on a computer readable medium, comprising instructions that, when executed by one or more processors of the DSP apparatus, cause the one or more processors to perform one or more operations related to any one of clauses 88-98.

Clause 100. A digital signal processing (DSP) apparatus configured to reduce noise from an audio signal sample associated with at least one microphone, the DSP apparatus comprising one or more processors and one or more storage devices storing instructions that are operable, when executed by the one or more processors, to cause the DSP apparatus to: receive user denoiser control parameters to facilitate audition of noise to be removed from the audio signal sample.

Clause 101. The DSP apparatus of clause 100, wherein the instructions are further operable to cause the DSP apparatus to: apply the user denoiser control parameters to a denoiser mask generated by a deep neural network (DNN) processing loop to generate a user-modified de-speech mask.

Clause 102. The DSP apparatus of any one of clauses 100-101, wherein the instructions are further operable to cause the DSP apparatus to: in a circumstance where the user-modified de-speech mask is determined prior to expiration of a transformation period associated with a time-frequency domain transformation pipeline, apply the user-modified de-speech mask to a frequency domain version of the audio signal sample associated with the time-frequency domain transformation pipeline to generate a user-modified de-speech audio signal sample.

Clause 103. The DSP apparatus of any one of clauses 100-102, wherein the instructions are further operable to cause the DSP apparatus to: in a circumstance where the denoiser mask is not determined prior to expiration of the transformation period, apply a default denoiser mask associated with a default noise prediction to the frequency domain version of the audio signal sample associated with the time-frequency domain transformation pipeline.

Clause 104. The DSP apparatus of any one of clauses 100-102, wherein the instructions are further operable to cause the DSP apparatus to: in a circumstance where the denoiser mask is not determined prior to expiration of the transformation period, apply a predicted denoiser mask to the frequency domain version of the audio signal sample associated with the time-frequency domain transformation pipeline.

Clause 105. The DSP apparatus of any one of clauses 100-102, wherein the instructions are further operable to cause the DSP apparatus to: in a circumstance where the denoiser mask is not determined prior to expiration of the transformation period, apply a prior denoiser mask associated with a prior noise prediction to the frequency domain version of the audio signal sample associated with the time-frequency domain transformation pipeline.

Clause 106. The DSP apparatus of clause 105, wherein the instructions are further operable to cause the DSP apparatus to: modify the prior denoiser mask in response to applying the prior denoiser mask to the frequency domain version of the audio signal sample associated with the time-frequency domain transformation pipeline.

Clause 107. The DSP apparatus of any one of clauses 100-102, wherein the instructions are further operable to cause the DSP apparatus to: in a circumstance where the denoiser mask is not determined prior to expiration of the transformation period, apply a prior denoiser mask configured without denoising to the frequency domain version of the audio signal sample associated with the time-frequency domain transformation pipeline.

Clause 108. The DSP apparatus of any one of clauses 100-107, wherein the DSP apparatus performs a computer-implemented method related to any one of clauses 100-107.

Clause 109. The DSP apparatus of any one of clauses 100-107, wherein a computer program product, stored on a computer readable medium, comprising instructions that, when executed by one or more processors of the DSP apparatus, cause the one or more processors to perform one or more operations related to any one of clauses 100-107.

Clause 110. A digital signal processing (DSP) apparatus configured to reduce noise from a mixture audio signal sample generated based on a plurality of other audio signal samples, the DSP apparatus comprising one or more processors and one or more storage devices storing instructions that are operable, when executed by the one or more processors, to cause the DSP apparatus to: provide the mixture audio signal sample to a time-frequency domain transformation pipeline.

Clause 111. The DSP apparatus of clause 110, wherein the time-frequency domain transformation pipeline forms part of a digital signal processing process.

Clause 112. The DSP apparatus of any one of clauses 110-111, wherein the instructions are further operable to cause the DSP apparatus to: provide respective component audio signal samples of the mixture audio signal sample to a deep neural network (DNN) processing loop that is configured to determine a denoiser mask associated with a noise prediction for the mixture audio signal sample.

Clause 113. The DSP apparatus of any one of clauses 110-112, wherein the instructions are further operable to cause the DSP apparatus to: apply the denoiser mask associated with the noise prediction to a frequency domain version of the mixture audio signal sample associated with the time-frequency domain transformation pipeline to generate a denoised audio signal sample.

Clause 114. The DSP apparatus of any one of clauses 110-113, wherein the respective component audio signal samples of the mixture audio signal sample are generated by respective microphones.

Clause 115. The DSP apparatus of any one of clauses 110-113, wherein the respective component audio signal samples of the mixture audio signal sample are generated by respective beamformed lobes of a microphone array.

Clause 116. The DSP apparatus of any one of clauses 110-115, wherein the DSP apparatus performs a computer-implemented method related to any one of clauses 110-115.

Clause 117. The DSP apparatus of any one of clauses 110-115, wherein a computer program product, stored on a computer readable medium, comprising instructions that, when executed by one or more processors of the DSP apparatus, cause the one or more processors to perform one or more operations related to any one of clauses 110-115.

Clause 118. A digital signal processing (DSP) apparatus configured to provide AI denoiser audio processing associated with an audio signal sample, the DSP apparatus comprising one or more processors and one or more storage devices storing instructions that are operable, when executed by the one or more processors, to cause the DSP apparatus to: provide the audio signal sample to a deep neural network (DNN) processing loop that is configured to determine whether the audio signal sample includes one or more signals of interest.

Clause 119. The DSP apparatus of clause 118, wherein the instructions are further operable to cause the DSP apparatus to: configure an interest value based on the one or more signals of interest.

Clause 120. The DSP apparatus of any one of clauses 118-119, wherein the instructions are further operable to cause the DSP apparatus to: apply the interest value to an adaptive noise cancellation pipeline for the audio signal sample.

Clause 121. The DSP apparatus of any one of clauses 118-120, wherein the instructions are further operable to cause the DSP apparatus to: scale one or more adaptive noise cancellation processes based on the interest value.

Clause 122. The DSP apparatus of any one of clauses 118-121, wherein the instructions are further operable to cause the DSP apparatus to: scale an in-ear microphone signal associated with an in-ear microphone of a wearable listening device based on the interest value.

Clause 123. The DSP apparatus of any one of clauses 118-122, wherein the instructions are further operable to cause the DSP apparatus to: scale an ambient audio microphone signal associated with an ambient microphone of a wearable listening device based on the interest value.

Clause 124. The DSP apparatus of any one of clauses 118-123, wherein the instructions are further operable to cause the DSP apparatus to: scale, based on the interest value, an in-ear microphone signal associated with an in-ear microphone of a wearable listening device and an ambient audio microphone signal associated with the ambient microphone of a wearable listening device.

Clause 125. The DSP apparatus of any one of clauses 118-124, wherein the audio signal sample is an otoacoustic emissions signal sample.

Clause 126. The DSP apparatus of clause 125, wherein the instructions are further operable to cause the DSP apparatus to: provide the otoacoustic emissions signal sample to a DNN model of the DNN processing loop that is configured to predict whether the otoacoustic emissions signal sample includes one or more signals of interest.

Clause 127. The DSP apparatus of any one of clauses 1-52, wherein the audio signal sample is an otoacoustic emissions signal sample.

Clause 128. The DSP apparatus of clause 127, wherein the instructions are further operable to cause the DSP apparatus to: provide the otoacoustic emissions signal sample to a DNN model of the DNN processing loop that is configured to predict whether the otoacoustic emissions signal sample includes one or more signals of interest and to configure the denoiser mask based on the one or more signals of interest.

Although example processing systems have been described in the figures herein, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer-readable storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer-readable storage medium can be, or be included in, a computer-readable storage device, a computer-readable storage substrate, a random or serial access memory array or device, or a combination of one or more of them. Moreover, while a computer-readable storage medium is not a propagated signal, a computer-readable storage medium can be a source or destination of computer program instructions encoded in an artificially-generated propagated signal. The computer-readable storage medium can also be, or be included in, one or more separate physical components or media (e.g., multiple CDs, disks, or other storage devices).

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

While this specification contains many specific implementation details, these should not be construed as limitations on the scope of any disclosures or of what may be claimed, but rather as description of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in incremental order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a product or packaged into multiple products.

Thus, particular embodiments of the subject matter have been described.

Other embodiments are within the scope of the following claims. In some cases, the actions recited in the claims can be performed in a different order and still achieve desirable results. In addition, the processes depicted in the accompanying figures do not necessarily require the particular order shown, or incremental order, to achieve desirable results, unless described otherwise. In certain implementations, multitasking and parallel processing may be advantageous.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

That which is claimed is:

1. A digital signal processing (DSP) apparatus configured to reduce noise from an audio signal sample associated with at least one microphone, the DSP apparatus comprising one or more processors and one or more storage devices storing instructions that are operable, when executed by the one or more processors, to cause the DSP apparatus to:
provide the audio signal sample to a time-frequency domain transformation pipeline for a transformation period, wherein the time-frequency domain transformation pipeline forms part of a digital signal processing process;
provide the audio signal sample to a deep neural network (DNN) processing loop that is configured to determine a denoiser mask associated with a noise prediction for the audio signal sample; and
in a circumstance where the denoiser mask is determined prior to expiration of the transformation period, apply the denoiser mask associated with the noise prediction to a frequency domain version of the audio signal sample associated with the time-frequency domain transformation pipeline to generate a denoised audio signal sample associated with the at least one microphone.

2. The DSP apparatus of claim 1, wherein the instructions are further operable to cause the DSP apparatus to:
in a circumstance where the denoiser mask is not determined prior to expiration of the transformation period, apply a default denoiser mask associated with a default noise prediction to the frequency domain version of the audio signal sample associated with the time-frequency domain transformation pipeline.

3. The DSP apparatus of claim 1, wherein the instructions are further operable to cause the DSP apparatus to:
in a circumstance where the denoiser mask is not determined prior to expiration of the transformation period, apply a prior denoiser mask associated with a prior noise prediction to the frequency domain version of the audio signal sample associated with the time-frequency domain transformation pipeline.

4. The DSP apparatus of claim 3, wherein the instructions are further operable to cause the DSP apparatus to:
modify the prior denoiser mask in response to applying the prior denoiser mask to the frequency domain version of the audio signal sample associated with the time-frequency domain transformation pipeline.

5. The DSP apparatus of claim 1, wherein the instructions are further operable to cause the DSP apparatus to:
in a circumstance where the denoiser mask is not determined prior to expiration of the transformation period, apply a passthrough denoiser mask configured without denoising to the frequency domain version of the audio signal sample associated with the time-frequency domain transformation pipeline.

6. The DSP apparatus of claim 1, wherein the instructions are further operable to cause the DSP apparatus to:
in a circumstance where the denoiser mask is not determined prior to expiration of the transformation period, apply a band-pass shape denoiser mask to the frequency domain version of the audio signal sample associated with the time-frequency domain transformation pipeline.

7. The DSP apparatus of claim 1, wherein the instructions are further operable to cause the DSP apparatus to:
in a circumstance where the denoiser mask is not determined prior to expiration of the transformation period, apply a low-pass shape denoiser mask to the frequency domain version of the audio signal sample associated with the time-frequency domain transformation pipeline.

8. The DSP apparatus of claim 1, wherein the instructions are further operable to cause the DSP apparatus to:
receive user denoiser control parameters;
apply the user denoiser control parameters to the denoiser mask to generate a user-modified denoiser mask; and
in the circumstance where the user-modified denoiser mask is determined prior to expiration of the transformation period, apply the user-modified denoiser mask to the frequency domain version of the audio signal sample associated with the time-frequency domain transformation pipeline to generate a user-modified denoised audio signal sample.

9. The DSP apparatus of claim 1, wherein the instructions are further operable to cause the DSP apparatus to:
generate a dynamic noise reduction interface object that is configured to cause a client device to render a dynamic noise reduction interface to visually indicate a degree of noise reduction provided by the denoiser mask; and
output the dynamic noise reduction interface object to the client device.

10. The DSP apparatus of claim 1, wherein the frequency domain version of the audio signal sample is a first frequency domain audio signal sample, and wherein the instructions are further operable to cause the DSP apparatus to:
transform the audio signal sample into the first frequency domain audio signal sample via the time-frequency domain transformation pipeline; and
transform the audio signal sample into a second frequency domain audio signal sample via the DNN processing loop.
provide the second frequency domain audio signal sample to a DNN model that is configured to determine the denoiser mask; and
in the circumstance where the denoiser mask is determined prior to expiration of the transformation period, apply the denoiser mask to the first frequency domain audio signal sample.

11. The DSP apparatus of claim 1, wherein the instructions are further operable to cause the DSP apparatus to:
modify frequency of one or more portions of the audio signal sample to generate a modified audio signal sample;
transform the modified audio signal sample into a frequency domain audio signal sample;
modify frequency of one or more portions of the frequency domain audio signal sample to generate a modified frequency domain audio signal sample; and
determine the denoiser mask associated with the noise prediction based on the modified frequency domain audio signal sample.

12. The DSP apparatus of claim 11, wherein the instructions are further operable to cause the DSP apparatus to:
provide the modified frequency domain audio signal sample to a DNN model that is configured to determine the denoiser mask; and
in the circumstance where the denoiser mask is determined prior to expiration of the transformation period, apply the denoiser mask to the frequency domain version of the audio signal sample associated with the time-frequency domain transformation pipeline.

13. The DSP apparatus of claim 1, wherein the instructions are further operable to cause the DSP apparatus to:
perform spatial filtering of the denoiser mask to generate an optimized denoiser mask; and
in a circumstance where the optimized denoiser mask is determined prior to expiration of the transformation period, apply the optimized denoiser mask to the frequency domain version of the audio signal sample associated with the time-frequency domain transformation pipeline to generate an optimized denoised audio signal sample associated with the at least one microphone.

14. The DSP apparatus of claim 1, wherein the instructions are further operable to cause the DSP apparatus to:
apply the denoiser mask associated with the noise prediction to the frequency domain version of the audio signal sample associated with the time-frequency domain transformation pipeline in a circumstance where a user bypass input parameter associated with the time-frequency domain transformation pipeline satisfies a defined bypass criterion.

15. The DSP apparatus of claim 1, wherein the instructions are further operable to cause the DSP apparatus to:
provide the audio signal sample to a DNN model of the DNN processing loop that is configured to predict whether the audio signal sample includes one or more signals of interest and to configure the denoiser mask based on the one or more signals of interest; and
in the circumstance where the denoiser mask is determined prior to expiration of the transformation period, scale active noise cancellation associated with the audio signal sample based on the denoiser mask.

16. The DSP apparatus of claim 1, wherein the audio signal sample is an otoacoustic emissions signal sample, and wherein the instructions are further operable to cause the DSP apparatus to:
provide the otoacoustic emissions signal sample to a DNN model of the DNN processing loop that is configured to predict whether the otoacoustic emissions signal sample includes one or more signals of interest and to configure the denoiser mask based on the one or more signals of interest.

17. A computer-implemented method performed by a digital signal processing (DSP) apparatus configured to reduce noise from an audio signal sample associated with at least one microphone, comprising:
providing the audio signal sample to a time-frequency domain transformation pipeline for a transformation period, wherein the time-frequency domain transformation pipeline forms part of a digital signal processing process;
providing the audio signal sample to a deep neural network (DNN) processing loop that is configured to determine a denoiser mask associated with a noise prediction for the audio signal sample; and
in a circumstance where the denoiser mask is determined prior to expiration of the transformation period, applying the denoiser mask associated with the noise prediction to a frequency domain version of the audio signal sample associated with the time-frequency domain transformation pipeline to generate a denoised audio signal sample associated with the at least one microphone.

18. The computer-implemented method of claim 17, further comprising:
in a circumstance where the denoiser mask is not determined prior to expiration of the transformation period, applying a default denoiser mask associated with a default noise prediction to the frequency domain version of the audio signal sample associated with the time-frequency domain transformation pipeline.

19. The computer-implemented method of claim 17, further comprising:
in a circumstance where the denoiser mask is not determined prior to expiration of the transformation period, applying a predicted denoiser mask to the frequency domain version of the audio signal sample associated with the time-frequency domain transformation pipeline.

20. The computer-implemented method of claim 17, further comprising:
in a circumstance where the denoiser mask is not determined prior to expiration of the transformation period, applying a prior denoiser mask configured without denoising to the frequency domain version of the audio signal sample associated with the time-frequency domain transformation pipeline.

21. A computer program product, stored on a computer readable medium, comprising instructions that, when executed by one or more processors of a digital signal processing (DSP) apparatus configured to reduce noise from an audio signal sample associated with at least one microphone, cause the one or more processors to:
provide the audio signal sample to a time-frequency domain transformation pipeline for a transformation period, wherein the time-frequency domain transformation pipeline forms part of a digital signal processing process;
provide the audio signal sample to a deep neural network (DNN) processing loop that is configured to determine a denoiser mask associated with a noise prediction for the audio signal sample; and
in a circumstance where the denoiser mask is determined prior to expiration of the transformation period, apply the denoiser mask associated with the noise prediction to a frequency domain version of the audio signal sample associated with the time-frequency domain transformation pipeline to generate a denoised audio signal sample associated with the at least one microphone.
